(19) United States
(12) Patent Application Publication
(10) Pub. No.: US 2004/0143621 A1
(43) Pub. Date: Jul. 22, 2004

(54) International and domestic collection system

(76) Inventors: Carol A. Fredrickson, Cypress, TX (US); Mary E. Khajehali, Houston, TX (US); Martha L. Sanchez, Houston, TX (US); Lawrence Grant JR., Katy, TX (US); Kyoko A. Flasik, Missouri City, TX (US); Thomas W. Carter, Humble, TX (US); Gary Okuhara, Spring, TX (US); Terry Comeaux, Kyle, TX (US); Douglas Alexander, Las Vegas, NV (US); Alicia Sabo, Kyle, TX (US); Hop Cheong Dun, Sugar Land, TX (US); Michael H. McDonald, Arlington, TX (US)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/635,563

(22) Filed: Aug. 7, 2003

Related U.S. Application Data
(60) Provisional application No. 60/402,292, filed on Aug. 9, 2002.

(51) Int. Cl. G06F 15/16

(52) U.S. Cl. 709/200

(57) ABSTRACT

A system is provided for capturing and processing information from a collection item. The system includes: one or more scanners structured to scan and extract information, including image information, from a collection item and/or one or more documents associated with the collection item; a client operable to receive the information from the one or more scanners, associate the collection item and any associated documents together as an image-based unit of work, provide a display interface for a user of the client, accept input from the user, and perform processing of the collection item in accordance with the user's input; a database operable to store the extracted information so as to be retrievable on a unit of work basis; and an application server coupled to the client and the database, the application server being operable to access information stored in the database, make information from the database available to the client, and interface with external systems.

### CROSS REFERENCE TO RELATED APPLICATIONS

This Application claims priority to Provisional Application No. 60/402,292 filed on Aug. 9, 2002, the entirety of which is incorporated by reference.

### FIELD OF THE INVENTION

This invention relates generally to a system for the processing of bank collections items, and more particularly to a computerized system for managing the processing of both domestic and international collections items.

### BACKGROUND OF THE INVENTION

The collections department of a bank typically receives and processes thousands of collections items each day. Collections items are typically categorized according to whether they are incoming collections items or outgoing collections items. Outgoing collections items are items that are sent by the collections department to external banks along with a collections letter requesting remittance of payment on a collections item. Incoming collections items are items that are sent from external institutions to the collections department along with a collections letter requesting that the collections department remit payment. Incoming collections items are often drawn on an account at the receiving bank, i.e., are often “on-us” checks. Incoming and outgoing collections items may be further subcategorized according to whether the items are drafted in U.S. currency or non-U.S. (i.e., foreign) currency.

The category into which a collections item falls will determine the procedures that the collections department must follow when processing that item. For example, in the case of an incoming collections item, the collections department must typically verify that the account on which the check is drawn contains sufficient funds to cover the payment before payment is made on the item. Sometimes, if an incoming collections item is for above a certain amount, the collections department must obtain the specific approval of the account-holder before making payment. Outgoing collections items require separate procedures. For example, the collections department must generate a collections letter to the correct address, make note of when the collections letter was sent, and keep track of payments made on that collections letter.

There are also differences in procedure when processing domestic items as opposed to international items. For example, all domestic checks, as well as auto dealer and oil and gas drafts, have routing numbers printed in machine-readable microcode. As result, key information can be automatically extracted from batches of domestic checks by simply running the checks through a microcode reader. However, the routing information on most non-U.S. checks is not microcoded, and as a result must be manually recorded. Moreover, information such as the latest foreign currency exchange rates must be incorporated into the procedure in order to determine the monetary value of a particular foreign currency item.

Conventionally, however, much of the information that is needed to process collections items is found on paper, and stored in paper files. The sheer volume of collections items that are processed by the typical collections department makes paper-based processing highly inefficient. Electronic systems for scanning and storing images of collections items, and for storing associated collections item processing data in an electronic database, do exist in the art today. However, conventional electronic collections processing systems are capable of handling only part of the collections workflow. For example, one system may handle the processing of domestic collections items, but not foreign collections items, or vice versa. Thus, there exists a need in the art for an integrated computer system that is capable of processing both international and domestic collections items, while generating as little paper as possible.

### SUMMARY OF THE INVENTION

In accordance with one aspect of the present invention, there is provided a system for capturing and processing information from a collection item. The system includes: one or more scanners structured to scan and extract information, including image information, from a collection item and/or one or more documents associated with the collection item; a client operable to receive the information from the one or more scanners, associate the collection item and any associated documents together as an image-based unit of work, provide a display interface for a user of the client, accept input from the user, and perform processing of the collection item in accordance with the user's input; a database operable to store the extracted information so as to be retrievable on a unit of work basis; and an application server coupled to the client and the database, the application server being operable to access information stored in the database, make information from the database available to the client, and interface with external systems.

In accordance with another aspect of the present invention, there is provided a method for capturing and processing information from a collection item. The method includes: providing one or more scanners structured to scan and extract information, including image information, from a collection item and/or one or more documents associated with the collection item; receiving, at a client, the information from the one or more scanners, associating the collection item and any associated documents together as an image-based unit of work, providing a display interface for a user of the client, accepting input from the user, and performing processing of the collection item in accordance with the user's input; storing the extracted information in a database so as to be retrievable on a unit of work basis; and in an application server coupled to the client and the database, the application server being operable to access information stored in the database, making information from the database available to the client, and interfacing with external systems.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a block diagram depicting the International and Domestic Collections System (IDCS) in accordance with the present invention

FIG. 2 is a block diagram depicting the IDCS client software modules in accordance with the present invention;

FIG. 3 is a block diagram depicting the IDCS application server software modules in accordance with the present invention;

FIG. 4 is a flowchart depicting a procedure for processing collections in accordance with the present invention;

FIG. 5 is a flowchart depicting the sorting process in the IDCS in accordance with the present invention;

FIG. 6 is a flow chart depicting the process for scanning and indexing a collections item in accordance with the present invention;

FIG. 7 is a diagram depicting a scan workflow screen for Cash letter;

FIG. 8 is a diagram depicting a scan workflow screen for rescan item;

FIG. 9 is a diagram depicting a database index key numbering scheme in accordance with the present invention;

FIG. 10 is a flowchart depicting a procedure for item processing;

FIG. 11, 12 and 13 are diagrams depicting item processing screens for Collections;

FIGS. 14, 15 and 16 are diagrams depicting item processing screens for Cash Letters;

FIG. 17 is a flowchart depicting a procedure for balance and distribution processing in accordance with the present invention;

FIG. 18 is a diagram depicting a balance and distribution processing screen for a Cash Letter;

FIG. 19 is a diagram depicting a balance and distribution processing screen Premier/Standard items;

FIG. 20 is a diagram depicting the balance and distribution screen for Print;

FIG. 21 is a diagram depicting the balance and distribution screen for Collection item;

FIG. 22 is a diagram depicting the balance and distribution screen for a Hold item;

FIG. 23 is a diagram depicting the balance and distribution screen for Re-Print;

FIG. 24 is a flowchart depicting a procedure for payment processing in accordance with the present invention;

FIGS. 25 and 26 are diagrams depicting payment processing screens for ICL's;

FIG. 27 is a diagram depicting a payment processing screen for Collections;

FIG. 28 is a diagram depicting a payment processing screen for Switches and Returns paid;

FIG. 29 is a diagram depicting a payment processing screen for Premier/Standard items;

FIG. 30 is a diagram depicting external interfaces connecting the IDCS to external systems;

FIG. 31 is a diagram depicting a workflow research processing screen;

FIG. 31A is a depiction of a deposit ticket in accordance with a preferred embodiment of the present invention;

FIG. 32 is a diagram depicting a fax status research processing screen;

FIG. 33 is a diagram depicting an incoming faxes research processing screen;

FIG. 34 is a diagram depicting a Pending SWIFTS research processing screen;

FIG. 35 is a diagram depicting a Received SWIFTS research processing screen;

FIG. 36 is a diagram depicting a New SWIFTS research processing screen.

FIG. 37 is a diagram depicting a Premier/Standard research processing screen;

FIG. 38 is a diagram depicting a workflow hold research processing screen;

FIG. 39 is a diagram depicting a past due research processing screen;

FIG. 40 is a diagram depicting options available for handling an item drawn “on us” (CIU review);

FIGS. 41 and 42 are diagrams depicting inquiry screens for Items;

FIG. 43 is a diagram depicting an inquiry screen for Queue Status;

FIG. 44 is a diagram depicting an inquiry screen for Browse Images;

FIGS. 45 and 46 are diagrams depicting inquiry screens for Tables;

FIG. 47 is a diagram depicting an inquiry screen for Archive;

FIG. 48 is a diagram depicting a table screen to view tables;

FIG. 49 is a diagram depicting a system screen to view Start of Day;

FIG. 50 is a diagram depicting a system screen to view End of Day;

FIG. 51 is a diagram depicting a system screen to view Business Date;

FIG. 52 is a diagram depicting an IDCS Report screen;

FIG. 53 is a diagram depicting a Supervisor workflow screen;

FIG. 54 is a diagram depicting a Supervisor Unlock screen;

FIG. 55 is a diagram depicting a Supervisor Users screen;

FIG. 56 is a diagram depicting a Supervisor Settings screen;

FIG. 57 is a diagram depicting a Supervisor Batch status screen;

FIG. 58 is a diagram depicting a Customer Master File screen;

FIG. 59 is a diagram depicting a Customer screen;

FIG. 60 is a diagram depicting a Reconciliation Accounting screen;

FIG. 61 is a diagram depicting a Reversal Accounting screen;

FIG. 62 is a diagram depicting a Reconciliation AIP screen;

FIG. 63 is a diagram depicting a Reconciliation Fed Wire screen; and

FIG. 64 is a diagram depicting a Reconciliation IDC ticket screen.

### DETAILED DESCRIPTION OF THE INVENTION

The present invention is directed to a system and method that utilizes digital image-based processing to replace the known manual paper-intensive process. The present invention reduces the need to file paper documents and allows the volume of paper copies of items, in particular collections items, to be reduced. In a preferred embodiment, the system processes both international and domestic transactions and allows cash letters and collections to be handled on the same platform. In a preferred embodiment, the system provides a user interface compatible with Microsoft standards, such as navigation buttons, scripts, colors and task bars.

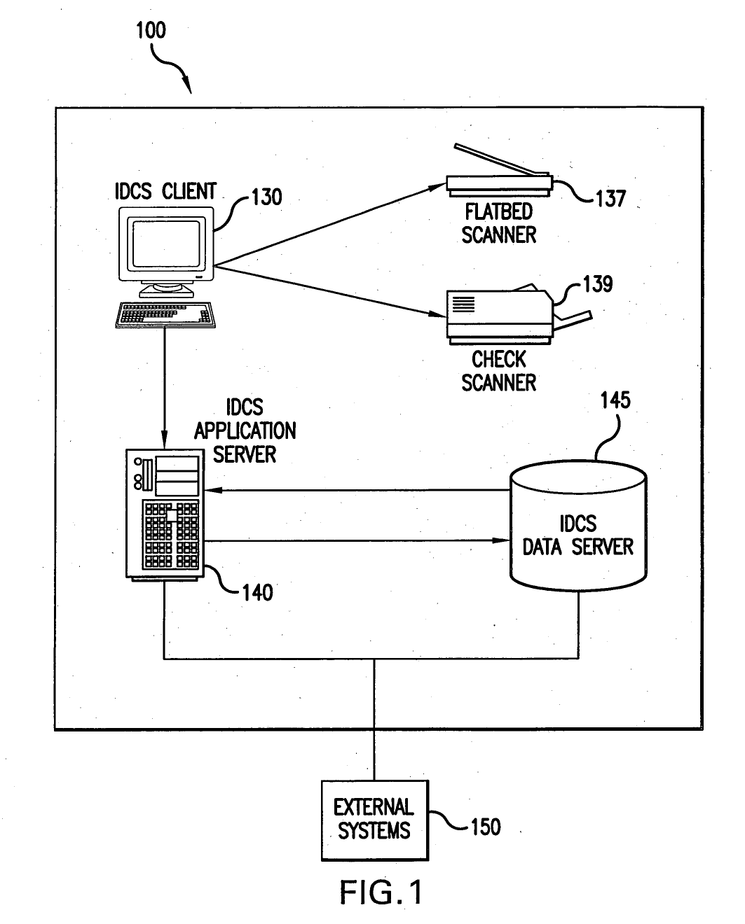

FIG. 1 is a block diagram depicting a system for processing international and domestic collections items in accordance with an exemplary embodiment of the present invention. The international and domestic collections system (“IDCS”) 100 is a distributed system having a client-server architecture. The IDCS 100 preferably comprises an IDCS client 130, an IDCS application server 140, and an IDCS data server 145, which are connected to one another via a conventional TCP/IP-based data network, such as the Internet or a private corporate Intranet. Although the present invention will be described in terms of an Internet/Intranet-based configuration, it will be appreciated by those skilled in the art that the IDCS 100 may alternatively be distributed across a Wide Area Network (WAN); may reside entirely on a Local Area Network (LAN); or may be accessed via a dial-up connection.

The IDCS client 130 comprises the client-side software in the IDCS 100 client-server system, and preferably runs on a machine separate from the IDCS application server 140. Software modules running on the IDCS client 130 automatically sort received collections items, scan and index the collections items and related documentation, process the collections items, and otherwise interact with the IDCS application server 140. The user interface for the IDCS client 130 is preferably a conventional Web browser capable of requesting and receiving Web pages dynamically generated by the IDCS application server 140. The IDCS client 130 is preferably connected to both a flatbed scanner 137 and check scanner 139. As will be discussed in greater detail, the check scanner 139 is operable to read the microcode commonly found on checks issued by U.S. banks. The microcode typically utilizes Magnetic Ink Character Recognition (MICR) which can be read by the check scanner 139. The flatbed scanner 137 can create image files for all types of collections items in addition to MICR encoded instruments. Preferably, the flatbed scanner 137 can scan letter, legal, or A4 documents, and may be provided with a sheet feeder to allow multiple page documents to be scanned.

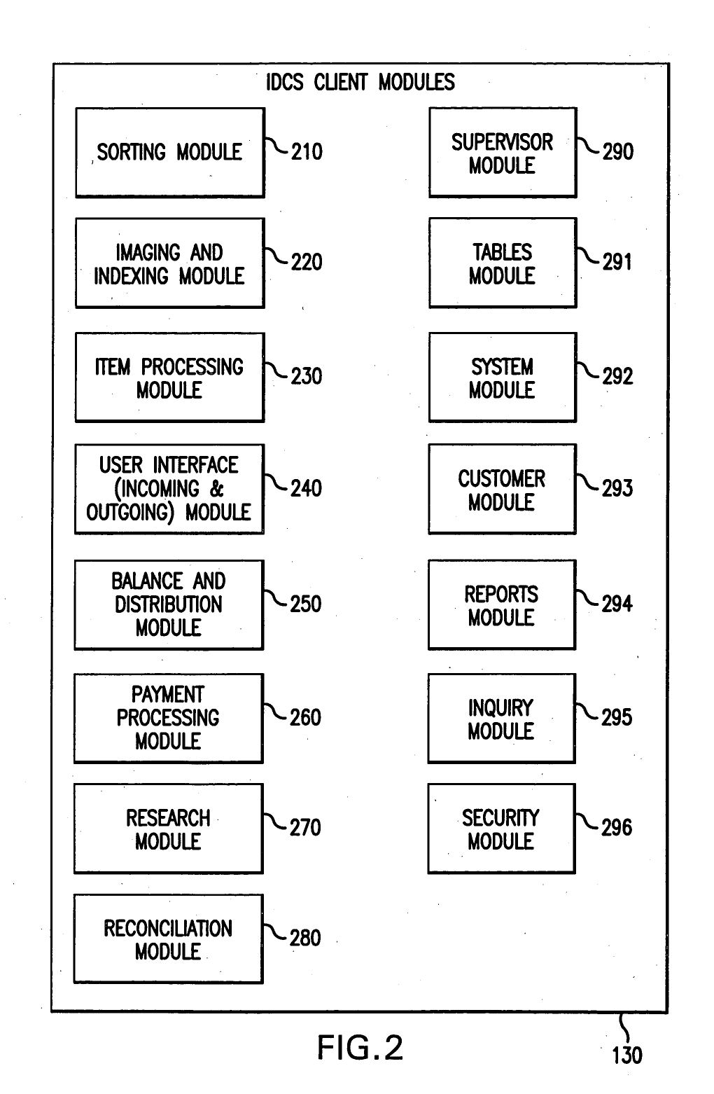

FIG. 2 is a block diagram depicting the IDCS client software, in accordance with an exemplary embodiment of the present invention. The IDCS client 130 may include a sorting module 210, an imaging and indexing module 220, a item processing module 230, and a user interface module 240, a balance and distribution module 250, a payment processing module 260, a Research module 270, a Reconciliation module 280, a Supervisor module 290, a Tables module 291, a System module 292, a Customer module 293, a Reports module 294, an Inquiry module 295; and a Security module 296. The sorting module 210 includes instructions for automatically sorting received collections items into various categories to facilitate the processing of and access to the collections items by the IDCS. The imaging and indexing module 220 includes instructions for scanning received collections items and any related paperwork, and for grouping all the images associated with a particular collections item into a single work unit.

The imaging and indexing module 220 is also responsible for generating a unique database key for each received collections item. All images and data relating to a particular collections items may be uniquely identified in the IDCS database 145 using the collections item's database key. The item processing module 230 includes instructions for processing the various collections items, including incoming, outgoing, and “on us” collections items. The user interface module 240 generates screens that both prompt the user of the IDCS 100 to input information, and display information to the user of the IDCS 100. The balance and distribution module 250 generate screens and provides processing necessary for the user to perform balance and distribution functions of the IDCS 100. The payment processing module 260 generates screens and provides processing necessary for the user of the IDCS 100 to effect payment processing of collection items in accordance with the present invention. The Research module 270 generates screens and provides processing necessary for the user of the IDCS 100 to view and search data that has been stored in the IDCS 100. The Reconciliation module 280 provides processing for reconciling payments received on collections items with the collections items entered in the IDCS 100. The Supervisor module 290 generates screens and provides processing necessary for a system supervisor to monitor user activity and perform other supervisory tasks relating to the IDCS 100. The Tables module 291 generates screens that provide information used by the IDCS System. Tables include but are not limited to: Rates, Thomson Directory, SWIFT BIC, Security Reasons, Account Analysis, Activity ID's, Security Levels, Account Constants, County Codes, DDA/GL Codes, etc. The System module 292 is comprised of 3 categories. Category 1: The Start of Day screen illustrates the inbound interfaces and their connectivity into IDCS. Further details include dates, start time of connectivity and end time of connectivity; Category 2: The End of Day screen provides the IDCS user the ability to create all accounting transactions for OPICS, EFUN, STARS and WDC for posting to the demand deposit posting system. The End of Day process validates that all existing processing queries have been completed prior to executing the End of Day function; Category 3: The Business Date screen displays the monthly calendar which validates the system date. The End of Day function advances the system date, which confirms successful End of Day processing. The Customer module 293 generates screens that allows the IDCS user to add, modify or delete customers to the IDCS customer database. The Customer Masterfile provides a unique customer reference number assigned to each customer in the IDCS customer database, as well as, settlement instructions, SWIFT address, GES limit information, and customer's address phone number and fax number. The Reports module 294 lists all reports accessible in IDCS. The Reports module allows the IDCS user to select the appropriate report utilizing variable dates. Reports are housed and generated under Crystal Format. The Inquiry module 295 allows the systematic search of case transactions utilizing product type codes and varying search criteria. Search criteria includes face amount, currency, country code, account name, account number, case reference number, etc. The Security Module 296 provides security access levels and passwords for each IDCS user. This module is only accessible by the System Security Administrator.

The IDCS application server 140 comprises one or more server-side software modules that are programmed to interact with the IDCS client 130 and the IDCS data server 145. The IDCS database 145 is preferably a relational database such as, for example, Oracle or Microsoft SQL Server. The IDCS database 145 and the IDCS application server 140 may reside on separate computers connected via a conventional data network or, alternatively, the IDCS data server 145 and the IDCS applications server 140 may co-exist as separate processes on the same machine. The interoperation between the IDCS client 130, the IDCS application server 140, and the IDCS data server 145 will be described in greater detail herein.

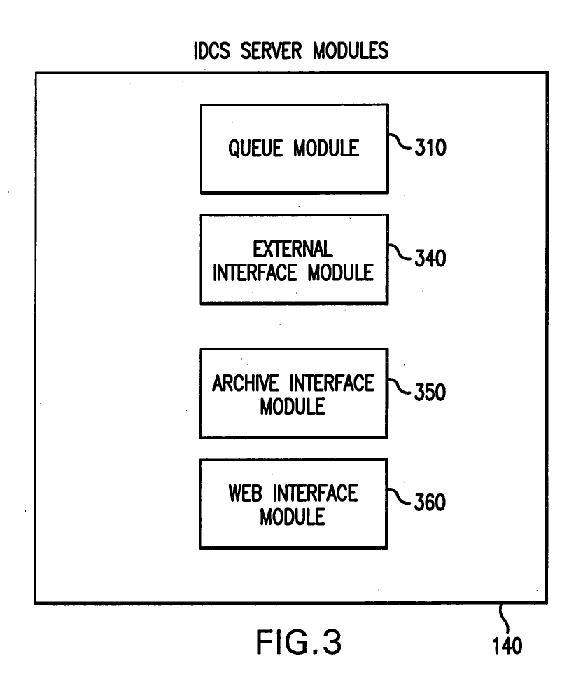

FIG. 3 is a block diagram depicting the IDCS application server software, in accordance with an exemplary embodiment of the present invention. The IDCS application server 140 is also preferably comprised of software modules, including a Queue module 310, an External Interface module 340, an Archive Interface module 350, and a Web Interface module 360.

The system of the present invention utilizes status queues for storage of data to be used during processing and other functions of the present invention. For example, international collections and domestic collections data flows are managed by means of such status queues, which are tracked and maintained by the system. The tracking and update of the status queues is performed dynamically by the queue module 310 as items are processed throughout the day. Individual queues will be discussed throughout the description that follows.

External Interfaces

The IDCS 100 is preferably connected to one or more external systems 150 by way of the IDCS application server 140. As was previously stated, the IDCS application server 140 preferably includes an External Interface Module 340. The External Interface Module 340 includes one or more external interfaces, through which the IDCS 100 may either output data to, or input data from, external systems 150.

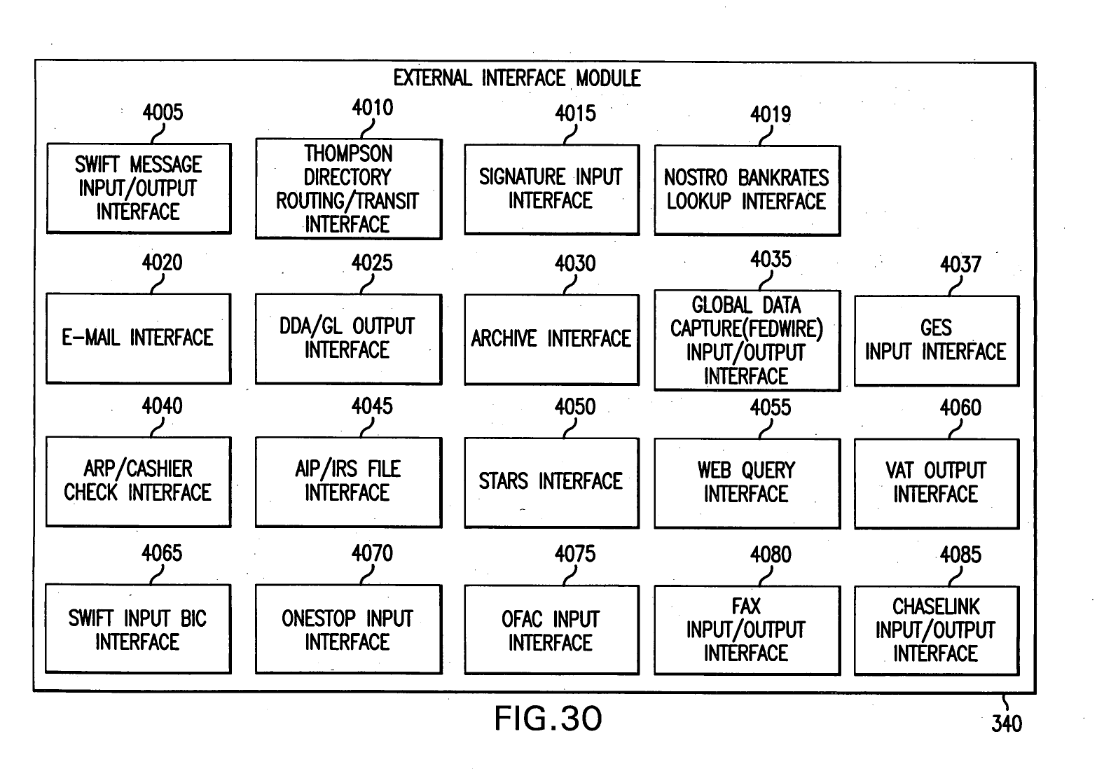

FIG. 30 is a block diagram depicting the external interfaces in the External Interface Module 340, in accordance with an exemplary embodiment of the present invention. The external interfaces may be divided into three basic categories. The first category comprises those interfaces that input data to the IDCS 100. The second category comprises those interfaces that both input data to, and accept output from, the IDCS. The third category comprises those interfaces that solely accept output from the IDCS 100.

Input to the IDCS 100 is provided by the SWIFT Message Interface 4005 and the Thompson Directory Interface 4010. The SWIFT Message Interface 4005 accepts periodically incoming SWIFT messages throughout the processing day. These incoming SWIFT messages are preferably swept into the IDCS 100 at 30 minute intervals. The IDCS user must review each SWIFT message and manually match it up with the appropriate item and forward the SWIFT message to the proper collections item for processing. The SWIFT Message Interface 4005 preferably accepts the following MT series messages into the IDCS system: MT 199 (Free Form Message); MT 202 (Third Party Payment of a Collection); MT 400 (Advice of Payment); MT 410 (Acknowledgement of Receipt); MT 420 (Tracer to Clearing Bank); MT 422 (Advise of Fate Instruction); MT 456 (Advise of Dishonor); and MT 499 (Free Form Message Related to a Collection). An “answer back” will be sent by the IDCS 100 whenever a SWIFT message is received.

The Thompson Directory Interface 4010 accepts periodic updates to the IDCS database 145 as to bank name changes, the removal of a retired ABA, and the assignment of a new ABA Every financial institution in the United States has a unique transit routing or ABA number assigned to it. The ABA number contains information such as, for example, what Federal district the financial institution is located in.

Input is provided to the IDCS 100 by Signature Card Input 4015. Signature Card input 4015 is used to verify an account holders signature. Signature cards are completed by account holders at the time the account is opened. They are used by the financial institution to verify that the accountholder in fact issued the document being presented. This interface 4015 allows for entry of signature card information into the system of the present invention.

The Office of Foreign Asset Control (OFAC) interface 4075 is the interface through which the IDCS 100 receives the OFAC list. The OFAC list is a list of foreign countries, terrorists, international narcotics traffickers, and those engaged in activities related to the proliferation of weapons of mass destruction, that have been targeted for economic or trade sanctions by the United States government. The Patriot Act of 2002 makes it mandatory for all U.S. financial institutions to review the OFAC list. If a transaction being processed contains a name that is on the OFAC list, the government must be informed and legal intervention may be necessary.

SWIFT BIC Interface 4065 (Society Worldwide International Financial Transfers) All financial institutions have a unique SWIFT address. This unique SWIFT address provides the ability to communicate worldwide between financial institutions to perform and document financial transactions. The worldside SWIFT headquarters are located in Ta Hulpe, Belgium.

One Stop Interface 4070 (TMS) allows the IDCS user to obtain account name and address which is then populated into the appropriate IDCS processing fields. In addition, the One Stop interface 4070 allows the IDCS user to validate the validity and status of an account number entered during IDCS processing.

GES Interface (Global Exposure System) 4037 houses the credit lines for various bank products for which an account officer has performed the appropriate financial credit level. Credit limits are established in GES and in their credit review and ratings.

The external interfaces that provide output from the IDCS 100 to external destinations will now be described. The Nostro Bank Look-up Interface 4019 retrieves data from the Smart Stream Reconciliation (SSR) Queues. SSR queues are used to manage foreign currency transactions. In a financial institution, each business unit handling foreign currency settlement is assigned a queue. The business unit is responsible for identifying and clearing all transactions placed in its queue.

The Outgoing SWIFT Message Interface 4005, is the interface through which SWIFT messages are generated and sent from the IDCS 100 to SWIFT during the processing day. Outgoing SWIFT messages are preferably created at the time of data entry. Tracers are automatically generated and sent through this interface, preferably at the 45 day, 60 day, and 90 day mark, and then every day thereafter. (List message types automatically sent & when they are sent)

The Fax Input and Output Interface 4080 allows for the input of faxes to the IDCS system. Incoming faxes can be systematically attached to the appropriate case for documentation. Based on the Customer Master File and the indication of a fax number, IDCS customers can receive notification and acknowledgments of collection items via fax. The fax notification of GES limits to the appropriate account officer is another feature of the fax interface.

Chaselink Input/Output Interface 4085 allows IDCS a reporting structure for account reconciliation of all internal DDA accounts. The Chaselink output interface provides case transaction financial reporting for clients utilizing Chaselink and IDCS processing.

The Demand Deposit Account/General Ledger (DDA/GL) Output Interface 4025 is the interface through which the IDCS 100 posts changes to DDA and GL accounts that result from the completion of processing of collections items. These entries represent collections postings to the financial institution's financial systems. E-mail interface 4020 is the interface though which the system communicates via electronic mail, typically, but not limited to, electronic mail over the Internet or local network.

The Archive Interface 4030 is the interface through which collections items images are uploaded to the image archiving system, such as, for example, the OnDemand™ system. The interface is controlled by the archive interface module 350. Archive images are preferably maintained in the IDCS 100 database 145 for a period of 90 days after closure and then uploaded to the archive system at the end of each month, moving these items closed 90 days or more via the Archive Interface 4030. After the images have been uploaded to the image archive, the images are deleted from the IDCS database 145.

The Global Data Capture (GDC) Interface 4035 is the interface through which outgoing wire transfers and clearinghouse payments are sent by the IDCS 100. The GDC Interface 4035 is preferably capable of outputting a variety of payment formats, including CHIPS and Fedwire payments.

The ARP/Cashier Check Interface 4040 is the interface through which reconciliation records are sent to a check fraud prevention system, such as Positive Pay, each time a cashier's check is produced by the IDCS 100. The record sent via interface 4040 preferably includes the ABA of the bank, a reconciliation number, check number, a check amount, and the date of the check.

The AIP interface 4045 is the interface by which information on each outstanding collections item in open status is sent to Automated Investment Process (AIP) via Network Data Mover (NDM). The file outputted through the AIP interface 4045 preferably includes: the current date; the collections letter number; the name of the financial entity; the DDA account number; the principal amount on the collections item; the collections item category; and the number on the collections item,

The Subledger Transaction Accounting Reporting System (STARS) Interface 4050, is the interface which funds all entries on the bank's records for processing the collections items (e.g., for processing payment by wire, payment by check, IDC transactions, etc.) are credited and posted to the bank's general ledger account.

The Web Query Interface 4055 is the interface through which a mirror image of the IDCS database 145 is outputted to a separate Web-accessible database server located outside the IDCS 100. Since the external Web-accessible database is a mirror of the IDCS database 145, it is capable of responding to Web-based queries regarding the current status of all collections items. However, the external Web-accessible database has no direct connection to the IDCS database 145 and is not capable of updating the data stored in IDCS database 145.

The Volume Allocation Tracking Interface (VAT) 4060 sends the widget for each IDCS case. This tracking of IDCS cases provides the volume allocation for customers utilizing IDCS processing.

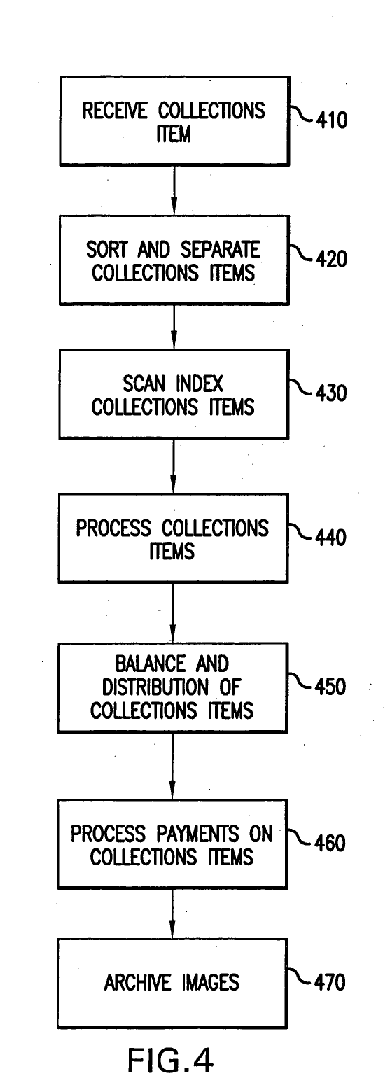

The operation of the IDCS 100 will now be described with reference to the flowchart in FIG. 4, in accordance with an exemplary embodiment of the present invention. Each step will be discussed under a separate heading.

Receive Collections Item Step 410

At step 410 an IDCS user, e.g. in a bank collections department, receives a “collections item.” A collections item is any negotiable instrument that a collections department receives for processing. Collections items may be drafted in either U.S. or non-U.S. currency, and include such items as checks, automobile drafts, oil and gas drafts, bonds and coupons. Collections items may be received by the collections department from a variety of sources, including walk-ins, a clearing house, internal bank branches, a lock box, via regular mail, or from a location outside the United States (i.e., a “foreign” location).

Sort and Separate Collections Items Step 420

At step 420, the received collections item is sorted into a processing category. The sorting step 420 may be performed by sorting module 210 of the IDCS client. Sorting module 210 shown in FIG. 2, automatically sorts each collection item, classifying it within a particular collections item processing category. The automatic sorting process will be discussed in more detail below. Alternatively, sorting step 420 may be performed manually.

Collections items may be classified as belonging to one of two basic categories: international collections items, and domestic collections items. International collections items may be further subclassified as Collection Incoming International items (“CIIs”), Collection Incoming International On-Us items (“CIUs”), Collection Outgoing International items (“COIs”), International Cash Letter items (“ICLs”) Premier/Premier items, Premier/Standard items, and Standard/Standard items

CIIs and CIUs are both “incoming” collections items. Incoming collections items are those that are received by the collections department along with a request for remittance of payment. The only difference between the two is that a CIU is drawn on-us, while a CII is not. As known to those skilled in the art, the term “on-us” indicates that the account against which the collections item is drawn is held by the bank itself. With a CIU, once the collections department approves payment, it need only debit the account that the item is drawn on, and remit payment to the presenting entity.

By contrast, with a CII, the collections department must forward the request for payment to the external bank on which the incoming collections item is drawn. The external bank either approves or denies payment on the collections item and, if payment is approved, the external bank remits payment to the collections department. The collections department, in turn, deducts a processing fee and forwards the payment to the external bank that requested it.

A COI is an “outgoing” collections item. Outgoing collections items are sent by the collections department to external institutions along with a request for remittance of payment from the external institution. Whereas incoming collections items may or may not be on-us, outgoing collections items are never on-us.

ICLs are cash letter (C/L) collections items that originate outside the United States. They are drafted in foreign currency or US Dollar drawn on a financial institution in an overseas country. ICL items are sorted together by destination and currency and sent to the foreign institution on a cash letter for settlement.

Premier/Premier—Premier/Premier transactions are those that are conducted for clients of the financial institution for which the financial institution has agreed to process those transactions that meet certain standards as “premier” transactions.

Premier/Standard transactions are those that are conducted for clients that have signed a “Premier” agreement, wherein the item being processed does not meet the standards for “premier” transactions and is therefore processed as a standard transaction.

Standard/Standard transactions are those that involve collection items that are processed by the financial institution in accordance with the “premier” workflow.

Like international collections items, the domestic collections items may also be divided into subcategories. These subcategories preferably include Collection Incoming Non-cash items (“CINs”), Collection Incoming Non-cash On-Us items (“CIUs”), Collection Outgoing Non-cash items (“CONs”), Collection Outgoing Cash items (“COCs) Coupon Outgoing Cash (“QOCs”), Coupon Outgoing Noncash (QON”), and Payable Thru Drafts (PTDs”).

Just as in the case of international CIs and CIUs, domestic CINs and CIUs are incoming collections items that are received from an external institution requesting remittance of payment. CONs and COCs are outgoing domestic collections items that are sent by the collections department to external institutions along with a request for remittance of payment from the external institution.

Domestic CINs, CIUs and CONs are non-cash items, while COCs are cash items. By default, collections items are non-cash items. A non-cash item is a collections item that is not immediately convertible into cash. That is to say, the account of the holder of a non-cash collections item is not paid on presentment of the non-cash item. The holder is credited only after the institution on which the item is drawn actually has remitted payment.

Some bank customers, however, have a special arrangement with their bank to convert collections items into ledger credit on deposit. The collections items deposited by such customers are referred to as cash items, i.e., COCs.

QOC and QON letters allow a bank to process customer deposits of past due or future due bond coupons.

Payable Through Drafts (PTDs) are check-like instruments drawn against the payor and not against a bank as is a check. After a PTD is presented to a bank, the payor decides whether to honor or refuse payment.

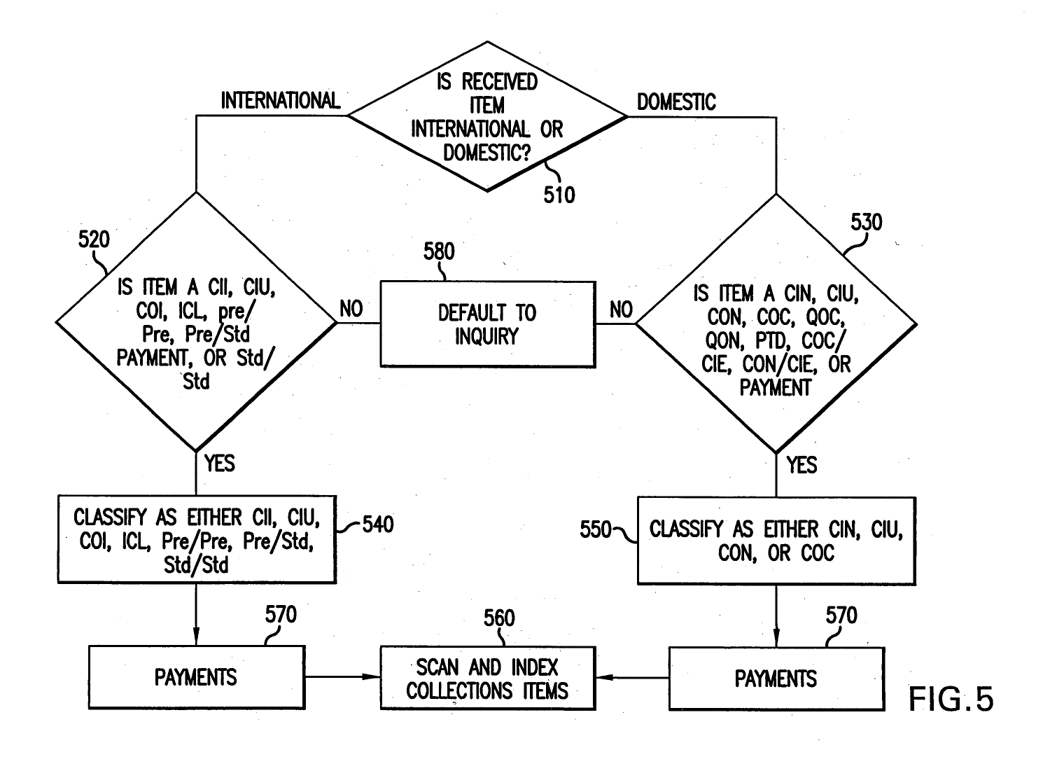

FIG. 5 is a flowchart depicting the sorting process in accordance with as exemplary embodiment of the present invention. At step 510, collections determines whether the received collections item is an international collections item or a domestic collections item. If the collections item is international, the international collections item falls into one of the international collections subcategories (described above) recognized by the IDCS 100, e.g., CII, CIU, COI, ICL, Premier/Premier, Premier/Standard, Standard/Standard, Alternative embodiments of the present invention may include a greater, or fewer number of international subcategories, without departing from the inventive concept of the present invention.

If the sorting module 210 determines that international collections item falls into one of the recognized international collections subcategories, it classifies the collections item accordingly at step 540. The international collections item is then scanned and indexed at step 560. In alternative embodiments, a different default item classification may be assigned to unidentified, or unidentifiable, international collections item without departing from the inventive concept of the present invention.

Referring again to step 510 of FIG. 5, if the received collections item does not fall into a recognized international collections subcategory, the sorting module 210 determines, at step 530, whether the collections item falls into one of the domestic collections item subcategories recognized by the IDCS 100, e.g., CIN, CIU, CON, COC, QOC, QON, PTD. As before, alternative embodiments may include more, or fewer, domestic collections subcategories.

If the sorting module 210 determines that the domestic collections item falls into one of the recognized domestic collections subcategories, it classifies the domestic collections item accordingly at step 550. The domestic collections item is then scanned and indexed at step 560. Payments step 570 invokes a payment module which scans payments received by fax of mail. The payment advices are scanned utilizing the check or flatbed scanner. The successful execution of the commit action in scanning payments moves the image to the appropriate processing queue.

If the domestic collections item does not fall into a recognized domestic collections subcategory, the sorting module 210 preferably classifies it as a Default to Inquiry at step 580. In alternative embodiments, a different default item classification may be assigned to unidentified, or unidentifiable, domestic collections item.

Scan and Index Collections Items Step 430

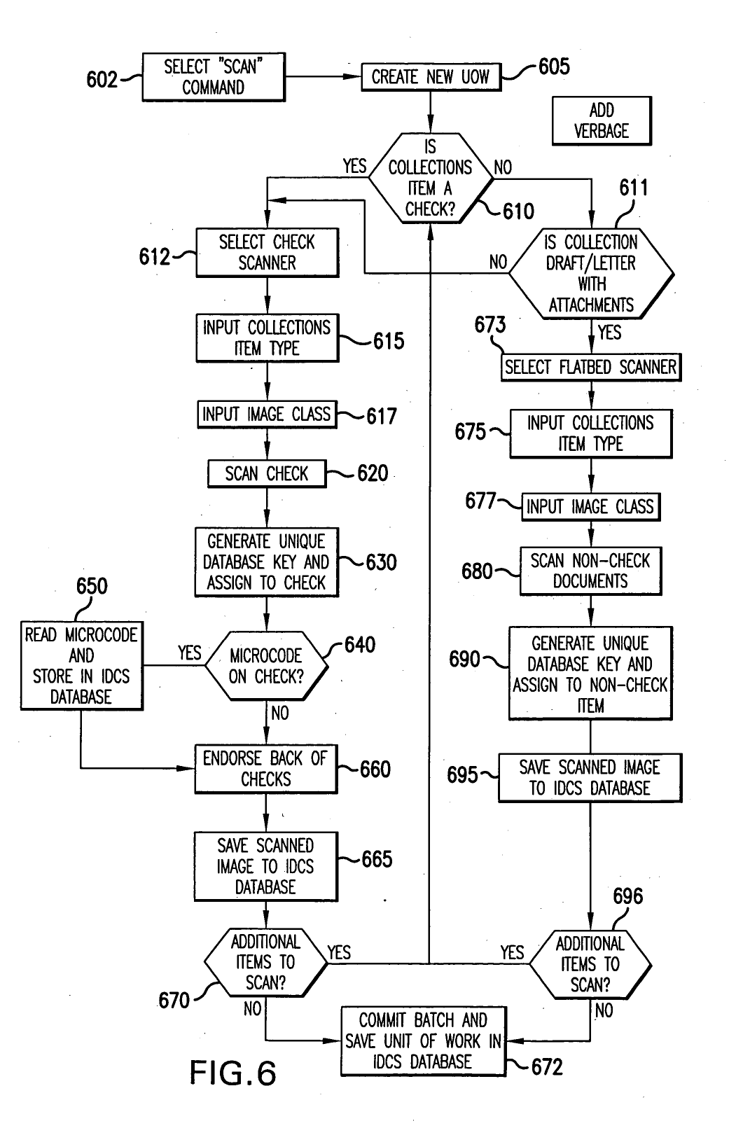

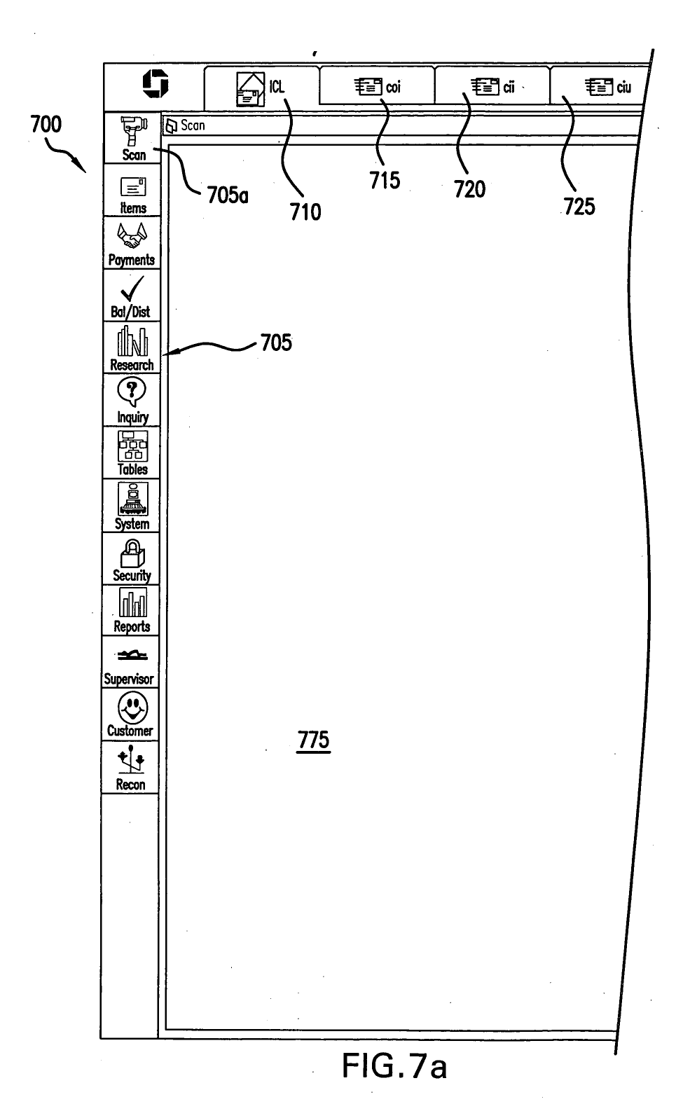

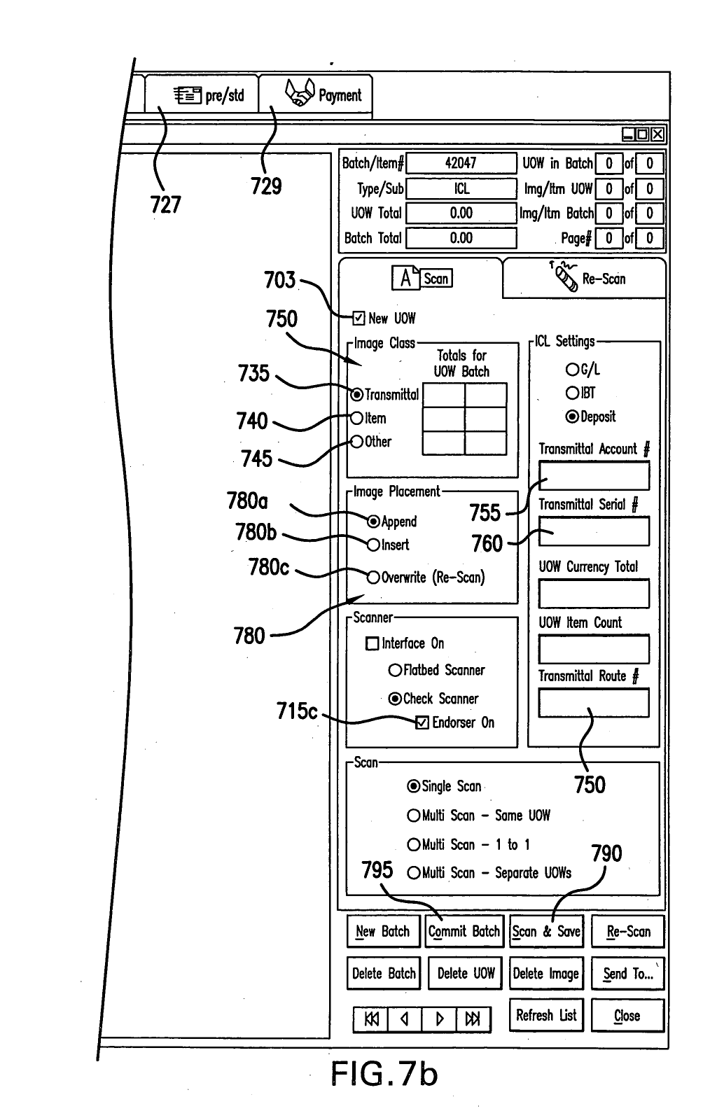

Returning again to FIG. 4, once the collections item has been sorted into its appropriate collections item processing category, the collections item must be scanned and indexed at step 430. FIG. 6 is a flow chart depicting the process for scanning and indexing a collections item, and FIG. 7 is a diagram of the scan workflow screen generated by the imaging and indexing module 220 (FIG. 2) in accordance with an exemplary embodiment of the present invention.

Referring to FIG. 6, at step 602, the IDCS user clicks the “scan” button 705a of the menu bar 705. Preferably, menu bar 705 appears in each of the screens to be discussed in connection with the present invention. In response to clicking the scan button 705a, the imaging and indexing module 220 of the IDCS client 130 generates and displays scan workflow screen 700 to the IDCS user. The IDCS user uses the scan workflow screen 700 to enter data required by the imaging and indexing module 220 for completion of the scanning and indexing step 430.

The first piece of information that the user must input into scan workflow screen 700 relates to what will be referred to as image-based “units of work” (UOWs). The imaging and indexing module 220 groups all images related to a particular collections item, whether check or non-check, together as an image-based UOW. The image-based UOW forms the basis of the image-based workflow of IDCS 100. A UOW may consist of a transmittal (one or more pages), a collections item (front and back), and any supporting documentation associated with the collections item (zero or more pages). At step 605, before actually scanning anything, the user must indicate to the imaging and indexing module 220 that a new unit of work is being created. The user may do so, for example, by selecting the “new UOW” command button 703.

Next, at steps 610, the IDCS user determines whether the item to be scanned is, or is not, a check. If the item to be scanned is a check, the user scans the item using the check scanner 139 (FIG. 1). If the item to be scanned is not a check, the user scans the item using the flatbed scanner 137. At steps 612 and 673, the user may indicate his choice at in the scanner selection area 715 (FIG. 7), by selecting either the “check scanner” radio button 715b, or the “flatbed” radio button 715a.

At this point, the steps in the flow chart diverge into substantially parallel paths, one for checks, and one for non-check items. Identical, or substantially identical, steps in the parallel paths will be discussed together, to avoid the necessity of repeating the same description. At step 615 and parallel step 675, the IDCS user informs the imaging and indexing module 220 to which collections item category the collections item should be assigned. For example, referring to FIG. 7, the IDCS user may assign a collections item category by selecting the ICL tab 710, the COI tab 715, the CII tab 720, the CIU tab 725, the PRE/STD tab 727 or the Payment tab 729.

Next, at steps 617 and 677, the user indicates to the imaging and indexing module 220 whether the document being scanned is a transmittal, a collections item, or other supporting documentation, i.e., the class of the document within the unit of work. For example, the user may specify the image class by selecting the “transmittal” radio button 735, the “item” radio button 740, or the “other” radio button 745, in the image class selection area 750.

At steps 620 and 680, the document (either collections item or supporting documents) are scanned. The user places the document in the appropriate scanner device: check scanner 139 if the item is a check (step 620), or flatbed scanner 137, if the item is not a check (step 680). The user then clicks the “scan and save” command button 790. As the document is scanned, the imaging and indexing module 220 generates a unique database index key for the document and assigns it to the document at step 630 and parallel step 690. The unique database key uniquely identifies each image-based UOW stored in the IDCS database 145. That is, each image-based UOW is stored in and retrieved from the IDCS database 145 via its unique database index key.

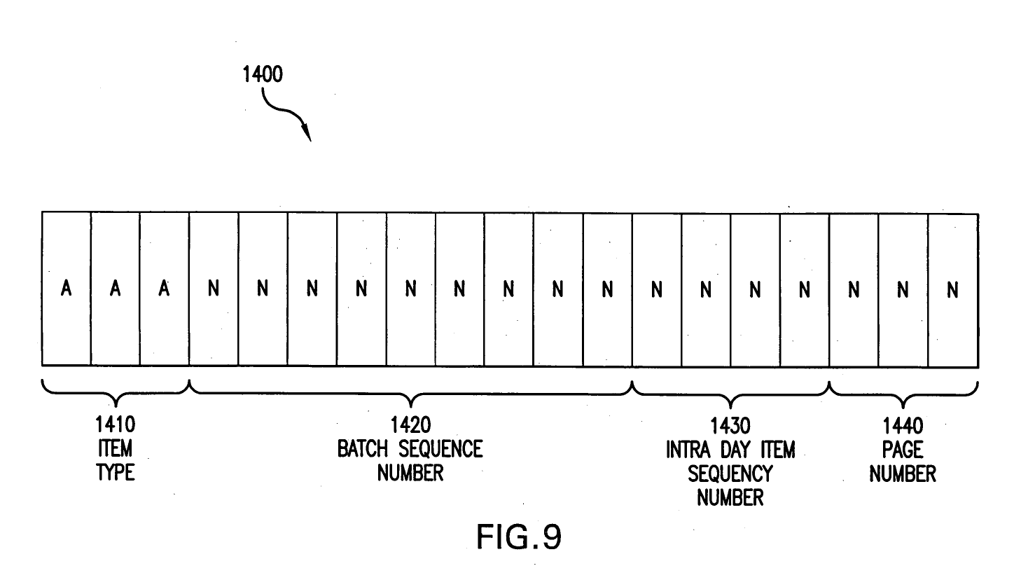

Next will be described a scheme for generating the database index key in accordance with an exemplary embodiment of the present invention. Any conventional numbering scheme that assigns a unique database index key to each item being scanned may be utilized. An example of such a scheme is depicted in FIG. 9. In the illustrated embodiment, a 19 digit alphanumeric index key 1400 is assigned. The first 3 digits 1410 of the index key 1400 are alphabetical, and indicate the type of collections item that is being scanned. For example, COI, CII, CIU, Pre/Std etc. The next 9 digits 1420 of the index key 1400 are a unique batch sequence number. Every bundle of items that is run through either the flatbed scanner 137 or the check scanner 139 is assigned a unique batch sequence number 1420 based on items in the batch. The last 4 digits 1430 of the index key 1400 are a numeric intra-day item sequence number. All the items scanned on the same day are incrementally assigned an item sequence number 1430 starting at 1 each day. Finally, the last three digits 1440 of the index key 1400 is a page number for each scanned item. Every page of every item is assigned a three digit number beginning with 001. The page number 1440 starts over again with 001 with each new item.

Referring again to FIG. 6, At step 640, if the item was scanned as a check using the check scanner 139, the imaging and indexing module 220 determines whether there exists a microcoded e.g., MICR encoded, routing number on the check. All domestic checks contain routing numbers, but most foreign checks do not. If the check includes microcode, at step 650 the microcode is read and the microcoded information is stored by the IDSC data server 145. The microcoded information may be used to populate certain fields in the scan workflow screen 700, such as, for example, the transmittal routing number field 750, the transmittal account number field 755, and the transmittal serial number field 760. If the check is, for example, a foreign check that does not contain any microcode data, the user may manually enter data into fields 750-765.

At step 660, if the item is a check and the Endorser On checkbox 715c has been selected, the imaging and indexing module 220 electronically endorses the scanned check, by placing the prior endorsement guarantee (PEG) on the back of the check.

At steps 665 and 695, the scanned document is saved to the IDCS database 145. An image of the scanned document is displayed to the user in image display area 775.

The user may now wish to scan additional documents and associate them with the current unit of work, i.e., the current scanned collections item. If the user wishes to append another image to the current unit of work, the user may use the image placement selection area 780 to select the append radio button 780a. If the user wishes to insert an additional check image as an additional transmittal page, the user may select the insert radio button 780b. If the user wishes to replace a scanned image, the user may select the overwrite radio button 780c.

For every additional item to be scanned, the process begins again at step 610. For example, if the additional item is a check, then the user selects the check scanner at step 612 and continues as described above. If the additional item is not a check, then the user selects the flatbed scanner at step 673.

Once the user has completed scanning all the images associated with the current unit of work, the user may commit the image-based UOW by selecting the “commit Batch” command button 795. Additional UOW's may be associated with batch. The current UOW has now been completely scanned, and the entire batch—i.e., the collections item and all associated supporting document images—is now retrievable by querying the IDCS data server 145 using the collections item's unique database index key. Committing the batch at step 672 also causes the imaging and indexing module 220 to change the status of the batch from “scan” to “process,” indicating to the IDCS 100 that the scanning and indexing of the collections item is complete and that the batch is now ready for the item processing step 440 (FIG. 4). FIG. 7 shows the scan workflow screen for the selected ICL tab 710. As will be understood, substantially similar screens are preferably provided for the other collections categories for which tabs are provided on the scan workflow screen, and substantially the same steps preferably are performed as those shown above in connection with the ICL tab 710.

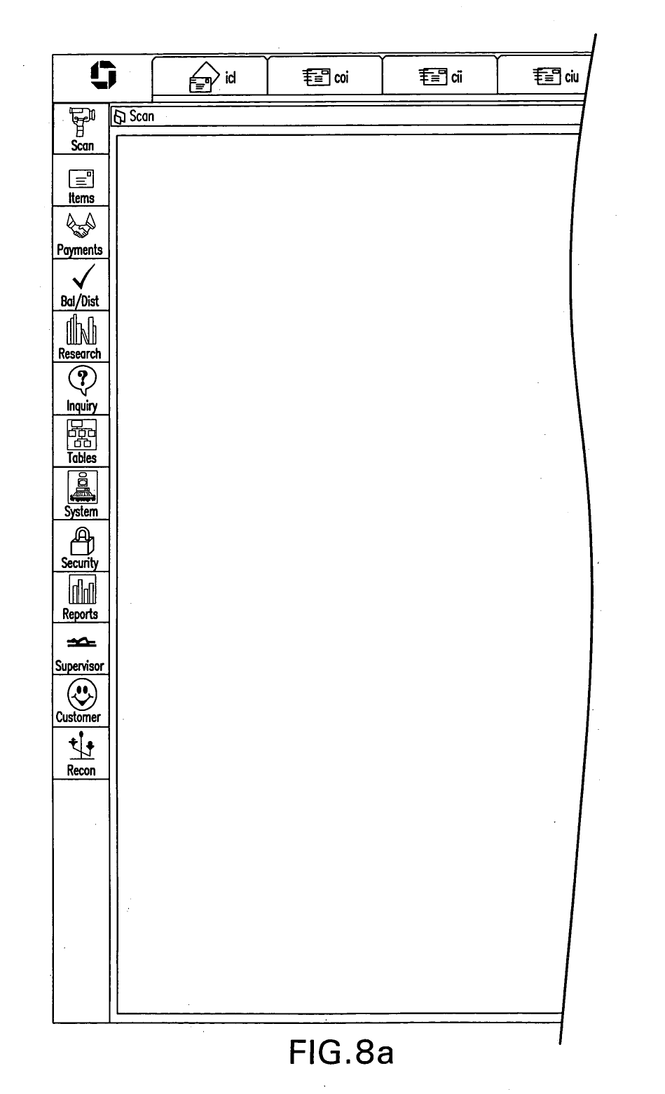

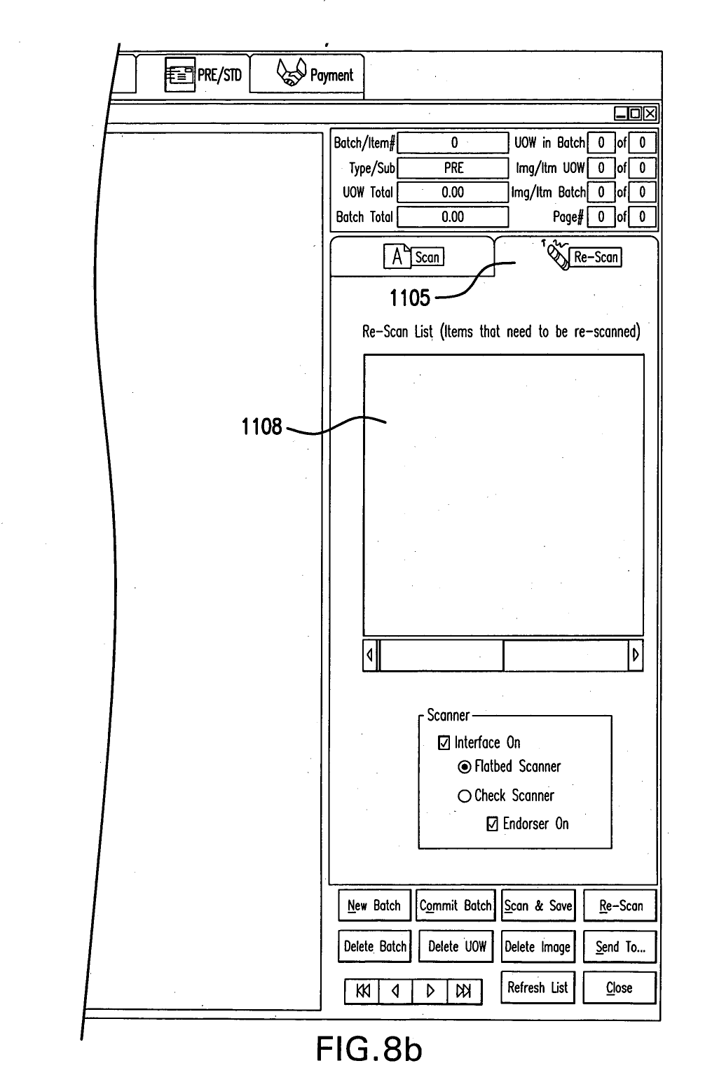

FIG. 8 shows the scan workflow screen, with the Re-scan tab 1105 selected. As shown in the figure, when the Re-scan tab 1105 is selected, the user is provided with window 1108 which displays the Re-scan list, i.e., the items that need to be re-scanned. The present invention uses the re-scan function with respect to all improperly scanned documents to be re-scanned immediately both at the batch and item level, allowing for replacement or insertion in its original placement. As opposed to prior systems, which would require that re-scanned images be placed at the end of a batch, in the re-scan process of the present invention, the bad image is scanned again and would actually replace the old image. Further, preferably even if an item was missed in the scanning process, it can be reinserted in the correct order in the re-scan process.

After the initial input of items, there is a constant flow of letters, faxes, and/or legal documents. These documents can be appended to an original transaction, if the later-received document corresponds to a unit of work that has already been created. Advantageously, MICR information from checks is used to populate appropriate fields in the database, reducing the amount of keying of information.

Once scanning is complete, the information is forwarded to a holding area for processing, or, if further action is required, to a research holding area

Process Collections Items Step 440

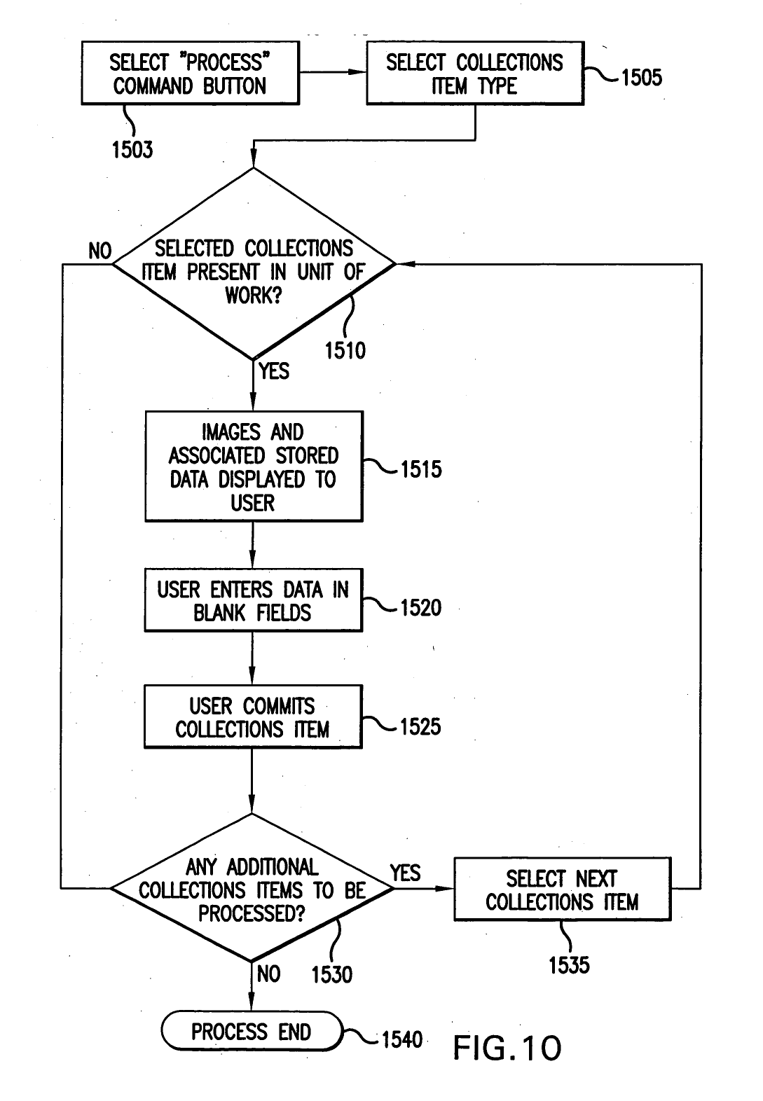

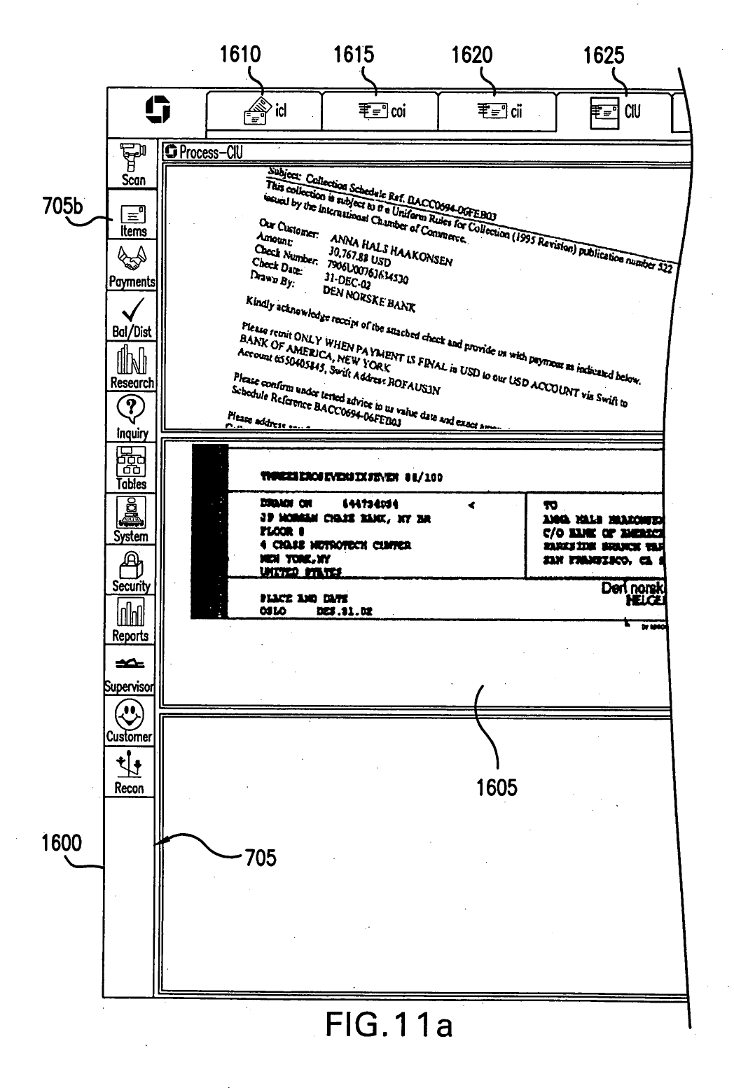

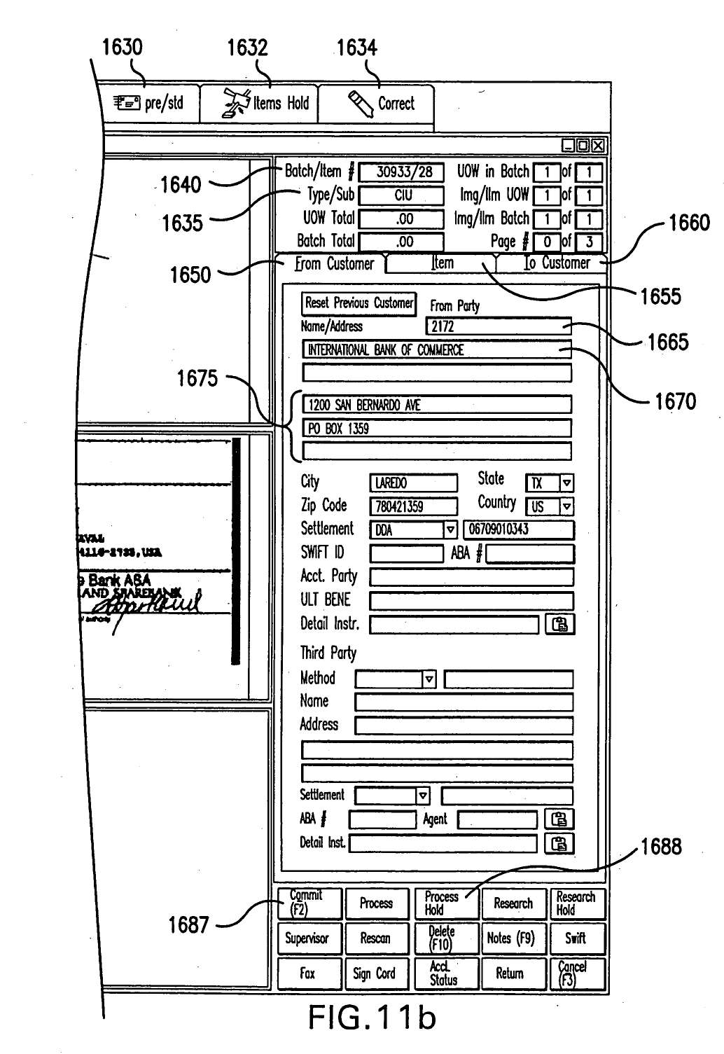

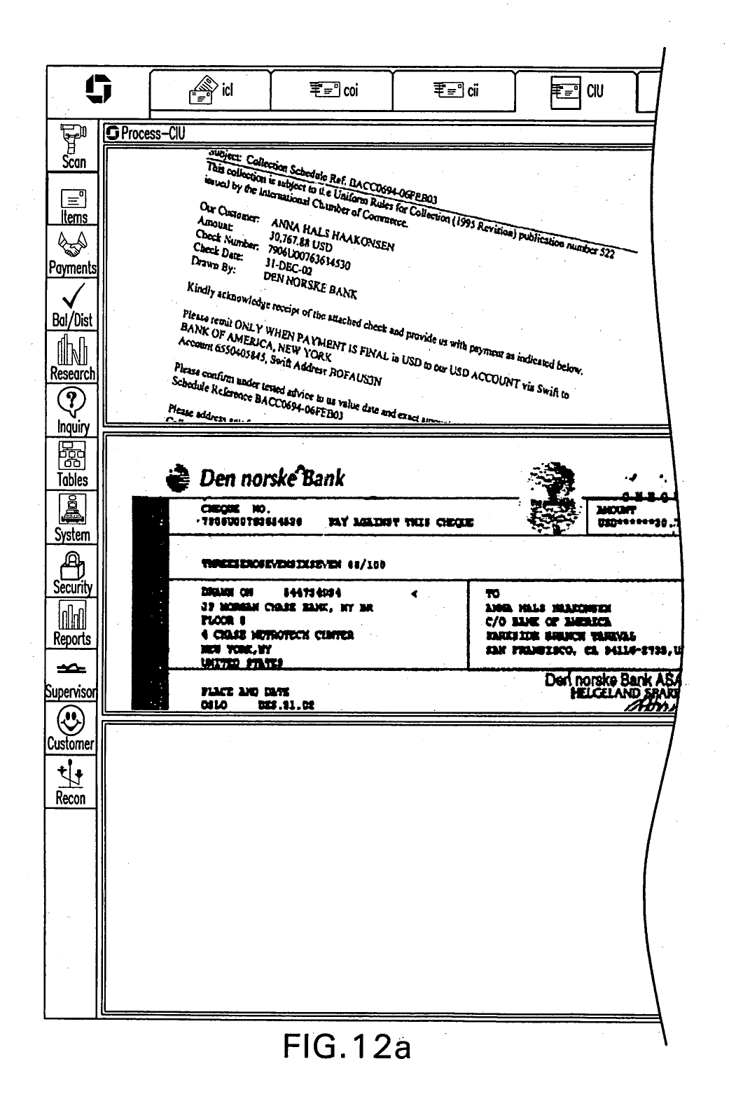

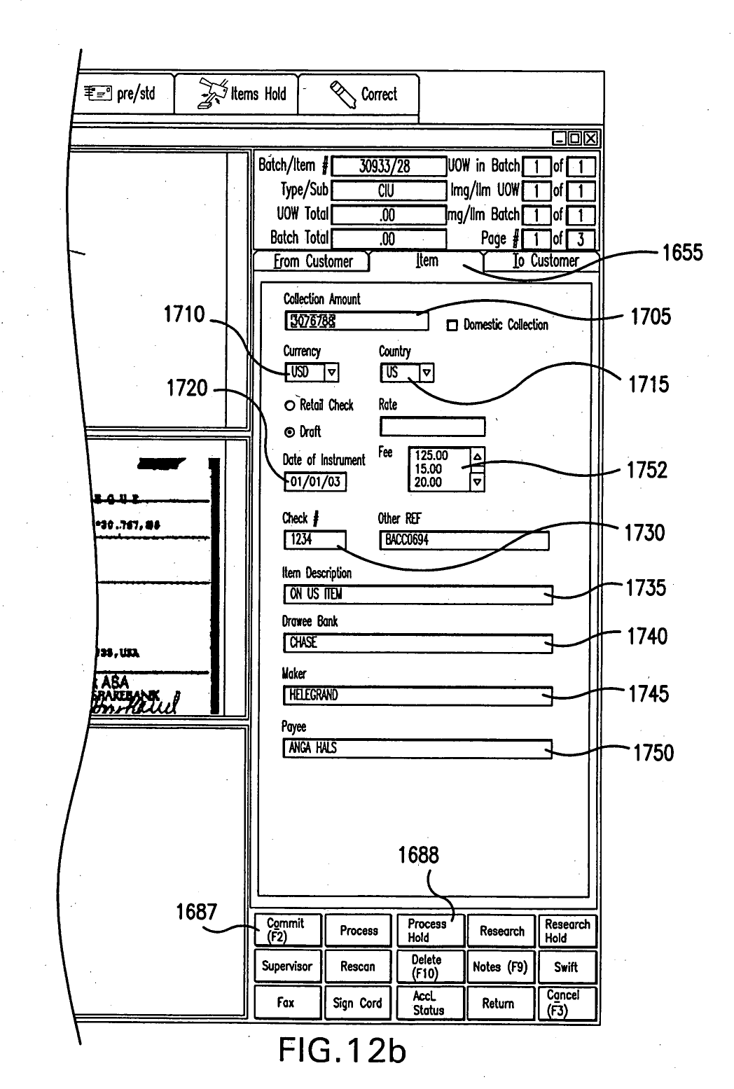

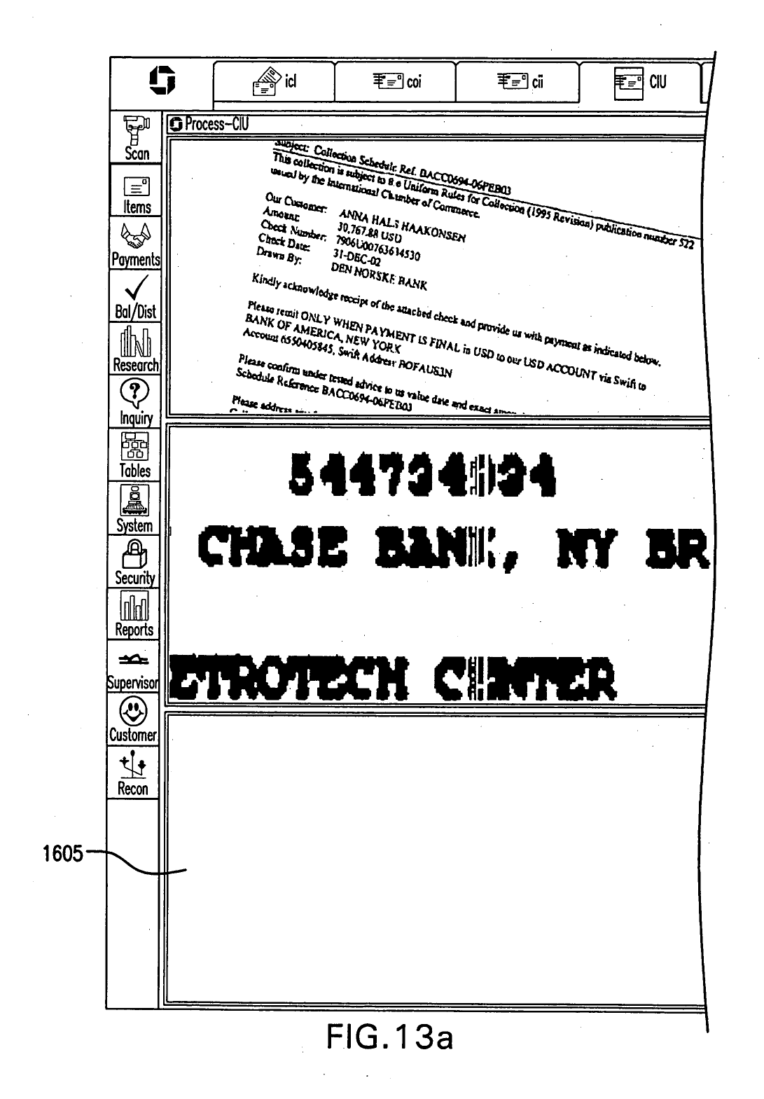

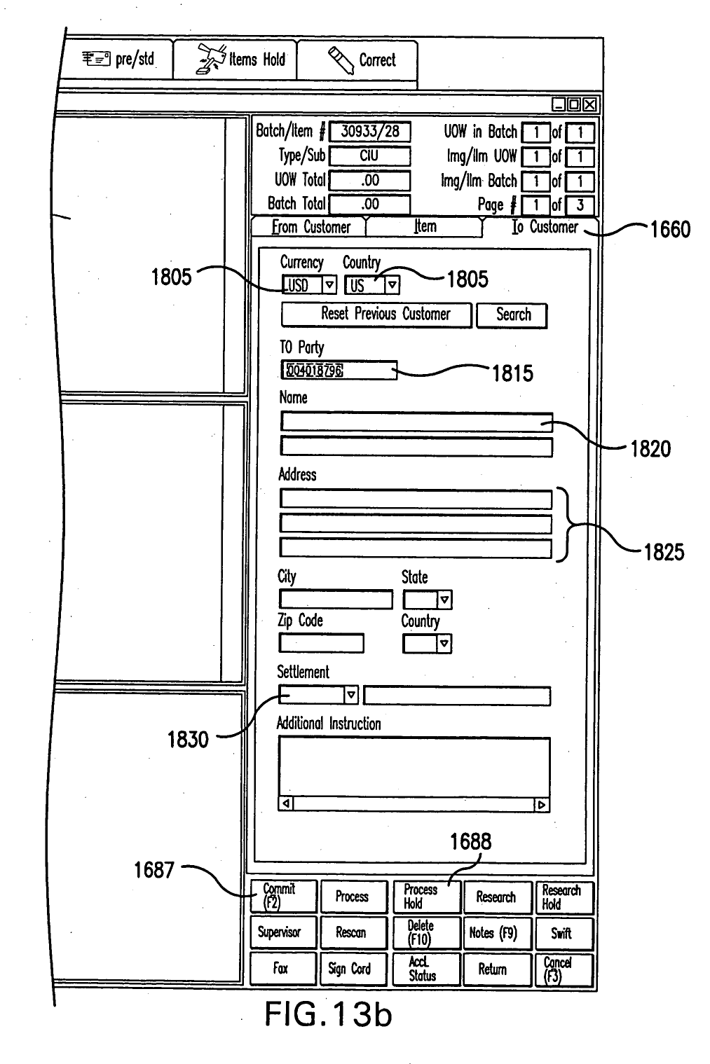

Returning to FIG. 4, once collections items have been input into the system of the present invention, as described above, the collections items are processed by the system at step 440. The Process Collection Items step 440 will next be described with reference to FIGS. 10 and 11. FIG. 10 is a flowchart depicting the flow for item processing, and FIG. 11 depicts an item processing screen, in accordance with an exemplary embodiment of the present invention. At step 1503, the IDCS user selects the “items” command button 705b. This causes the item processing module 230 of the IDCS client 130 to generate and display to the user an item processing screen 1600, depicted in FIG. 11. Across the top of process workflow screen 1600 there are seven tabs: ICL tab 1610, COI tab 1615, CII tab 1620, CIU tab 1625, Pre/Std tab 1630, Items Hold tab 1632, and Correct tab 1634. To begin processing a particular category of collections item, the user may, at step 905, select either the ICL tab 1610, the COI tab 1615, the CII tab 1620, or the CIU tab 1625, etc.

At step 1510, once the IDCS user has selected a collections item category by using one of tabs 1610, 1615, 1620, 1625, the item processing module 230 retrieves an open image-based UOW corresponding to the selected tab from the IDCS database 145. If there are no open UOWs available in the selected collections item category, the item processing module 230 simply displays a message to that effect. The message may read, for example, “No items are available for the selected type.” If the IDCS user has selected a collections item 1610, 1615, 1620, 1625 for which a UOW in fact exists, the item processing module 230 then retrieves the images corresponding to that UOW from the IDCS database 145, and display those images in image display area 1605.

Using image display area 1605, the IDCS user may examine images of the various documents associated with the UOW that is being processed. It provides the IDCS user with convenient access to an image-based folder—the UOW—that contains all the documents that are associated with the processing of the collections item, and allows the IDCS user to avoid the inefficiencies associated with organizing and tracking paper documents.

Referring to FIGS. 11 through 16, the item processing workflow screen 1605 may include various text boxes and combo boxes into which the IDCS user may enter item processing data. At step 1510, at the same time that the item processing module 230 displays the images associated with that collections item unit of work, the item processing module 230 automatically populates certain text boxes with data retrieved from the IDCS database 145. For example, the “type” text box 1635 is automatically populated with the collections item type that was previously entered during scanning and indexing step 430 for that unit of work. The item processing module 230 also populates the “batch” text box 1640 with the batch number assigned to that unit of work during scanning and indexing step 430.

At step 1520, the user enters data into those text boxes in the item processing workflow screen 1605 that are blank. Various sorts of data are entered by the user at step 1520 that identify, for example, the party from whom the collections item was received, reference information about the collections item itself, and information identifying the party to whom payment will be made.

For example, referring to FIG. 11, the item processing workflow screen 1605 includes a “from customer” tab 1650, an “item” tab 1655, and a “to customer” tab 1660. Under the “from customer” tab 1650, the user may enter in the “account number” text box 1665, the account number of the customer from whose account money is to be withdrawn once processing of the collections item is complete. The IDCS user also enters the “from” customer's name under the “name” text box 1670, and the “from” customer's address in the “address” text boxes 1675.

As an alternative to manually entering the “from” customer's information, the IDCS user may simply enter the first few characters (if known) of the “from” customer's name into the “account number” textbox 1665. This causes the item processing module 230 to query the IDCS database 145 for a listing of all customer names and addresses that are stored in the database 145 that start with those same three letters. The item processing module 230 then displays the listing returned by the IDCS database 145 to the IDCS user, so that the IDCS user may select a customer name from that listing. Once selected, the item processing module 230 inserts the “from” customer's information into textboxes 1665, 1670, and 1675 as appropriate. Preferably, one or more fields of information related to a customer can automatically be populated by the system accessing an internal customer verification facility.

FIG. 12 shows the contents of the item tab 1655 of the process workflow screen 1605. Referring to that figure, under the “item” tab 1655, the IDCS user enters information about the collections item itself. The amount of the collections item is entered in the “collection amount” textbox 1705. Under the currency drop down box 1710, the IDCS user may enter the currency type and the country of origin of the collections item in dropdown box 1715. In the “date of instrument” textbox 1720, the IDCS user may enter the date that the instrument was created. In the “check no.” textbox 1730, the IDCS user enters the check number from the face of the check. In the “description” textbox 1735, the IDCS user may enter a description of the collections item. In the “drawee bank” textbox 1740, the IDCS user enters the name of the bank on which the instrument is drawn. In the “maker” textbox 1745, the IDCS user enters the name of the person or entity who drafted the instrument. In the “payee” textbox 1750, the user enters the name of the person or entity to whom payment is to be remitted. In the fees combination box 1752, fees that are associated with item processing are listed. These fees may include upfront fees, air courier, SWIFT, fax, or image fees.

FIG. 13 depicts the data entry under the “To Customer” tab 1650. Referring to that figure, the IDCS user enters the type of currency in “currency” textbox 1805, and the country of origin of the item in “country” textbox 1805. The IDCS user may utilize the item processing module's 230 search function to retrieve all banks that settle the currency, country, and type entered for that item level. The banks are displayed on a grid. Once the IDCS user selects the appropriate bank, information is automatically populated in the “To party” textbox 1815, preferably with reference to a stored database of bank information. The IDCS 100 also automatically fills in the “name” textbox 1820 with the customer's name, and the “address” textbox 1825 with the customer's address. Alternatively, if the IDCS user knows the information, he may manually fill out textboxes 1815, 1820, and 1825 without using the above-described search function.

In the “settlement” dropdown box 1830, the IDCS user may choose the method by which payment is settled. The choices listed in dropdown box 1830 may include demand deposit account (DDA), FEDWIRE, cashier's check, or CHIPS. The default settlement method is DDA, the DDA account number being the one listed in the “To party” textbox 1815.

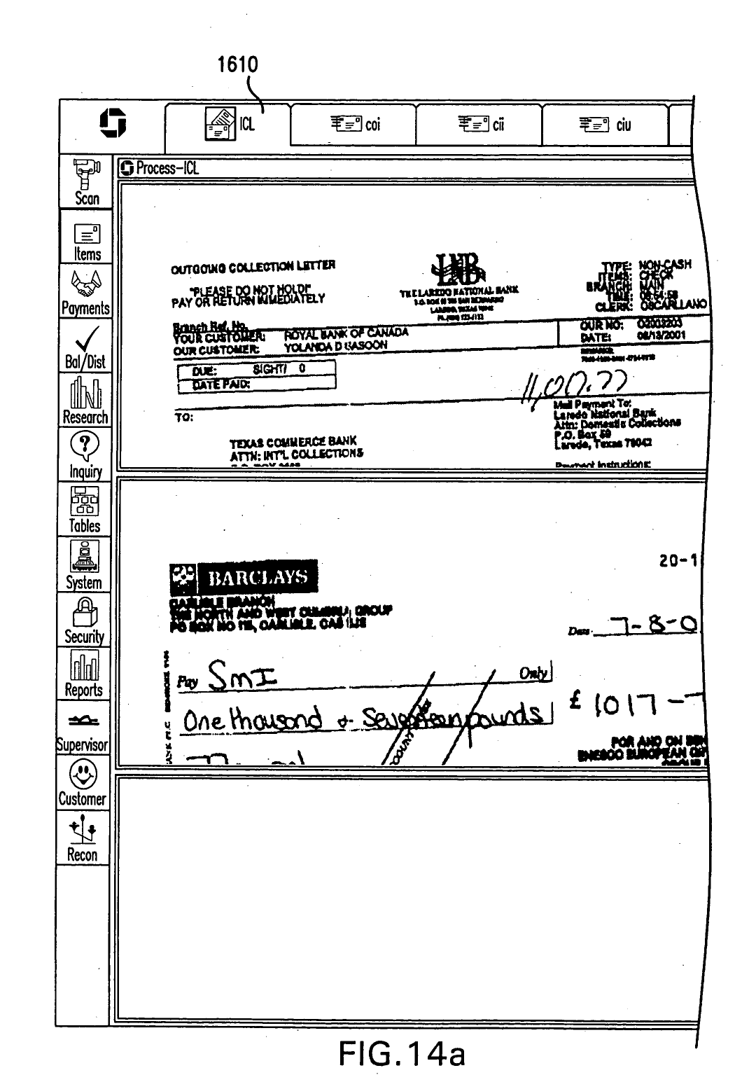

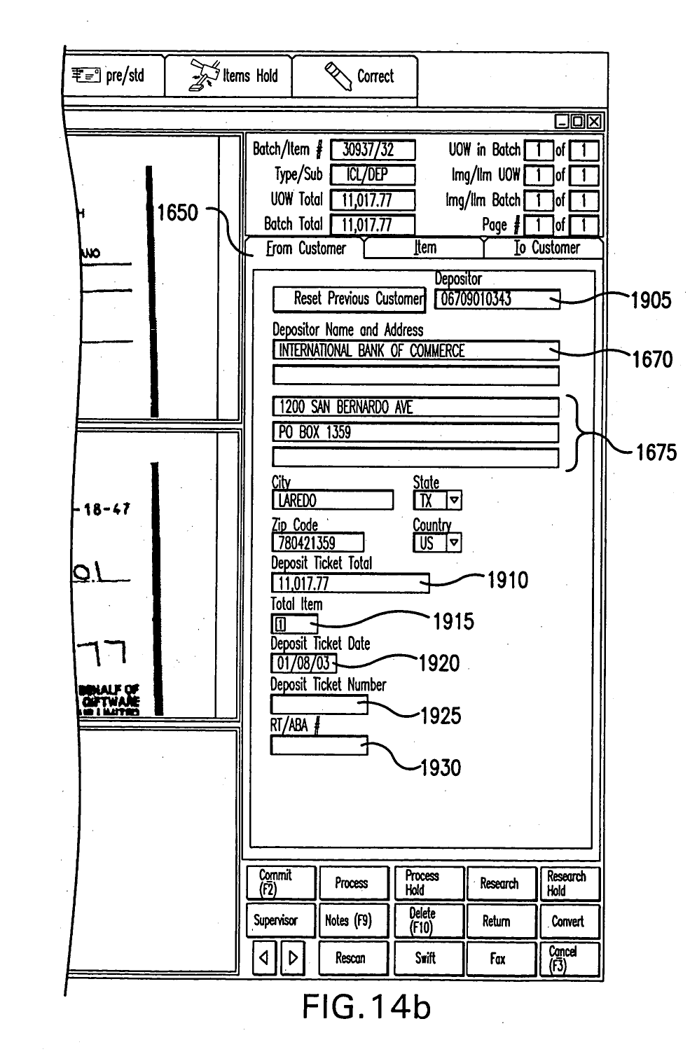

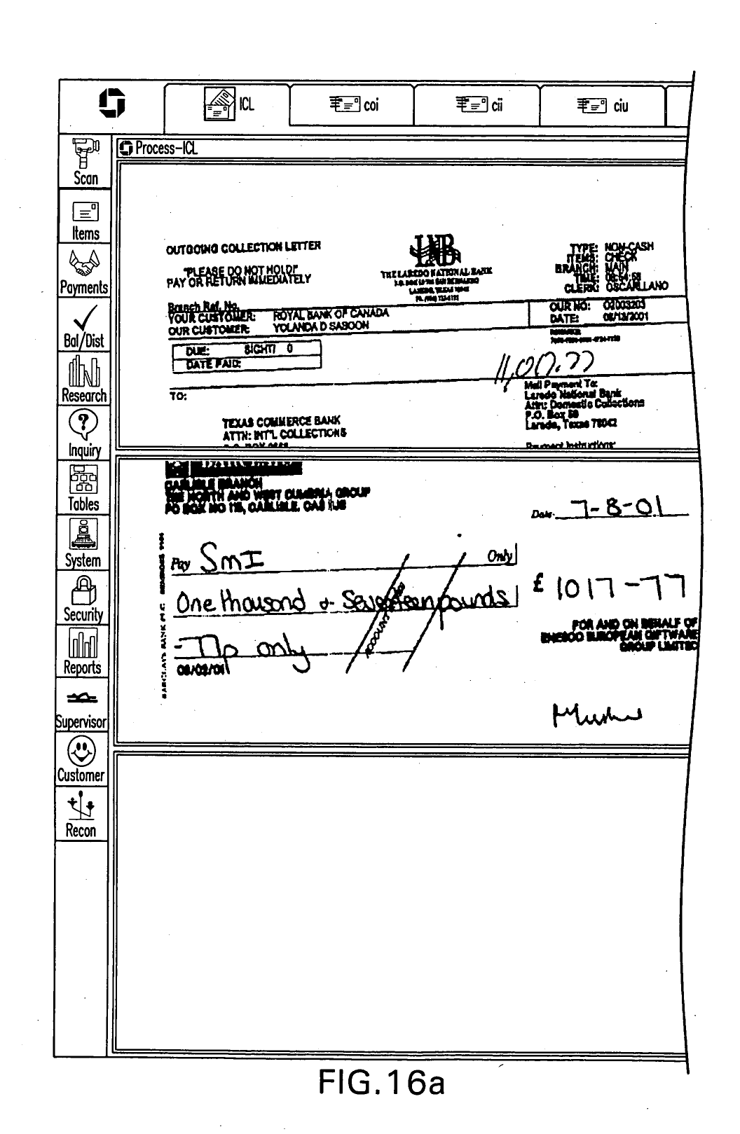

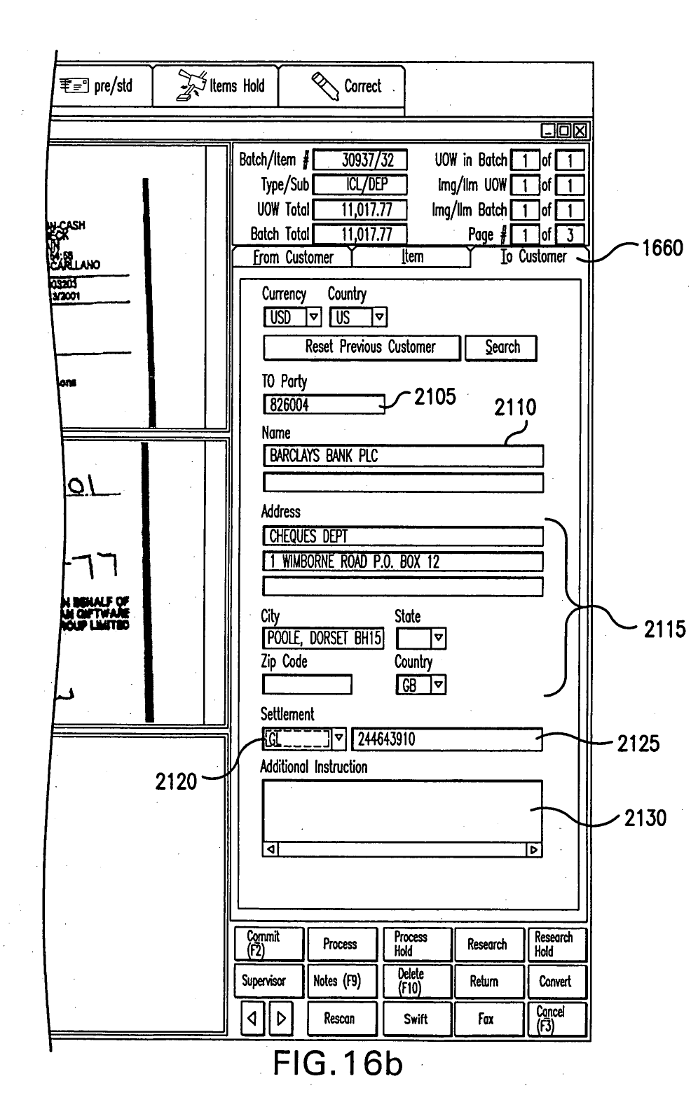

FIG. 14 shows an item processing screen for ICL 1610. As in FIG. 16, selecting the From Customer tab 1650 causes certain fields to be displayed. Depositor entry field 1905 displays the depositor number. Depositor name and address are displayed in fields 1670 and 1675, substantially identical to corresponding fields in FIG. 16. Field 1910 displays the Deposit Ticket Total and field 1915 displays the Total Item. Field 1925 displays the Deposit Ticket Number, while field 1930 displays the RT/ABA number.

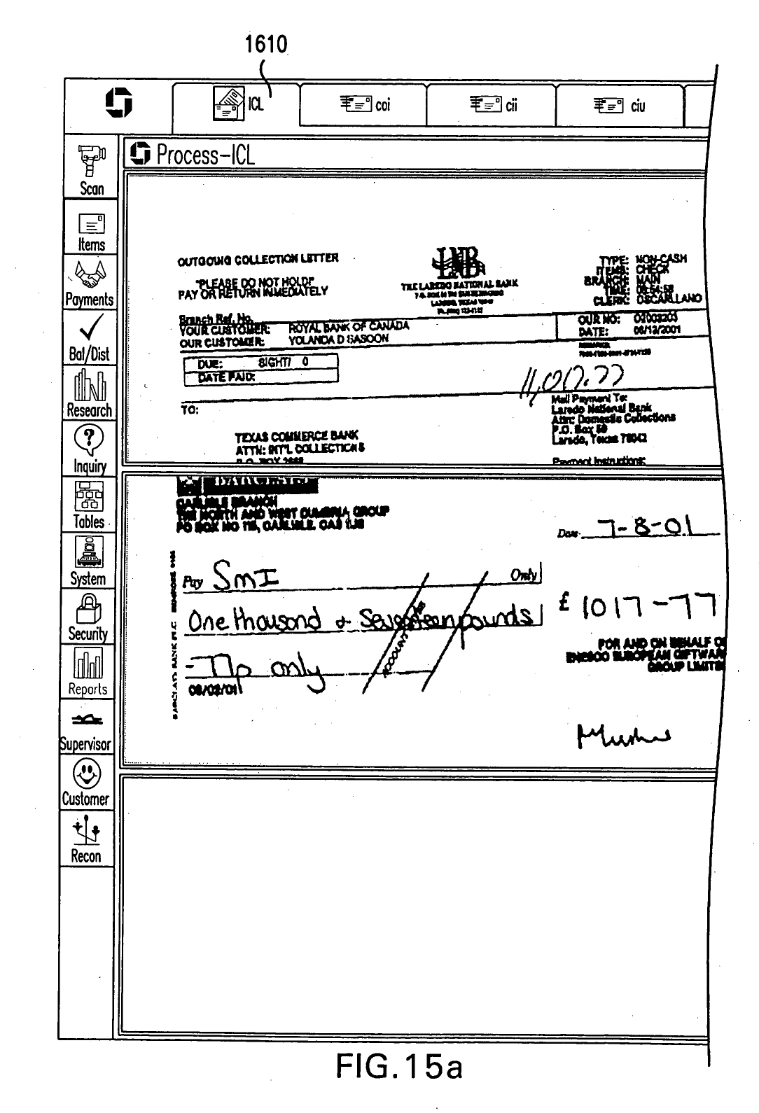

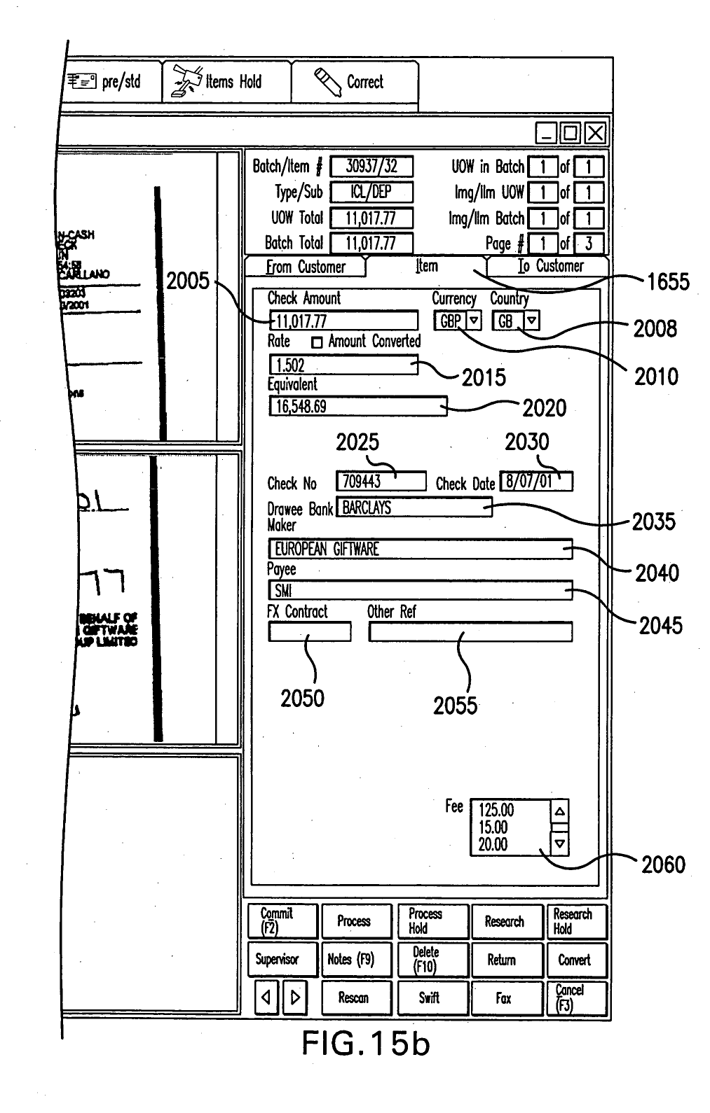

FIG. 15 shows the item processing screen shown in FIG. 14, but with the Item tab 1655 selected to reveal the data entry fields available there. The amount of the check being processed appears in the check amount field 2005. The country of the check, in this case Great Britain (GB) is displayed in country field 2008, while the currency appears in currency field 2010, in this case British Pounds (GBP). The conversion rate appears in the rate field 2015 and the equivalent amount in U.S. dollars appears in the equivalent field 2020. Check no. field 2025 displays the check number of the check being processed, while the check date and drawee bank are displayed in the check date field 2030 and drawee bank field 2035, respectively. Maker field 2040 and payee field 2045 are also provided at the item tab 1655. This tab also provides a Foreign Exchange (FX) contract field 2050 and another ref field 2055. Fee field 2060 displays any fees if necessary or required.

FIG. 16 shows the item processing screen shown in FIG. 14, but with the To Customer tab 1660 selected to reveal the data entry fields available there. The To party field 2105 displays a number corresponding to the party who will pay the item. The name field 2110 displays the name of the party who will pay the item The party's address appears in the address fields 2115. Settlement field 2120 shows how the item will pay, e.g., by DDA, Cashier's Check, FEDWIRE. Field 2125 shows the account number the system will settle to. Additional instruction field 2130 provides space for entry of any appropriate additional instruction.

If the IDCS user is missing some of the information that is needed to complete item processing for a particular collections item unit of work, the user may select the “process hold” command button 1688. This places that unit of work in a “process hold” queue, which is maintained by the IDCS server's 140 queue module 310 (FIG. 3). The IDCS user may then move on to the next collections item unit of work. The IDCS user may return to a collections items units of work in the “process hold” queue by selecting the “hold” tab 1632. Selecting the “hold” tab 1632 causes the item processing module 230 to generate and display a list of all the collections items in the “process hold” queue. The IDCS user may select one or more of the displayed collections item that are on “process hold.” The item processing module 230 then displays the normal item processing workflow screen 1605 for that item, and the IDCS user may complete the processing of that collections item. While an item is in process hold, a message is regularly sent to the IDCS user reminding him that the item is in process hold.

Once the IDCS user has completed entering all the data required by the item processing module 230, the IDCS user may commit the collections item by selecting the “commit” command button 1687. Selecting the commit command button 1687 causes the item processing module 230 to save all the entered data to the IDCS database 145. The item processing module 230 then sends a SWIFT, fax, or paper notification that the collections item has been processed to the presenting institution and/or customer. The collections item is now ready for balance and distribution (“B&D”) at step 440 of the flowchart of FIG. 4.

Balance and Distribution of Collections Items Step 450

Referring once again to FIG. 4, once the processing step 440 is completed, the IDCS user may proceed to the balance and distribution (“B&D”) step 450. The balance and distribution process balances out the accounts and distributes funds and prints out debits and credits for an entire day in addition to distributing funds via check, FEDWIRE or SWIFT. In the case of ICL's, the balance and distribution function receives the processed items and creates a Cash Letter (a summary list of collection items), preferably one per day per endpoint, and also prints out customer advices of credit/debit. In particular, bundle sheets and items are wrapped with the cash letter and sent to the endpoint institution for payment. With regard to collections items, whether COI, CII or CIU, the B&D function creates a collection letter, one per item and prints out customer acknowledgments. The item is attached to the collection letter and sent to the endpoint institution for payment. In the case of Premier/Std collection items, the B&D function creates deposit tickets and collection items are stacked behind the printed deposit slip and sent to a check processing area of the bank for clearing.

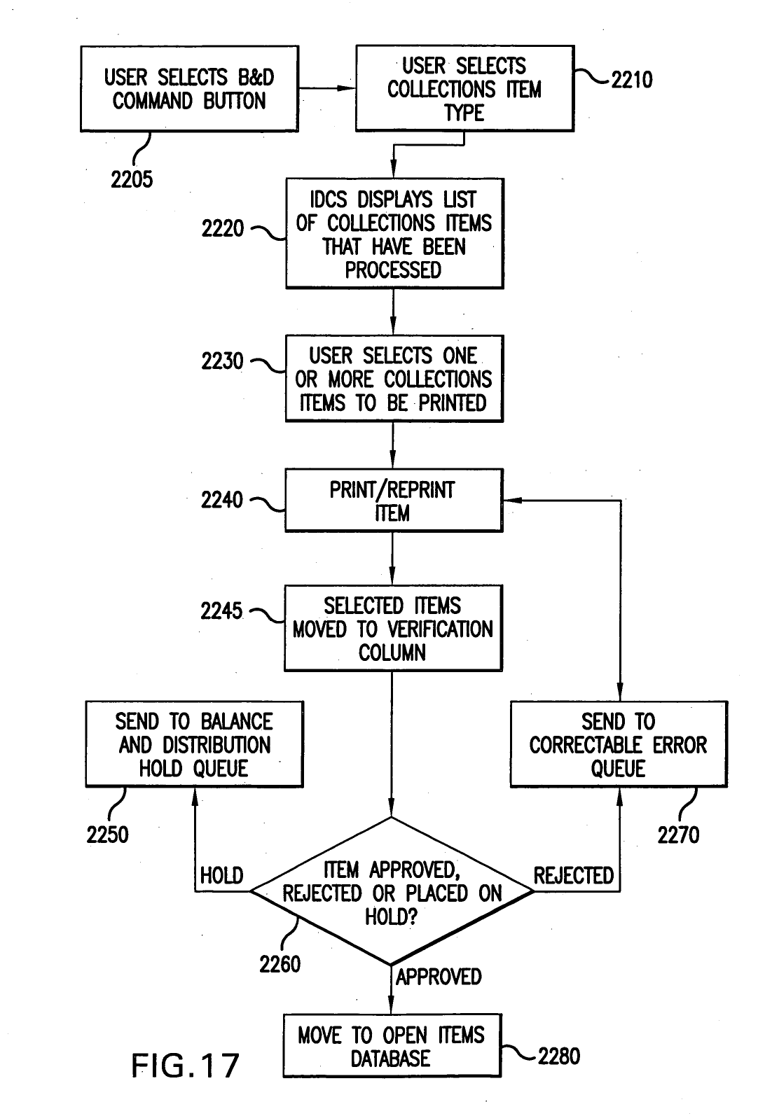

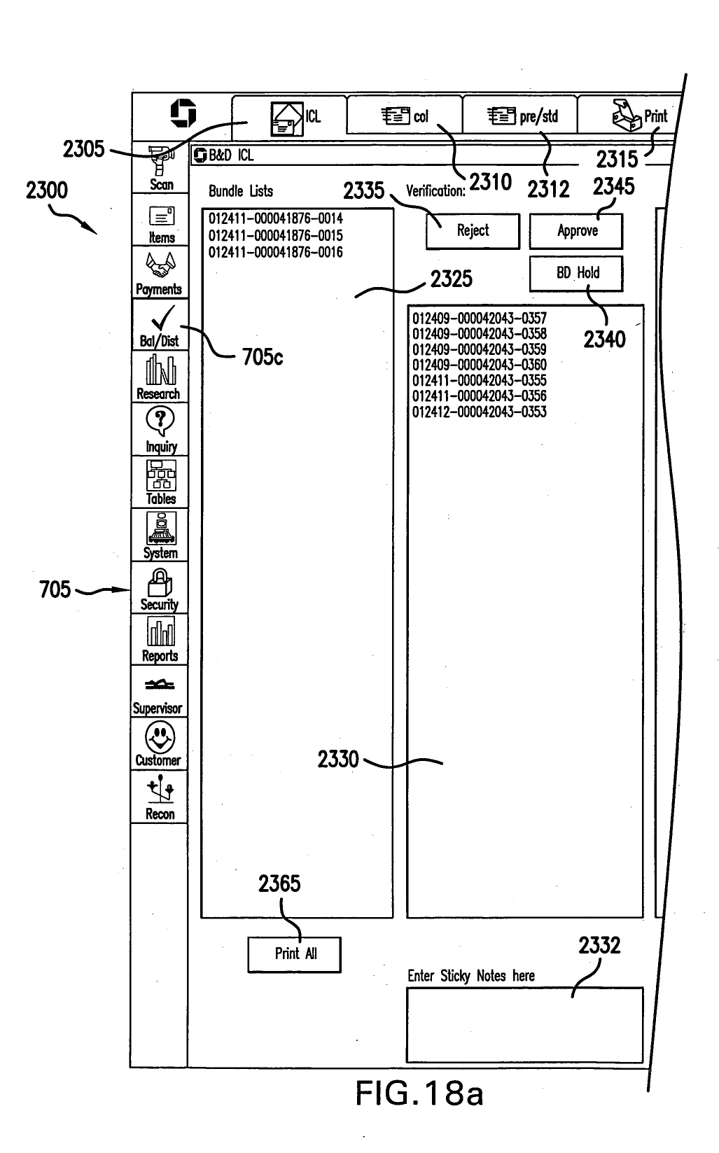

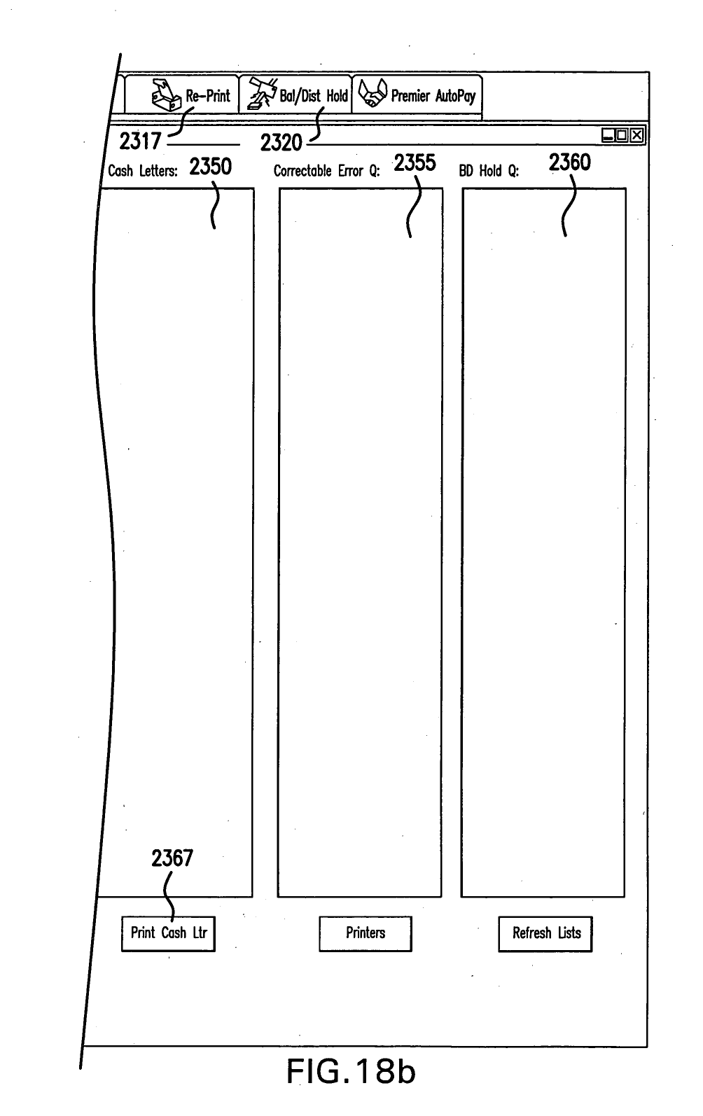

FIG. 17 is a flowchart depicting the B&D process in accordance with an exemplary embodiment of the present invention. FIGS. 18 through 21 are diagrams depicting B&D workflow screens in accordance with an exemplary embodiment of the present invention. At step 2205, the IDCS user clicks the Bal/Dist button 705c, located on menu bar 705, to begin the B&D process. Clicking the Bal/Dist button 705c causes the IDCS client's 130 B&D module 250 (FIG. 2) to generate and display a default B&D screen to the IDCS user. In one exemplary embodiment, the default B&D workflow screen may be cash letter B&D screen 2300

At step 2210, the IDCS user indicates whether he wishes to perform balance and distribution tasks for a cash letter item or for a collections item by selecting the appropriate one of the ICL tab 2305 or the COL tab 2310. In response to the IDCS user's selection of ICL tab 2305 or COL tab 2310, the balance and distribution module 250 generates and displays a list of those items that have been processed. The IDCS user may then choose an item from the generated list for verification and printing.

This process will now be described in relation to selection of the ICL tab 2305, which causes a B&D screen 2300 to be generated and displayed to the IDCS user. An exemplary B&D screen 2300 for display when the ICL tab 2305 is selected is shown at FIG. 18. At step 2220, all collections items for which processing has been completed are listed in bundle lists column 2325. If the ICL tab 2305 is selected, cash letter items are listed under the bundle lists column 2325. At step 2230, the IDCS user selects one or more of the collections items listed in bundle lists column 2325. At step 2240, the IDCS user causes selected items to be moved from the bundle lists column 2325 to the verification column 2330.

At step 2260, the IDCS user selects a collections item listed in the verification column 2330, and either rejects it, approves it, or sends it to the B&D hold queue by clicking the appropriate button, e.g., the reject button 2335, the approve button 2345, or the B&D hold button 2340. Clicking the Print All button 2365 prints the collection letter or IDCS bundle sheetsBundle sheets are generated when the IDCS user selects one or more cash letter item in the bundle list column. The bundle sheet lists the item(s) referencing their batch number, item number and check number. The bundle sheets provide a total currency amount and item count. Clicking the reject button 2335 at step 2270 causes the selected cash letter item to be sent to the correctable error queue column 2355. Items in the correctable error queue column 2355 are assigned a status of “process hold” and sent back to the item processing module 230 for further processing. At step 2250, clicking the B&D hold button 2340 sends the item to the B&D hold queue column 2360. The item is held in the B&D hold queue until the IDCS user has completed verification and has approved the collections item.

Another feature of the verification column 2330 is the ability to apply electronic “sticky notes” to selected collections items. When the IDCS user selects a collections item in the verification column 2330, a sticky notes text box 2332 is made available for use by the IDCS user. The IDCS user may enter notes or remarks about the selected item in the displayed text box. The B&D module 250 automatically associates any text entered into the displayed textbox with the selected item, causing that text to be displayed as an electronic “sticky note” any time that collections item is selected by the IDCS user at any point in the IDCS process.

At step 2280, clicking the approve button 2345 approves the collections item for printing, and moves the collections item to the approved items column 2350. The IDCS user may print the cash letter item by clicking the print button 2370. Once the cash letter item has actually been printed, it is removed from the approved items column 2350 and its status is set to “open.” Open collections items are placed in the “open” queue of the queuing module 310. Items in the “open” queue are ready for the payment step 460, described in greater detail below.

If the COL tab 2310 is selected instead, the process shown in the flowchart of FIG. 17 is carried out. The difference between what is displayed upon selection of the ICL tab 2305 and that shown upon selection of COL tab 2310 (the screen for which is not shown) lies primarily in what type of collections items are listed for selection. If the ICL tab 2305 is selected, cash letter items are listed under the bundle lists column 2325 and are eligible for selection. If the COL tab 2310 is selected, all collections item types except cash letter items (e.g., COI, CII, CIU, etc.) are listed in column of items eligible for selection. Just as in the case in which the ICL tab 2305 is selected, items from this column of items eligible for selection are selected by the user for verification, as well as the other operations detailed in the flowchart of FIG. 17.

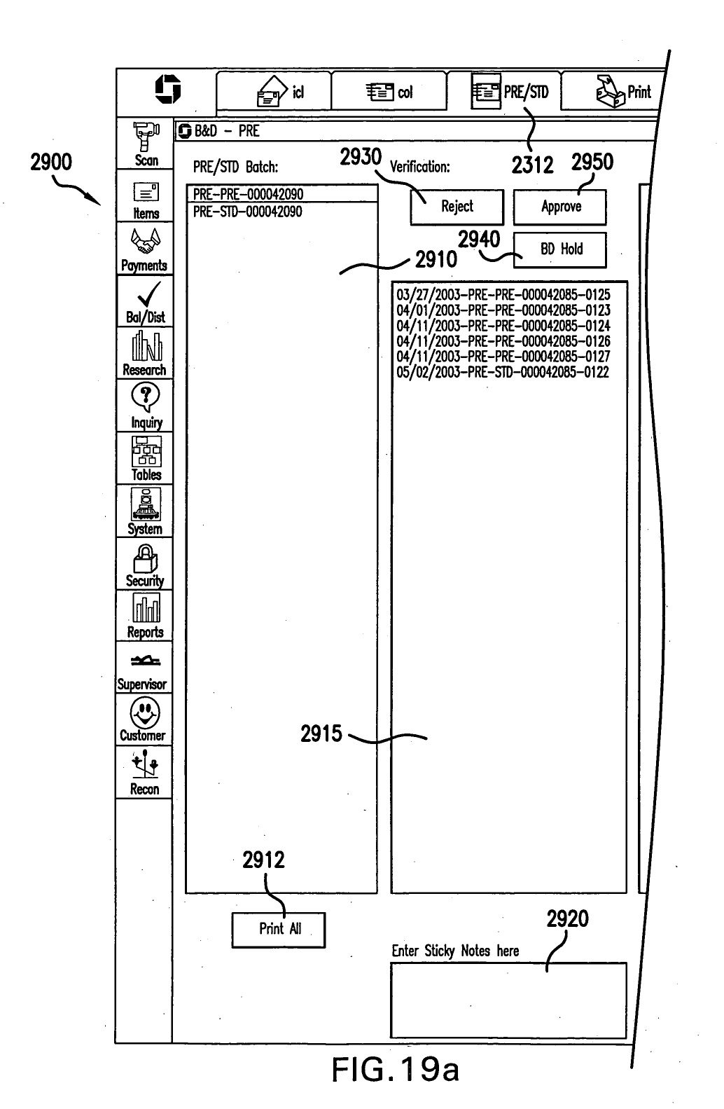

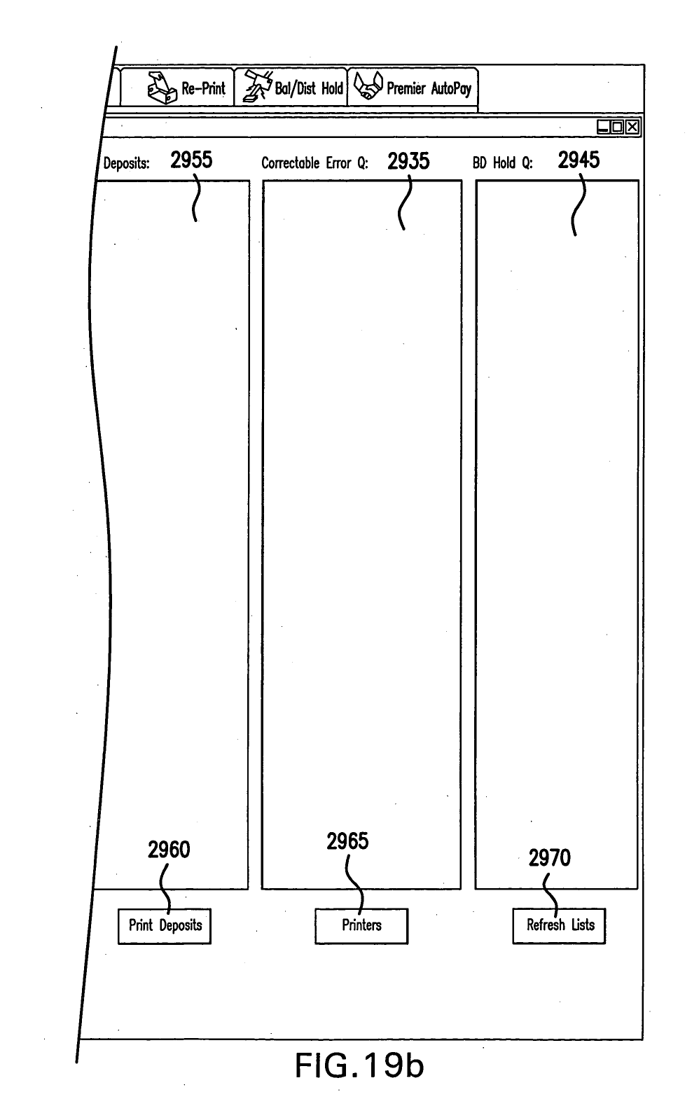

Returning to FIG. 18, selection of the “PRE/STD” tab 2312 in that figure causes the B&D module to generate and display a B&D PRE/STD screen 2900, which is shown in FIG. 19. The deposit ticket reference number is set when the item is first moved to the PRE/STD batch column 2910 in balance and distribution processing. This column lists the PRE/STD committed batches from item processing that are ready for the premier item deposit list to be printed. The items preferably are sorted and grouped by type, subtype and batch number. Type/Subtype may have values: Pre/Pre, Pre/Std, or Std/Std.

The print all button 2912 is used to print the premier deposit item lists and the printed items are moved to verification column 2915. The verification column 2915 is a display of the individual items printed from the previous column. The items may be grouped for processing by clicking on an item in the list. Preferably, the items thus selected are sorted and grouped by type, subtype, batch number and item number.

When an item is selected, a text box 2920 for sticky notes appears allowing the user to attach a note to that item by typing in the field. The reject button 2930 sends the selected items to collectable error Q, which is preferably for information only. This action causes the item to be available for review only in the correctable error Q column 2935. Items appear in this column only when they are rejected from the verification column. This column is for information only, and items cannot be selected from here. The BD hold button 2940 sends selected items to the BD hold queue and causes them to appear in the BD hold Q column 2945, which is for review only. Items appear in this column only when the BD hold button 2940 is clicked from the Verification column.

The approve button 2950 approves the item for Deposit Ticket printing and moves the items to the deposit column 2955. Entries in the deposit column 2955 are sorted and grouped by deposit reference number and value date. The deposit reference number is a 10-digit deposit reference number assigned at approval of the verification screen. The value date is the value date of the deposit ticket.

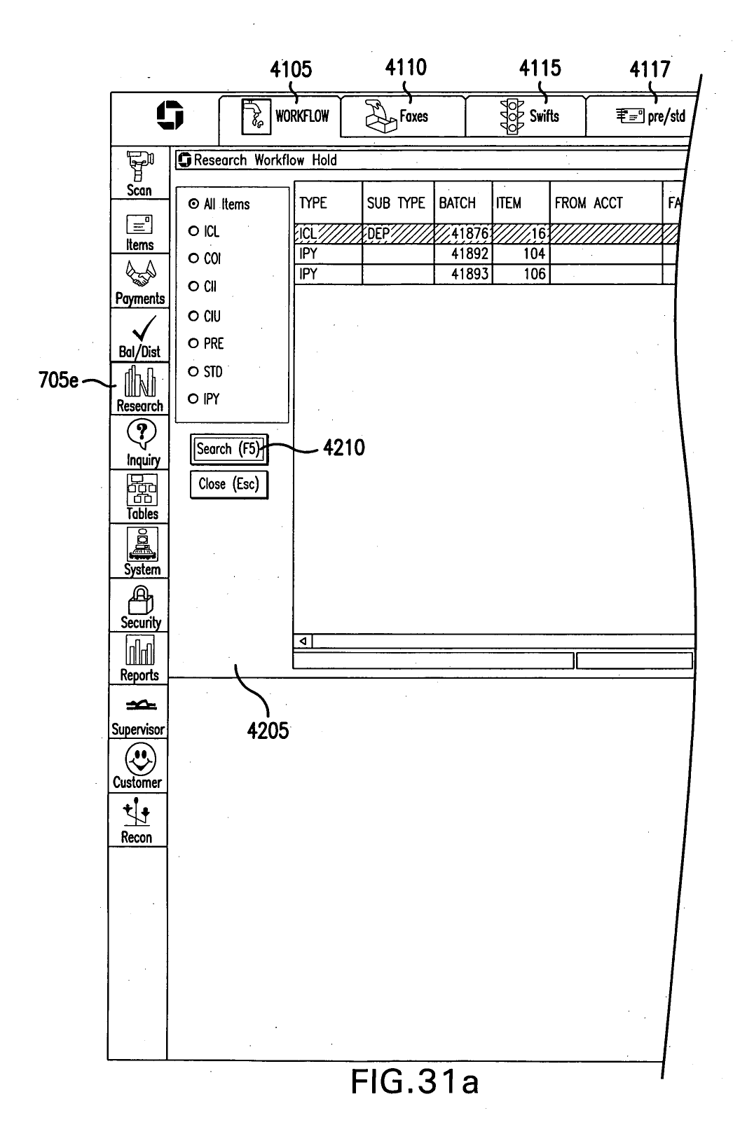

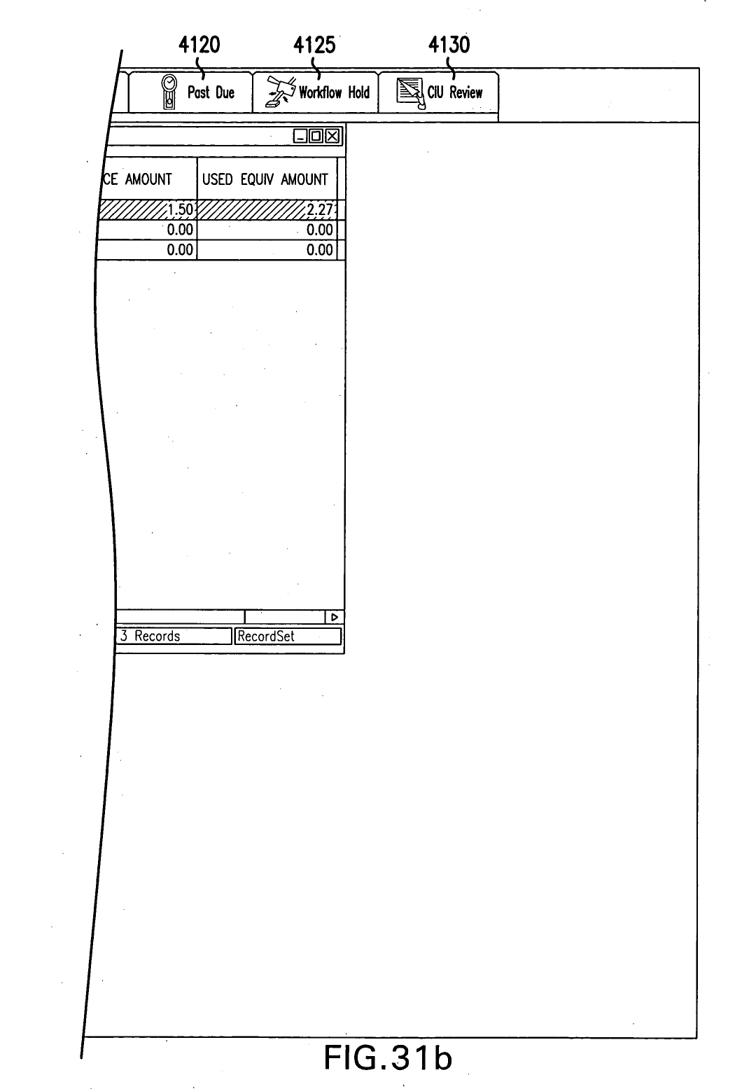

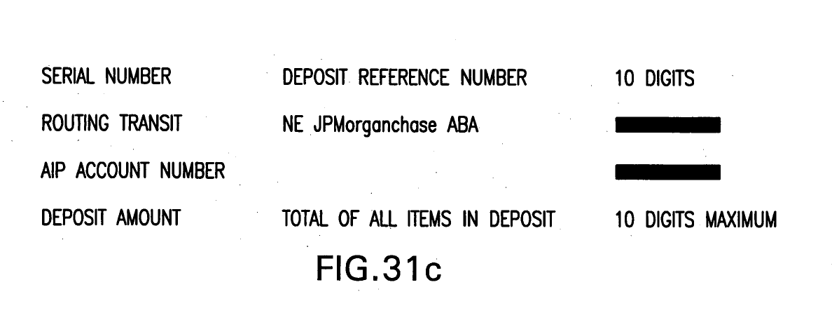

Deposit tickets can be selected for printing by highlighting them and clicking the print deposit button 2960. If an item is rejected, the system of the present invention preferably forces reprinting of the credit listing. The deposit is out of balance if any item has been rejected or has been moved to the correctable error column. The Premier Deposit Item list is reprinted automatically with the correct information. The selected PRE/STD deposit tickets are printed, the status is changed to open waiting payment, and items are removed from the deposits column 2955. The deposit ticket must be printed with a MICR quality ribbon. A sample deposit ticket format is shown in FIG. 31A.

The printers button 2965 is used to display a standard Windows printer selection dialog box, which allows a printer to be selected for use. The Windows default printer is used if a printer is not selected with this button. The refresh lists button 2970 causes all columns to be updated, with changes effected by other users.

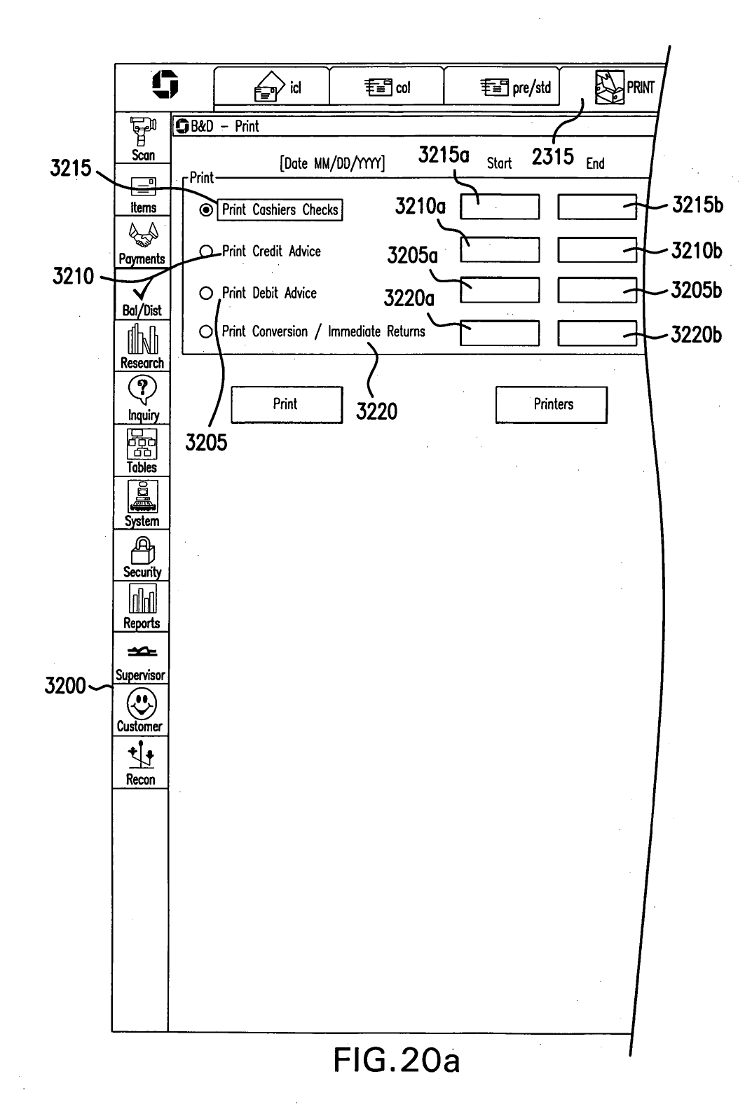

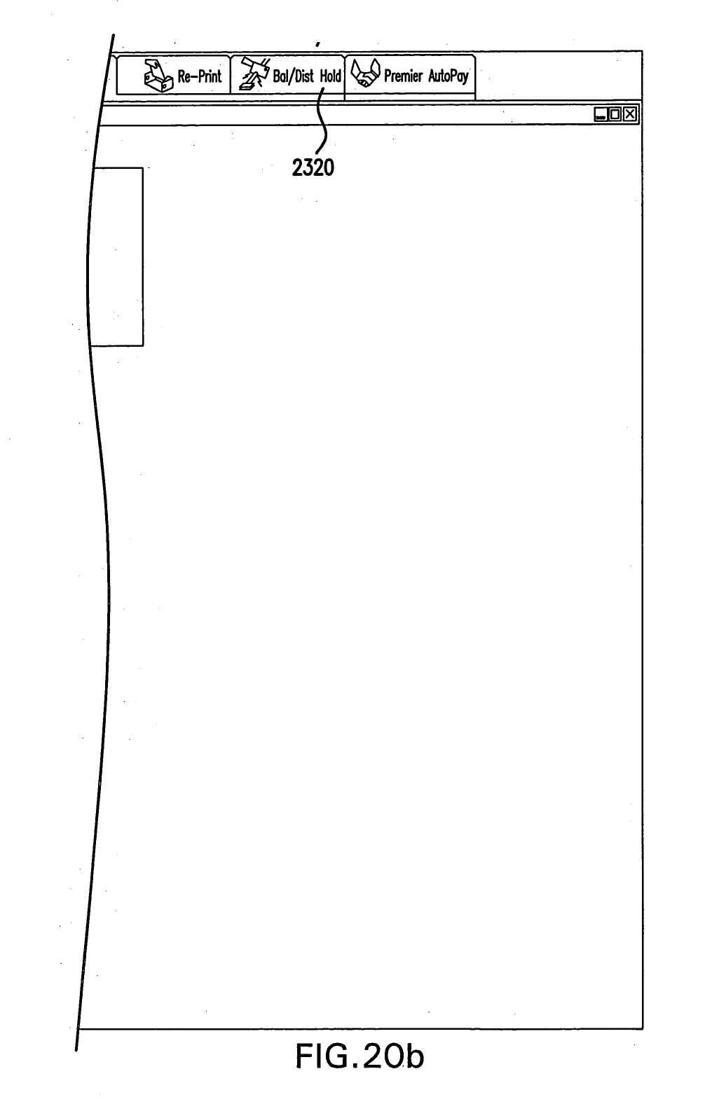

Returning to FIG. 18, selection of the “print” tab 2315 in that figure causes the B&D module to generate and display a B&D print screen 3200, shown in FIG. 20, in accordance with an exemplary embodiment of the present invention. From screen 3200, the IDCS user may print debits, credits, cashier's checks and wire notices by selecting print debit advice radio button 3205, print credit advice radio button 3210, print cashier's checks radio button 3215, or print conversion/immediate returns radio button 3220, respectively. Preferably, only one of radio buttons 3205, 3210, 3215, 3220 may be selected at a time. A range of collections items with a starting and ending number may be entered in corresponding start number textboxes 3205a, 3210a, 3215a, 3220a and end number textboxes 3205b, 3210b, 3215b, 3220b. Clicking print button 3245 causes the selected category 3205, 3210, 3215, 3220 to be printed for the range of collections items entered in textboxes 3205a-b, 3210a-b, 3215a-b, 3220a-b. If no range of collections items is entered in textboxes 3205a-b, 3210a-b, 3215a-b, 3220a-b, the selected category 3205, 3210, 3215, 3220 is printed for all available collections items.

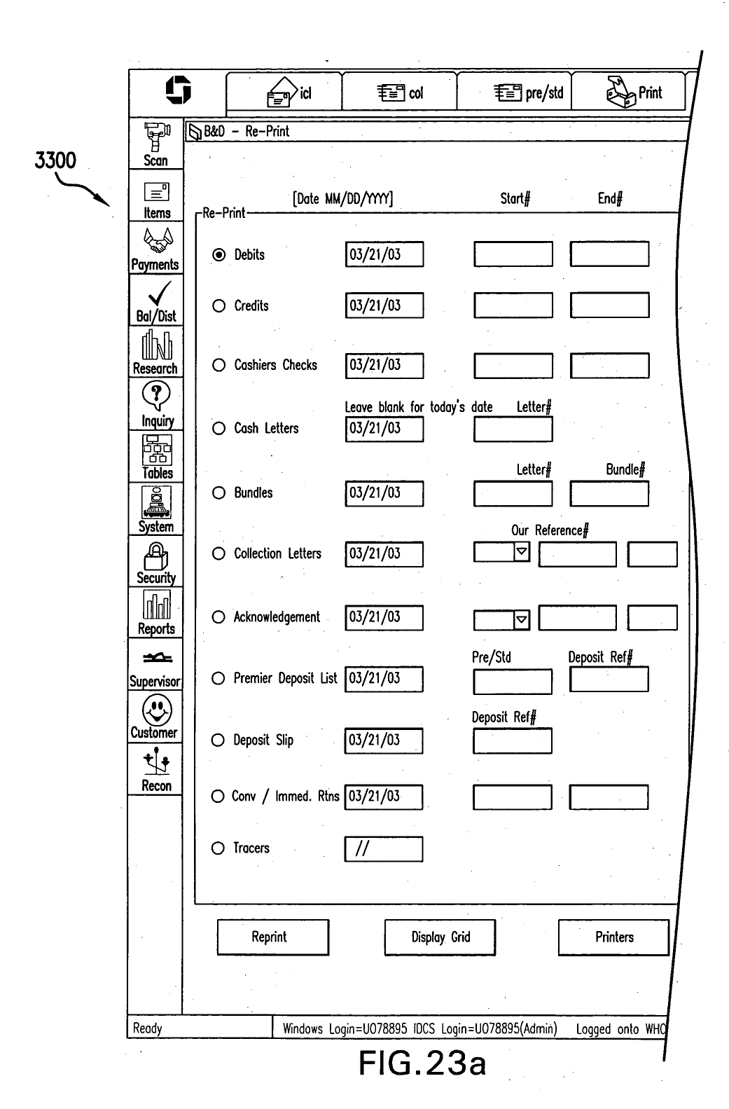

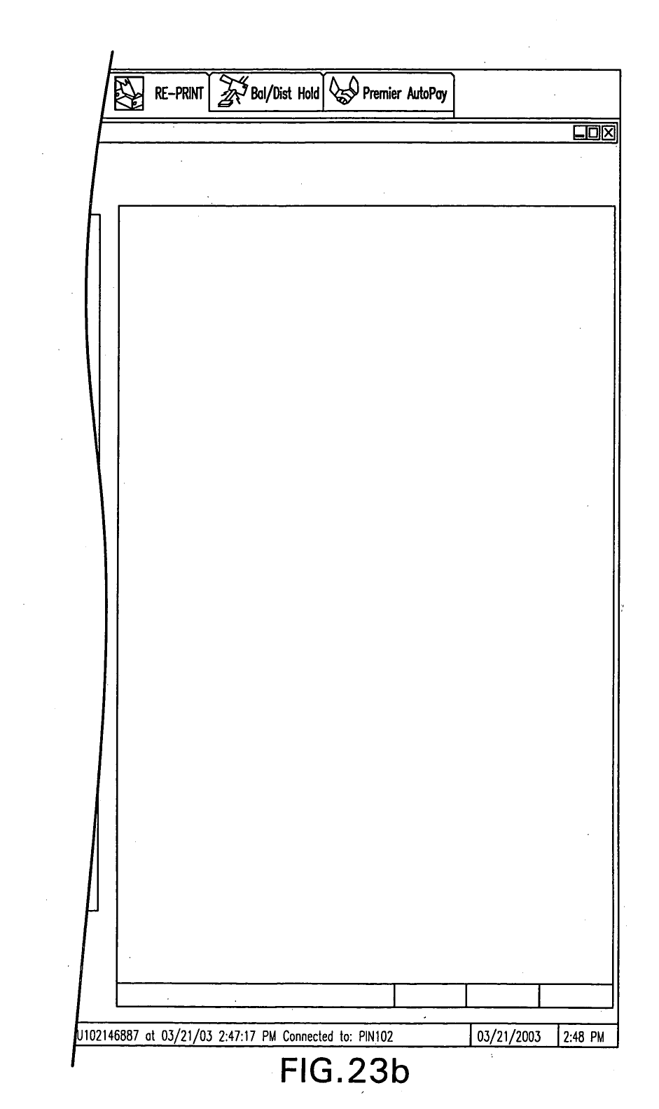

Returning to FIG. 18, selection of the “re-print” tab 2317 in that figure causes the B&D module to generate and display a B&D re-print screen 3300, shown in FIG. 23, in accordance with an exemplary embodiment of the present invention. As was described above, bundle lists will have to be reprinted if any item in that deposit was moved to the correctable error column or the BD hold column. This is necessary because the deposit will be out of balance, causing the bundle listing to be out of balance. The reprint function allows the user the ability to reprint any documentation that was produced by IDCS and listed in the “Re-print” module for any given date.

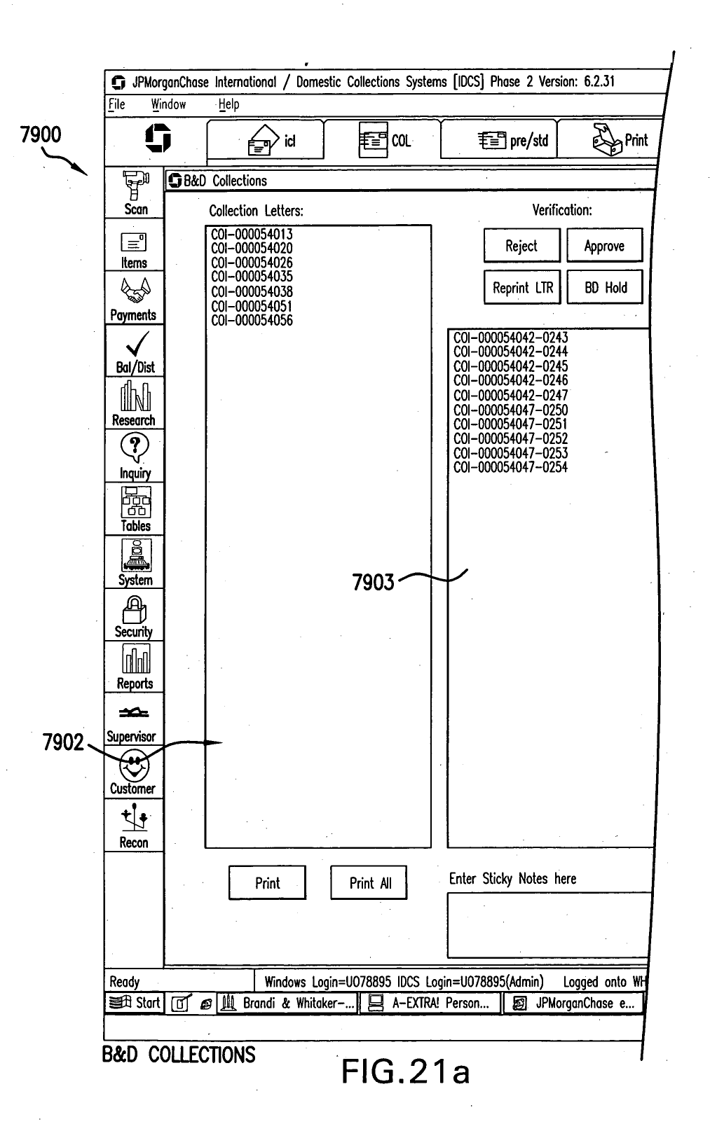

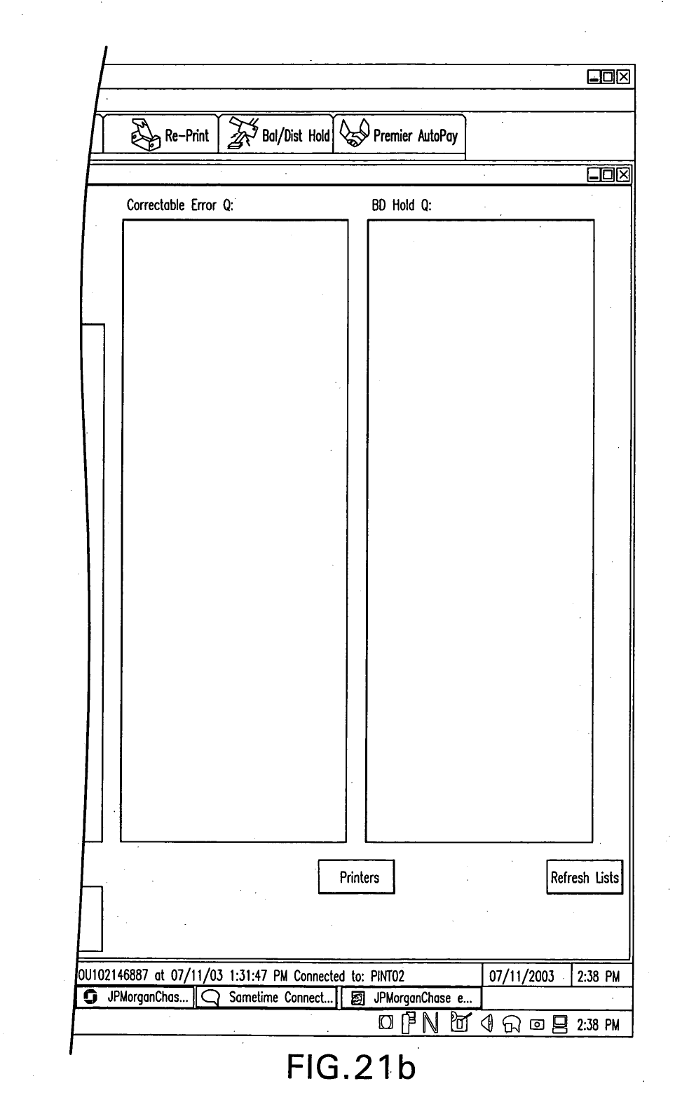

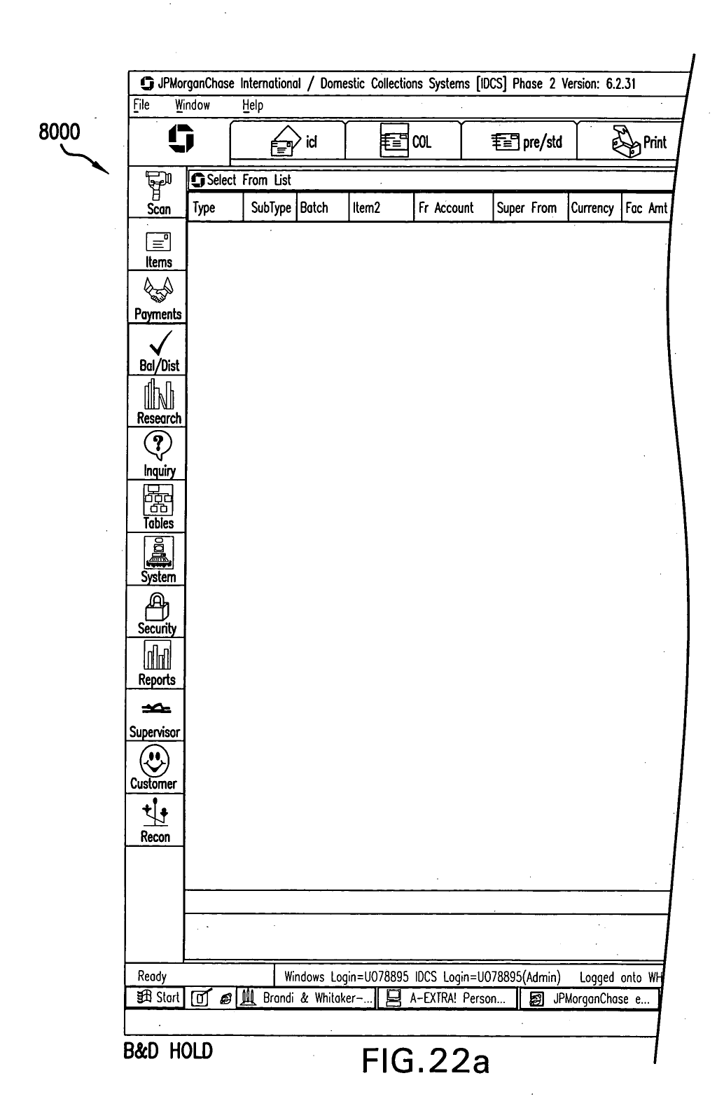

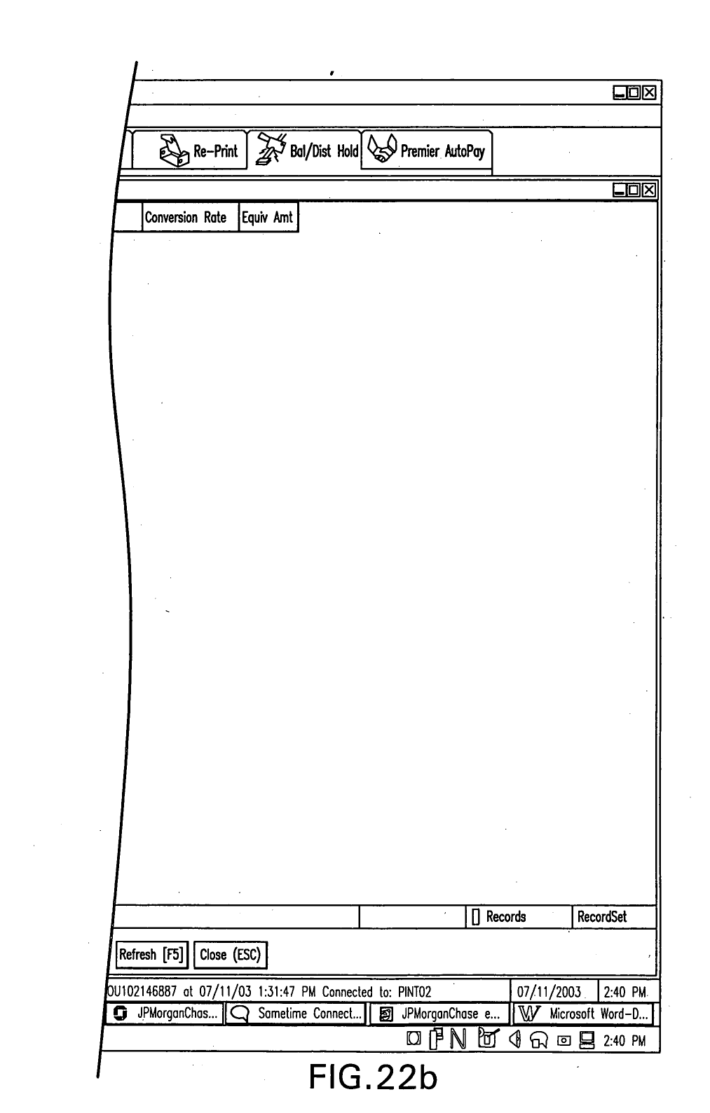

Selection of the “hold” tab 2320 causes the B&D module 250 to generate and display a list of all collections items that are currently in the B&D hold queue. A screen 8000 with the headings for such a list is shown in FIG. 22. The hold queue allows tracking of work in progress from one business day to the next business day. By selecting one or more of the listed B&D hold items and double clicking it, it is transferred to the appropriate processing queue, for subsequent processing by the process payments step 460, to be discussed below. FIG. 21 shows a B&D collections screen 7900. This screen includes a collection letters field 7902 that lists all collection cases ready for printing of the collection letter. The highlighting of the collection cases and executing the print function generates the collection letters. The forward action moves the collection cases to the approval and verification column field 7903. The matching of the collection letters to the specific collection item is the process of quality checking for pertinent accuracy in fields, i.e., amount, TO destination, currency and payee/maker. Verification field 7903 lists those collection cases that have been printed and quality checked. The approval and verification column has several options. A collection case can be approved (indicating all quality checks have been met), rejected (to correctable error with a notation of the needed changes) or forwarded to Balancing & Distribution Hold (these cases require research and additional dispositioning).

Process Payments on Collections Items Step 460

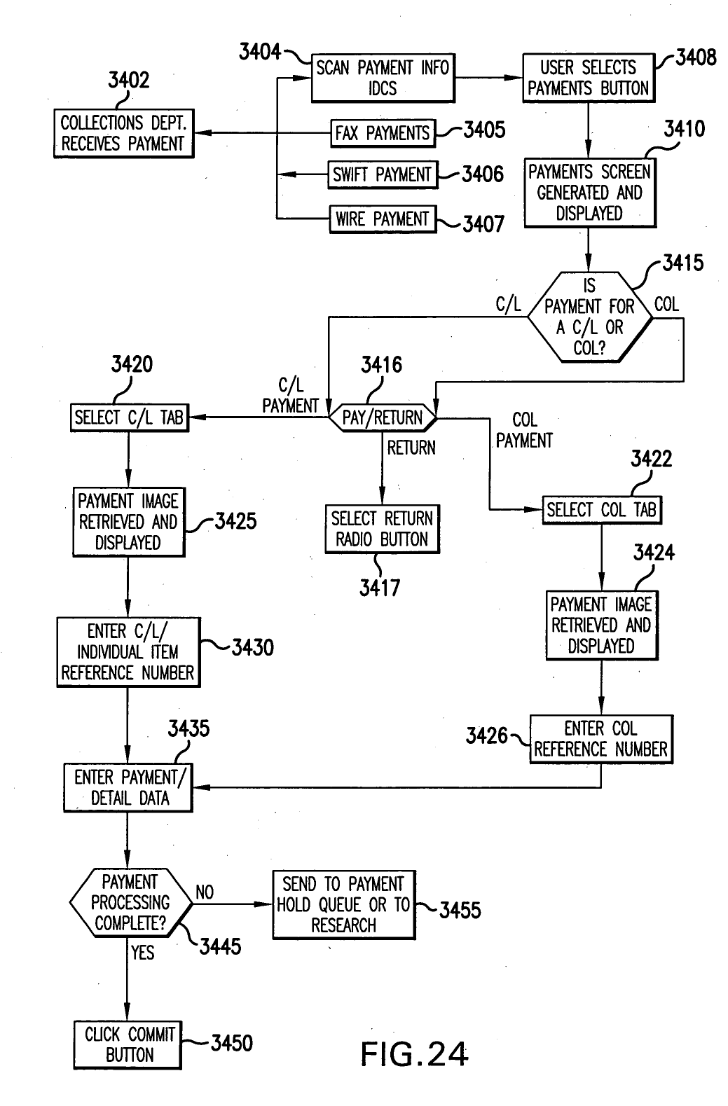

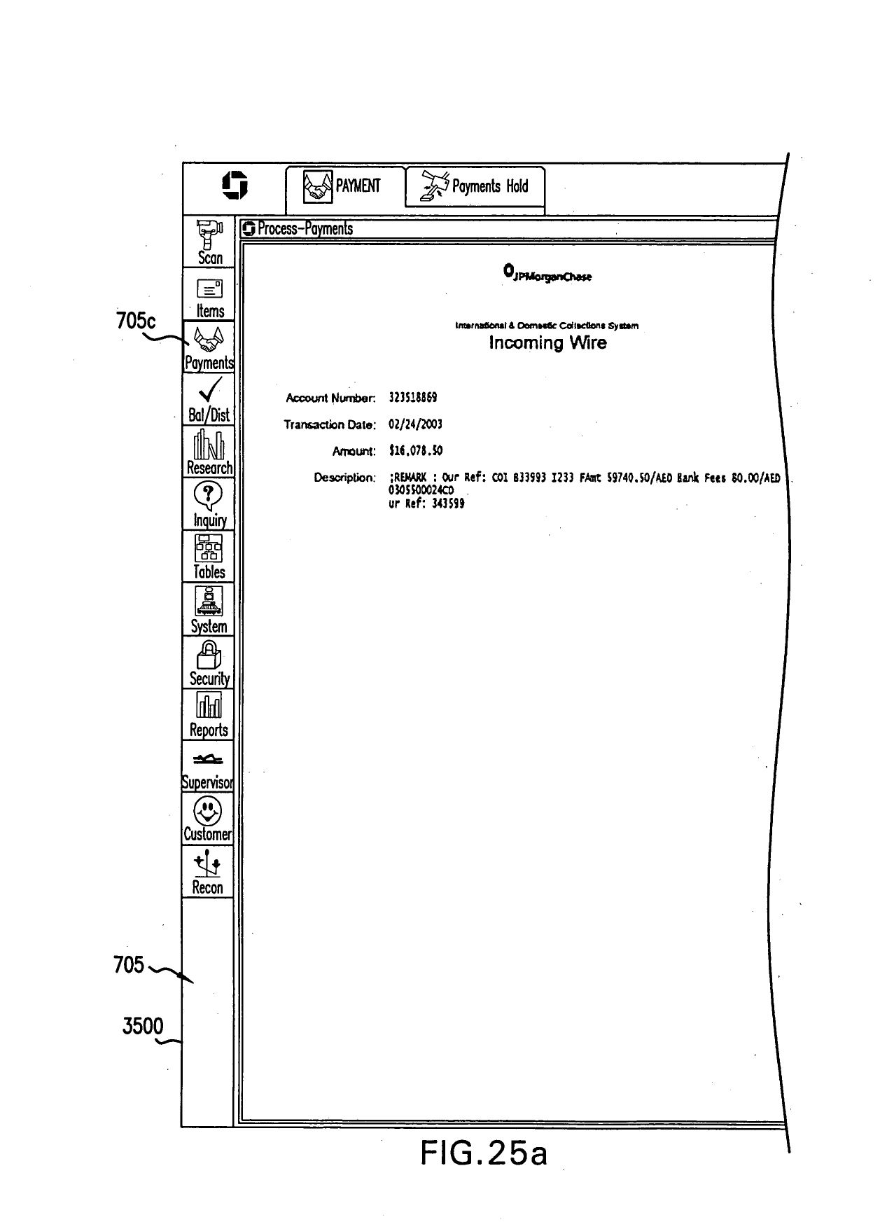

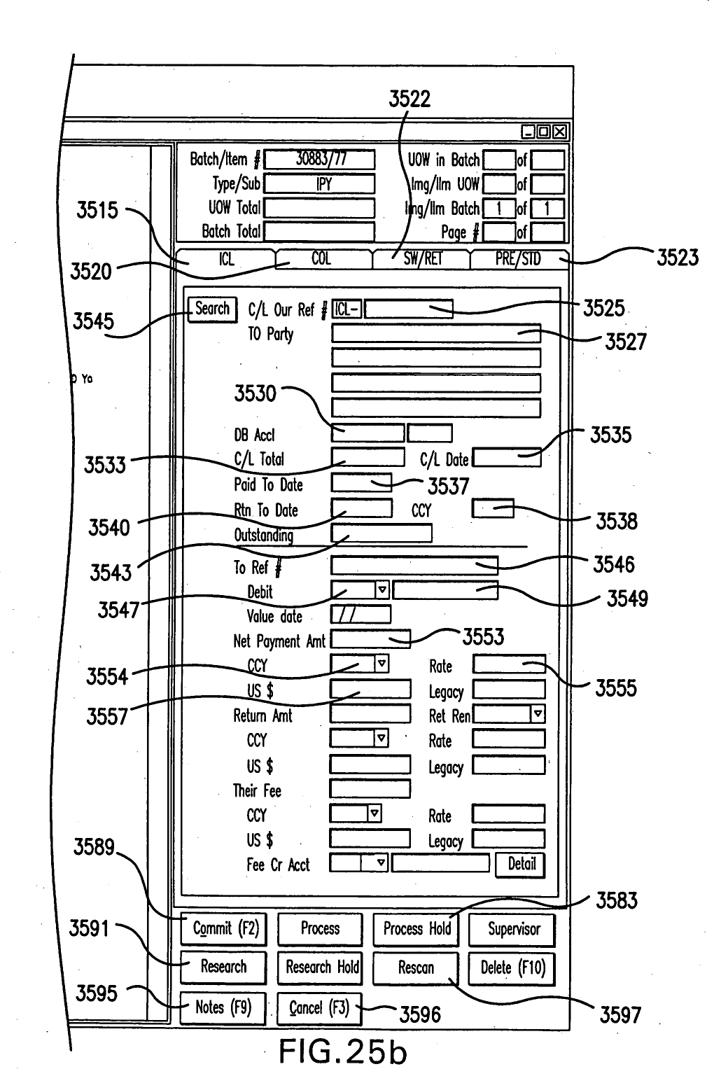

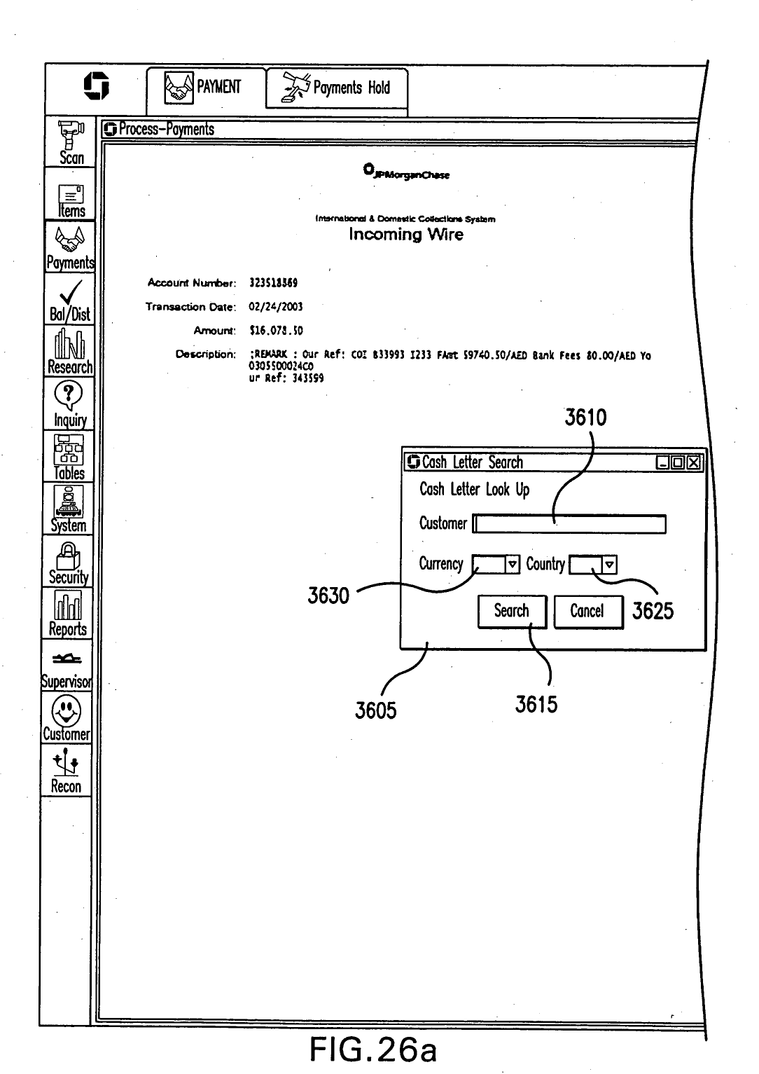

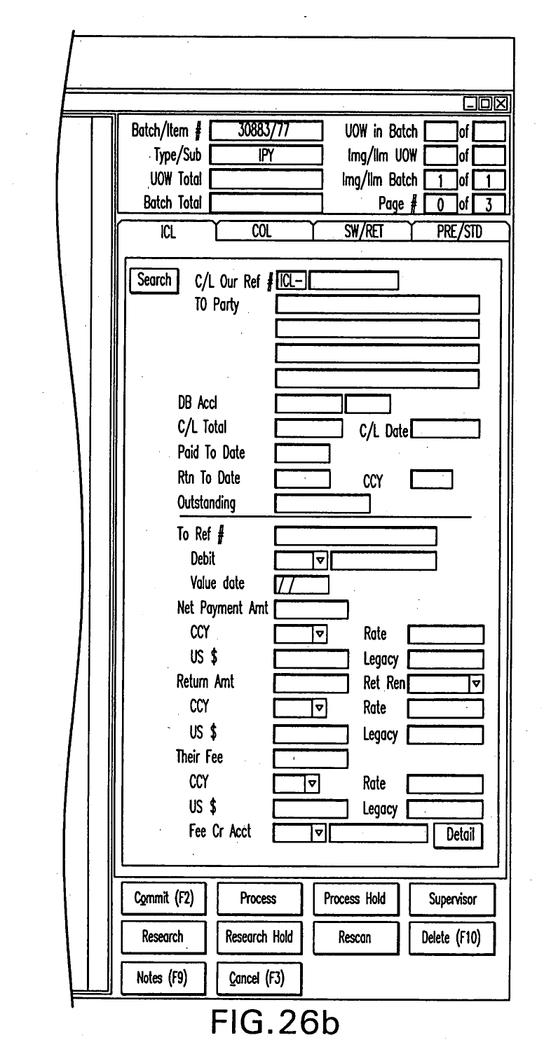

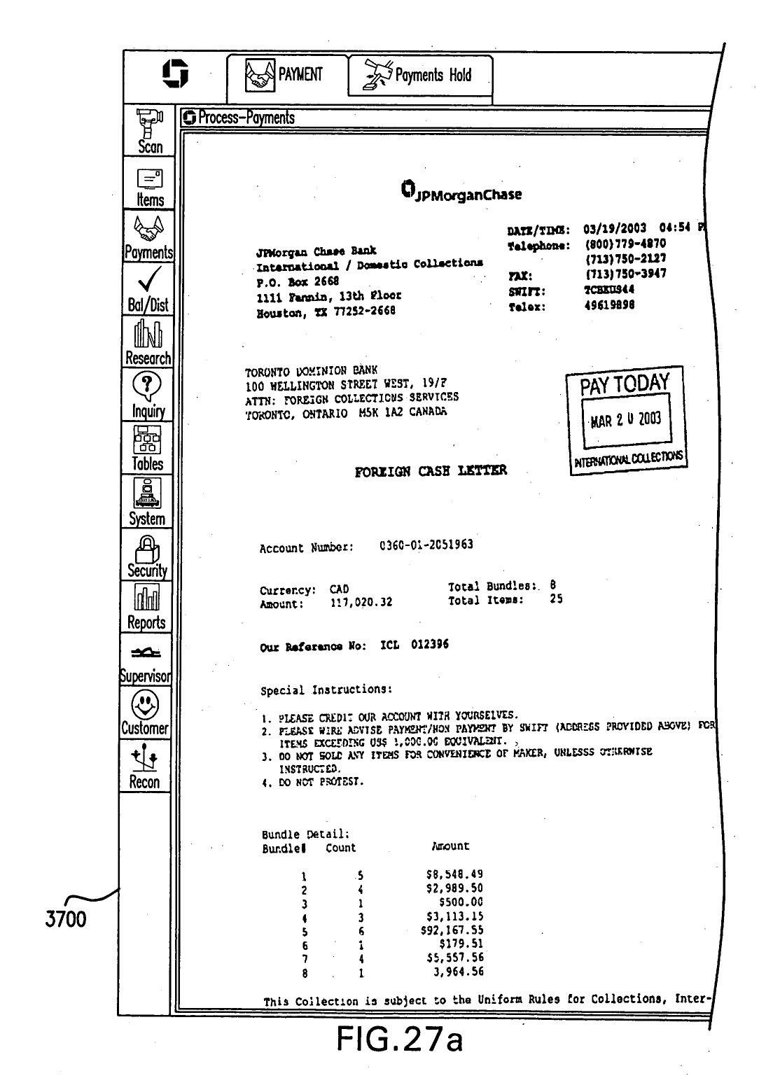

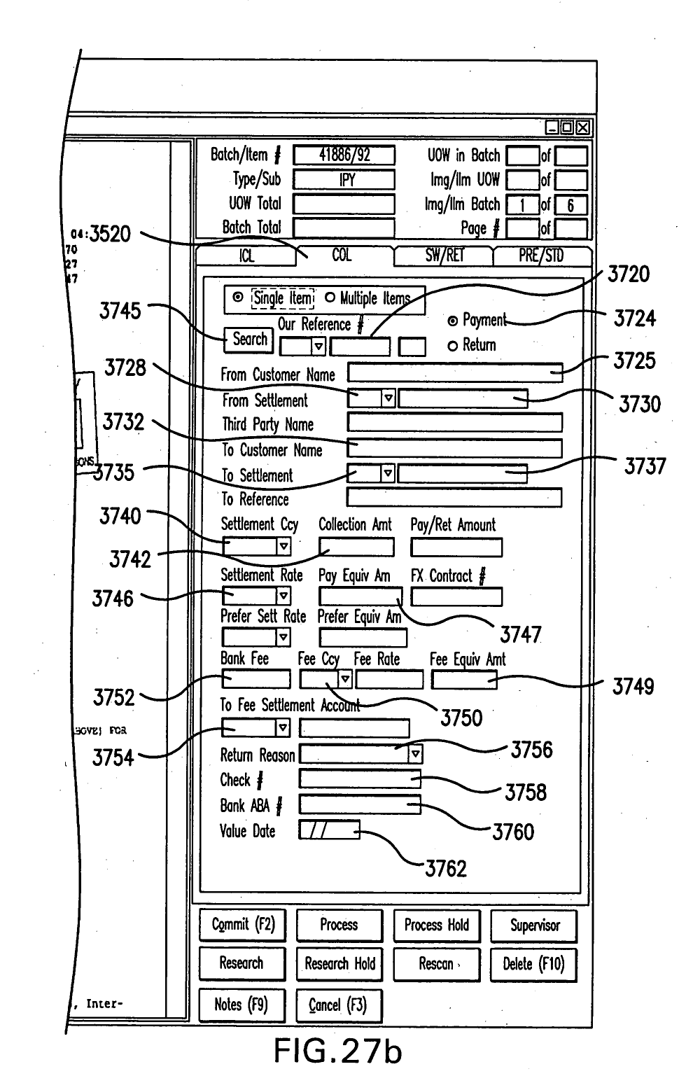

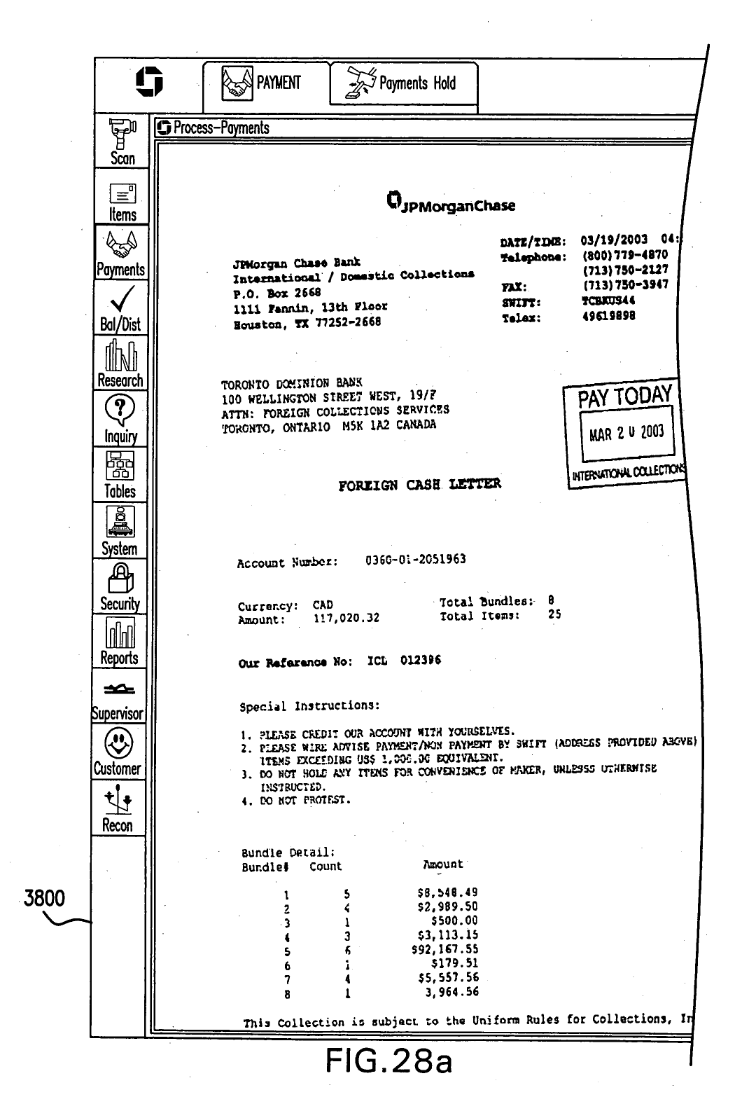

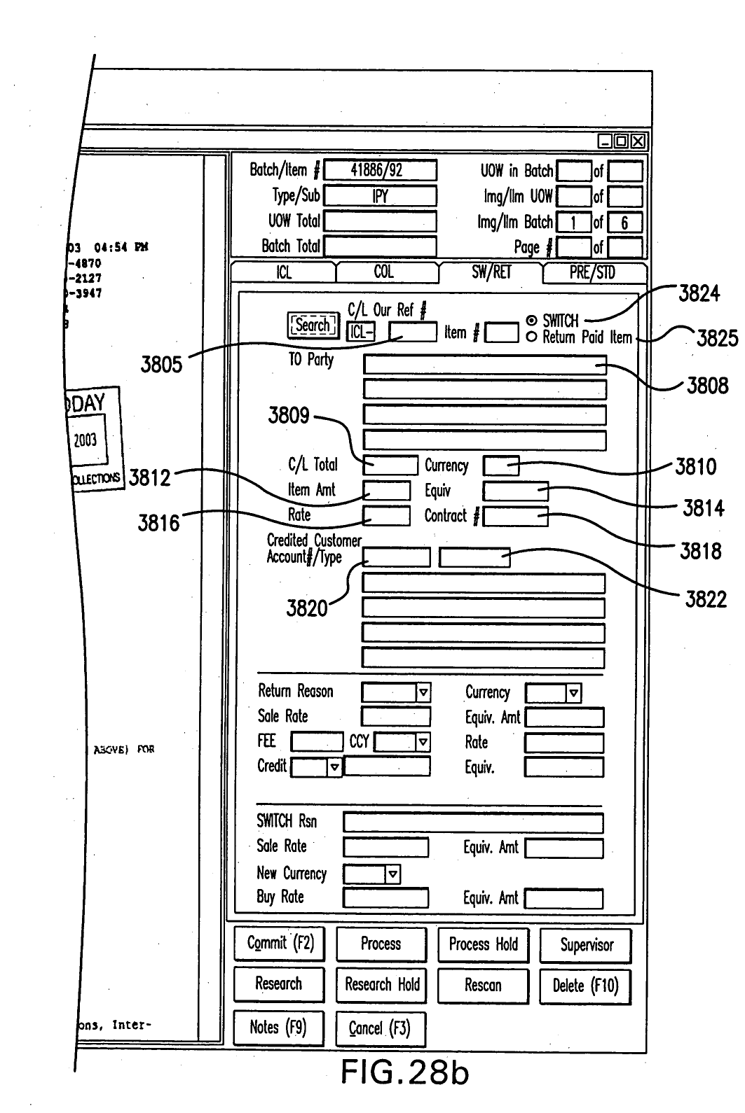

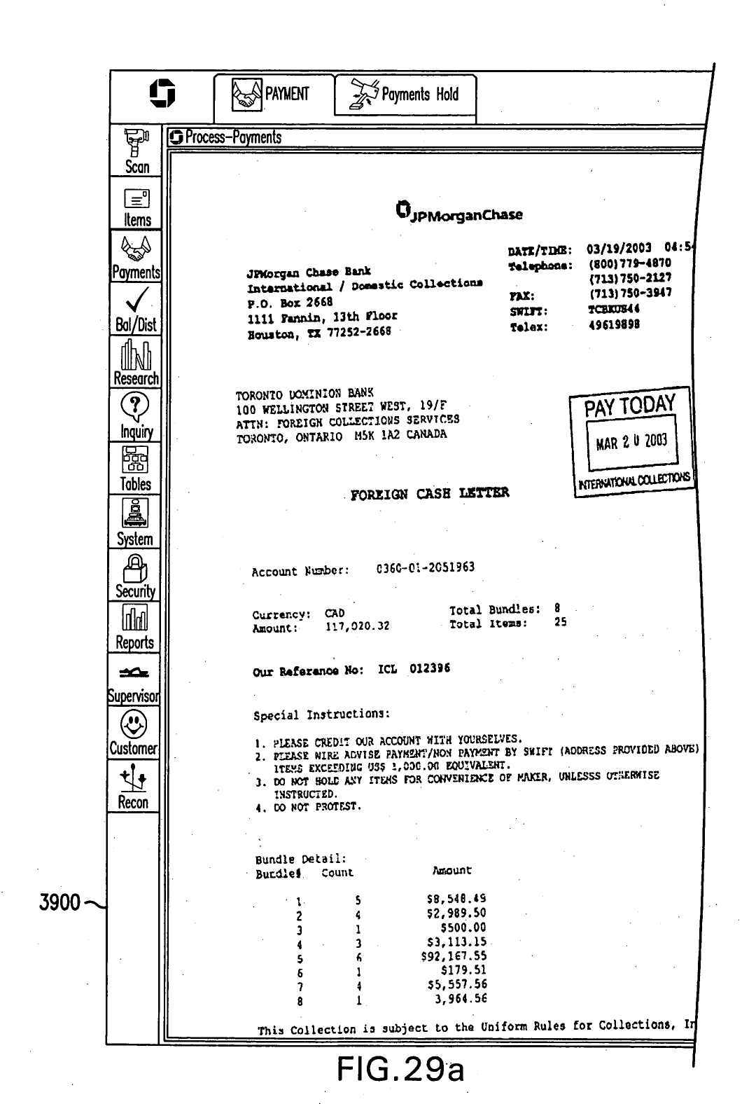

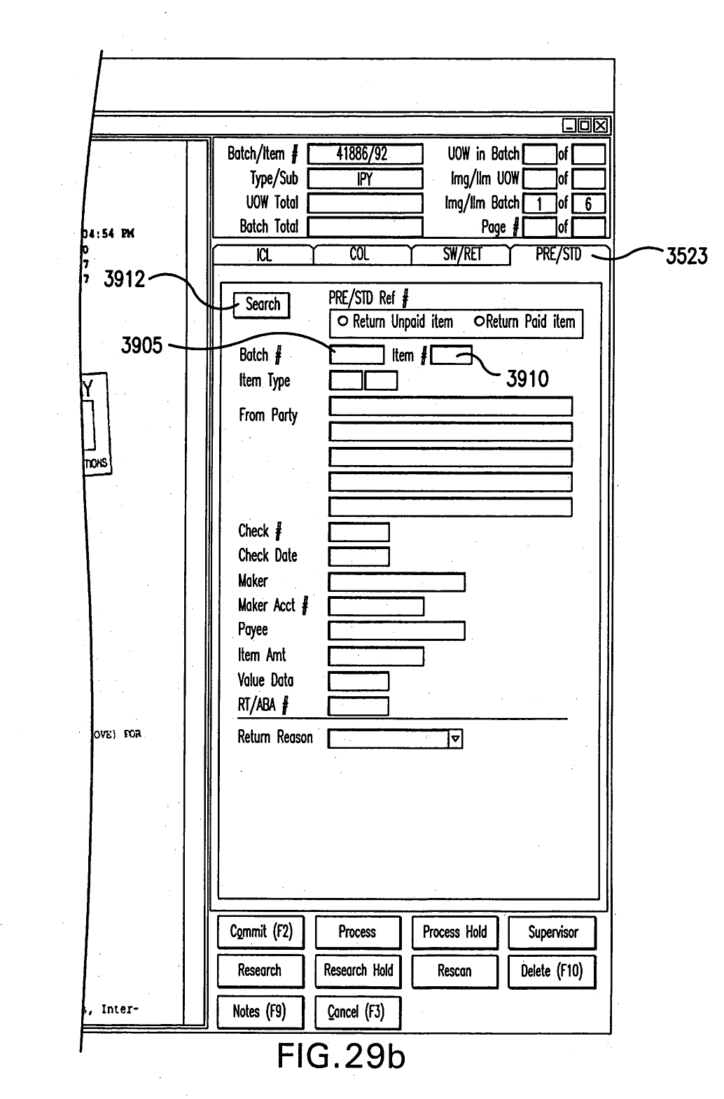

Payment processing in the IDCS, step 460 from FIG. 4, will now be described, with reference to FIGS. 24-29. FIG. 24 is a flowchart depicting payment processing in accordance with an exemplary embodiment of the present invention. FIGS. 25-26 are diagrams depicting an ICL payments processing screen in accordance with an exemplary embodiment of the present invention. FIG. 27 is a diagram depicting a COL payments processing screen in accordance with an exemplary embodiment of the present invention. FIG. 28 is a diagram depicting a payment processing screen for Switches and Returns paid in accordance with an exemplary embodiment of the present invention. FIG. 29 is a diagram depicting a payment processing screen for Pre/Std items in accordance with an exemplary embodiment of the present invention.

The flowchart of FIG. 24 illustrates the payment processing flow for processing payments on cash letter payments ICL and collection letter payments COL. Switch/Return and Pre/Std processing are not shown on the flow chart but will be discussed below with reference to the payment processing screens. Referring to FIG. 24, at step 3402, the collections department receives payment on a collections item in the form of, for example, a check. At step 3404, the received payment is scanned and index using scanning and indexing module 220 (see FIG. 6 and accompanying discussion supra). At step 3408, the IDCS user selects the payments button 705c, causing the IDCS payments module 260 to generate, by default, the ICL payments processing screen 3500.

The payment processing module 260 preferably recognizes cash letter payments and collection letter payments. At step 3420, the IDCS user selects the ICL tab 3515 to process payment received on an ICL. To process payment received on a collection letter, the IDCS user selects the COL tab 3520 at step 3420.

The processing of an ICL payment, using various payment processing screens to be discussed below, will now be described in accordance with an exemplary embodiment of the present invention. It is noted, however, that the following description is not limited to ICL items, but would also be applicable to describe the processing of a COL collections item, with the exception that some of the data entry fields may be different.

At step 3425, the image of the payment is retrieved from the IDCS database 145 and displayed to the IDCS user. At step 3430, if the ICL reference number corresponding to the ICL for which payment is being processed appears on the image or is known to the IDCS user, it may be inputted in “Ref #” textbox 3525. Entering the ICL reference number causes the payment processing module 260 to automatically populate the “To” textbox 3527, the “DB Acct” textbox 3530, the “C/L total” area 3533, the “C/L date” area 3535, the “Paid to Date” area 3537, the “Rtn to Date” area 3540, and the “Outstanding” area 3543.

If the IDCS user does not know the ICL reference number, he may perform a search for it by clicking the “search” button 3545. Referring to FIG. 26, clicking the “search” button 3545 causes the payment processing module 260 to generate and display a cash letter lookup dialog box 3605. The IDCS user may search for the ICL reference number by customer name. For example, the IDCS user may enter the first few letters of the customer's name in customer textbox 3610 and click the search button 3615. The payment processing module 260 then queries the IDCS database 145 for all open cash letters corresponding to a customer whose name begins with the entered letters. The payment processing module 260 generates and displays a list of the customers returned by the IDCS database 145. The IDCS user may select an open cash letter from the displayed list. The payment processing module 260 then uses the selected data to automatically populate the “To” textbox 3527, the “DB Acct” textbox 3530, the “C/L total” area 3533, the “C/L date” area 3535, the “Paid to Date” area 3537, the “Rtn to Date” area 3540, and the “Outstanding” area 3543. As an alternative to searching by the first few letters of the customer's name, the IDCS user may perform a search by entering the IDCS customer index number (i.e., NOSTRO number) in textbox 3610, or by inputting a country or currency in textboxes 3625 and 3630.

At step 3435, the IDCS user must enter data into various fields in the C/L payments processing screen 3500. These fields will now be described with reference to FIG. 25. The “C/L Our Ref #” textbox 3515, as was previously stated, is an ICL reference number obtained by inputting or looking up the correct number. The “To Party” textbox 3527 is automatically populated as a result of entering or searching the “C/L Our Ref #” 3515. The net proceeds of the money collected on the collections item is debited to the customer whose name appears in the “To Party” textbox 3527. The “DB Acct” textbox 3530 and the account type textbox 3531 are automatically populated based on the entry in the “C/L Our Ref #” textbox 3515. The “DB Acct” textbox 3530 identifies the account number of the party identified in the “To Party” textbox 3527. The account type in textbox 3531 may be a DDA or GL account.

The “C/L Total” area 3533, in which the total current amount due on the cash letter is stated, and the “C/L Date” area 3535, in which the date of the cash letter is stated, are automatically populated based on the entry in the “C/L Our Ref #” textbox 3515. The “Paid to Date” area 3537 states the total amount that has been paid on the cash letter to date. The “CCY” area 3538 states the name of the cash letter currency. The “Rtn To Date” area 3540 states the total amount returned to date on the cash letter. The “Outstanding” area 3543 states the total amount that remains unpaid on the cash letter. Areas 3537, 3538, 3540, and 3543 are all automatically populated based on the entry in the “C/L Our Ref #” textbox 3515.

The following data fields in the ICL payment processing screen 3500 are preferably inputted by the IDCS user, and are not automatically populated by the payment processing module 260. The “To Ref #” textbox 3546 contains the “TO” reference tracking number. The “Debit” dropdown box 3547 contains the method by which the account is debited. The “Debit” textbox 3549 contains the account number to be debited. The “Net Payment” textbox 3553 contains the total payment amount entered by the IDCS user as displayed in the current check image being shown in image area 775. The “CCY” dropdown box 3554 contains the cash letter currency type. The rate field 3555 displays the rate that IDCS populates automatically. The “US $” textbox 3557 contains the U.S. currency equivalent of the ICL if the ICL is in non-U.S. currency. The data in “US $” textbox 3557 is calculated and automatically inputted by the payment processing module 260 based on the values contained in the “Net Payment” textbox 3553 and the “CCY” dropdown box 3554 and “Rate Field” 3555.

If at step 3445 the IDCS user has completed all the data entry needed to complete payment processing, the IDCS user may, at step 3450, click the “commit” button 3589 to commit the payment and have the next payment displayed by the payment processing module 260. Payments can preferably be made in a number of ways, including automatic payments by Swift messaging, Fedwire, and Cashier's Check.

At step 3445, if for some reason the IDCS user is not able to complete the payment processing, the IDCS user may set the status of the payment to “payment hold” by clicking the payment hold button 3593. If there is an issue that the IDCS user feels needs to be researched with regard to this payment, the IDCS user may click the “research” button 3591 to send the payment to the research queue. The IDCS user may also attach a “sticky note” (described previously) to the payment image by right clicking the mouse and entering text in the textbox that is displayed. Cancel button 3596 is selected to abort the payment process and to display a grid of all available payment transactions. Re-scan button 3597 sends the payment to the rescan status. The rescan module allows for images to be rescanned or images added to a selected batch.

If the COL tab 3520 is selected, the user is presented with a COL payments processing screen 3700, shown in FIG. 27. As discussed above, the basic process for COL is shown in the flowchart of FIG. 24. In that figure, if it is determined at step 3415 that the payment is for a COL, that at step 3416 pay return, the flow proceeds to step 3422, at which the COL tab is selected. Next, at step 3424, the payment image is retrieved and displayed. Then, at step 3426, the COL reference number is entered. After execution of step 3426, the flow proceeds to step 3435, discussed above, and continues along the flowchart in a manner similar to C/L payment processing discussed above.

Referring again to FIG. 27, if the COL reference number corresponding to the COL for which payment is being processed appears on the image or is known to the IDCS user, it may be inputted in COL reference number field 3720. Entering the COL reference number causes the payment processing module 260 to automatically populate the “From Customer Name” textbox 3725, the “From Settlement Type” textbox 3728, the “From Settlement Acct No.” area 3730, the “To Customer Name” area 3732, the “To Settlement Type” area 3735, the “To Settlement Acct No.” area 3737, the “Settlement Ccy” (settlement currency) area 3740, the “Collection Amount” area 3742, the “Settlement Rate” area 3746, the “Pay Equiv Amt” area 3747 and the “Fee Ccy” (fee currency) area 3750.

If the IDCS user does not know the ICL reference number, he may perform a search for it by clicking the “search” button 3745, as in ICL payment processing discussed above. Bank fees are manually entered at bank fee field 3752. The equivalent amount of the bank fee is populated in fee equivalent amount field 3749 by the IDCS. A drop down box 3754 is provided for the To Fee Settlement Account information. A drop down box 3756 is provided for the return reason for returned checks. The check number, Bank ABA #, and value date are entered in fields 3758, 3760 and 3762, respectively.

If the SW/RET tab 3522 is selected, the user is presented with a SW/RET payments processing screen 3800, shown in FIG. 28. This screen is used to switch the currency of a payment and to allow payment returns. Payments may have their currency changed or be returned for a number of reasons. Premier items paid on their value date and then returned are processed using this screen. As in the COL screen, the basic process is substantially identical to that for the ICL processing. Several fields are automatically populated by entry of the C/L Our Ref. # field 3805. These fields are: the “TO Party” area 3808, the “C/L Total” area 3809, the “Currency” area 3810, the “Item Amt” area 3812, the “Equiv” area 3814, the “Rate” area 3816, the “Contract #” area 3818, the “Credited Customer Account” area 3820 and the “Credited Customer Type” area 3822.

Two process selection buttons are provided to allow the user to switch currency or return a paid item. The SWITCH button 3824 is clicked if the currency of a CL paid item is to be switched. To process an item as a return on a paid ICL item, the Return button 3825 is clicked. Appropriate fields are grayed out depending upon which button is selected.

The system of the present invention handles returns as a type of payment. Upon receipt, the reference number, the return amount and the return reason is entered. Returns are handled in multiple stages: the financial institution informs the system, typically via a SWIFT MT456, of a return, including an indication of their fee, if any. The actual item is returned and the system completes accounting entries as required for cash and premier items.

If the PRE/STD tab 3523 is selected, the user is presented with a PRE/STD payments processing screen 3900, shown in FIG. 29. This screen is used to process returned premier items. If the batch and item numbers are known, they can be typed into fields 3905 and 3910 respectively. Entering of those numbers populates the screen with related information. If the numbers are unknown, the search button 3912 allows items to be looked up in a manner similar to the item look up detailed above for ICL.

Archive Images Step 470

Finally, returning to FIG. 4, once the payments have been processed at step 460, the images of the collections items are archived at step 470. Archive images are preferably uploaded from the IDCS database 145 to the archive system every 90 days after closing date via the Archive Interface 4030 (FIG. 30), which is controlled by the archive interface module 350. After the collections item images have been uploaded to the image archive, the images are deleted from the IDCS database 145.

Research

The research function is required as a means of handling items that are rejected from the main process. This function is also used to build new customer accounts within the system and track old or stale items. Payments are deducted from the outstanding balance throughout the day The IDCS must calculate and maintain daily the aggregate outstanding limit for each customer based on their established Global Exposure System (GES) limit or a courtesy limit, preferably around $5,000. The IDCS user may access items that have been placed in the research queue by clicking the “research” command button 705e. This causes the research/inquiry module 270 to generate and display a research screen 4100, a diagram of which is depicted in FIG. 31. The IDCS user may select a research function by clicking on one of the tabs preferably located at the top of the screen. In accordance with an exemplary embodiment of the present invention, the available research tabs include a work flow tab 4105, a faxes tab 4110, a Pre/Std tab 4117, a SWIFTS tab 4115, a past due tab 4120, a workflow hold tab 4125, and a CIU review tab 4130.

Clicking work flow tab 4105 causes the research module 270 to generate and display a workflow research table 4205, depicted in FIG. 31. Items may be placed in the workflow research queue from the item processing screen 1600, the payments processing screen 3500 as previously described, or the supervisor screen, to be discussed below. If there are any open UOWs in the workflow research queue, they are listed in workflow research table 4205. The IDCS user may select a listed item by highlighting that item and clicking the Search button 4210. The IDCS user is then returned to the screen in the workflow process at which the UOW was placed in the workflow queue, e.g., either the item processing screen 1600, the payments processing screen 3500, or the Supervisor screen.

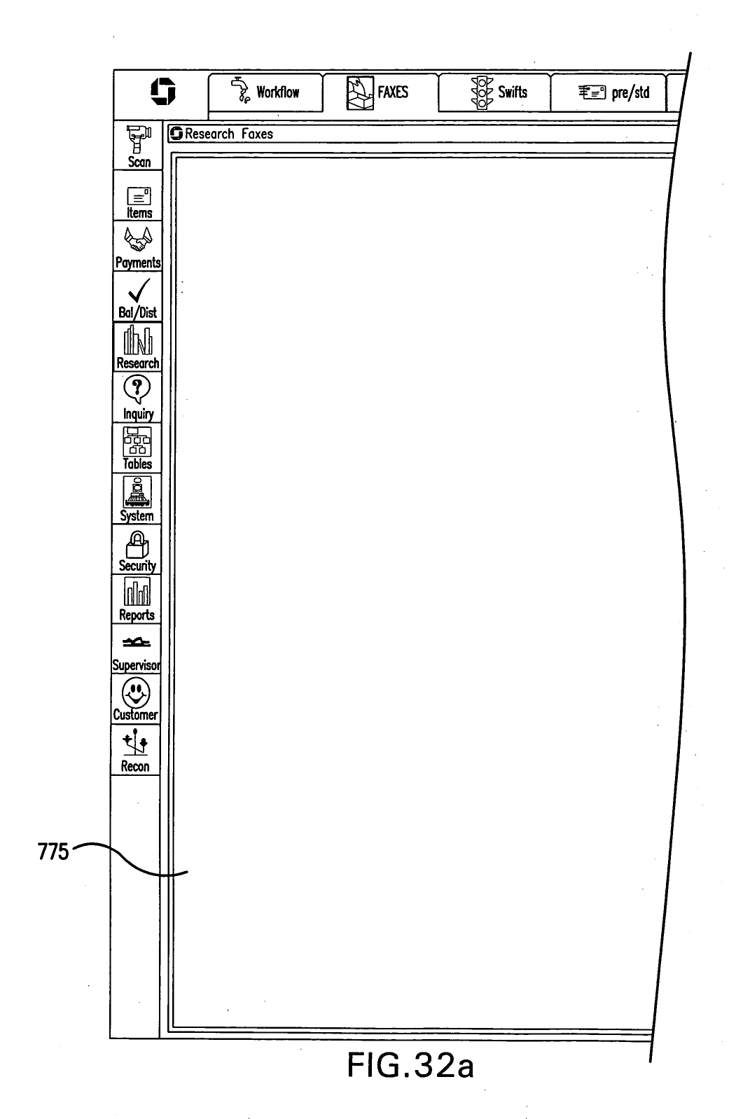

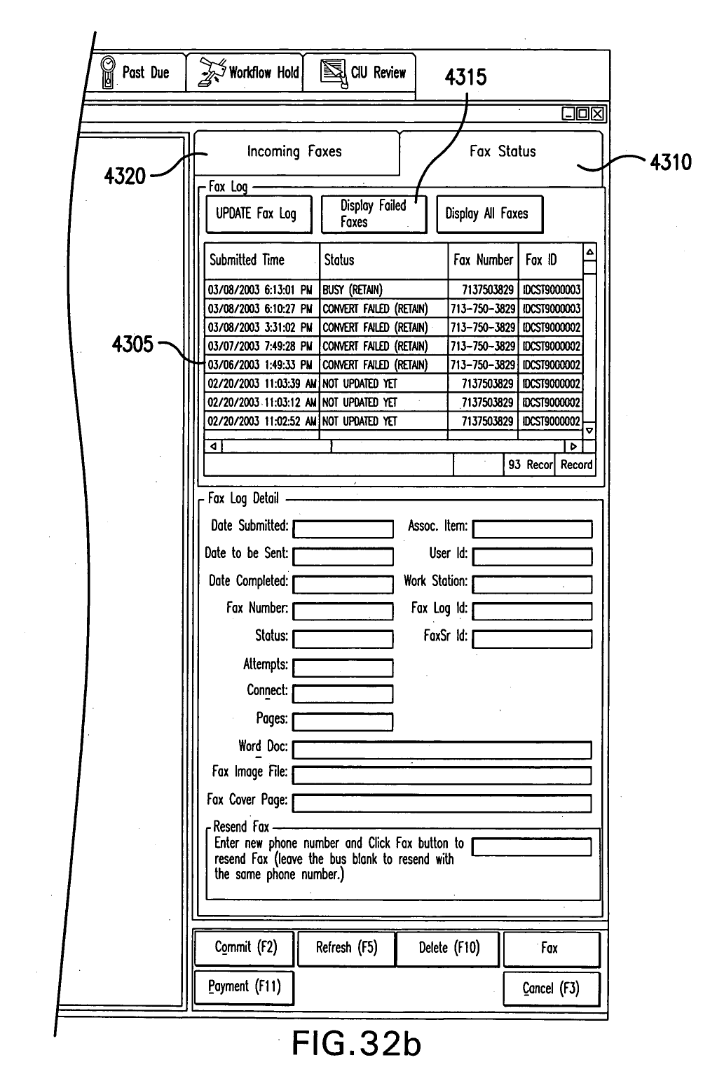

Clicking the faxes tab 4110 causes the research module 270 to generate and display a fax status table 4305, depicted in FIG. 32. The fax status tab 4310 is selected by default. Table 4305 lists all faxes, with a time of receipt, the status, for example, the reasons, if any, that the fax failed, the fax number and the fax ID. The IDCS user may access a list of failed faxes by clicking on the Display Failed Faxes tab 4315. In any case, clicking on the item or items displayed causes the selected item to be displayed in image display area 775. The IDCS user can also resend the fax by clicking the “FAX” button.

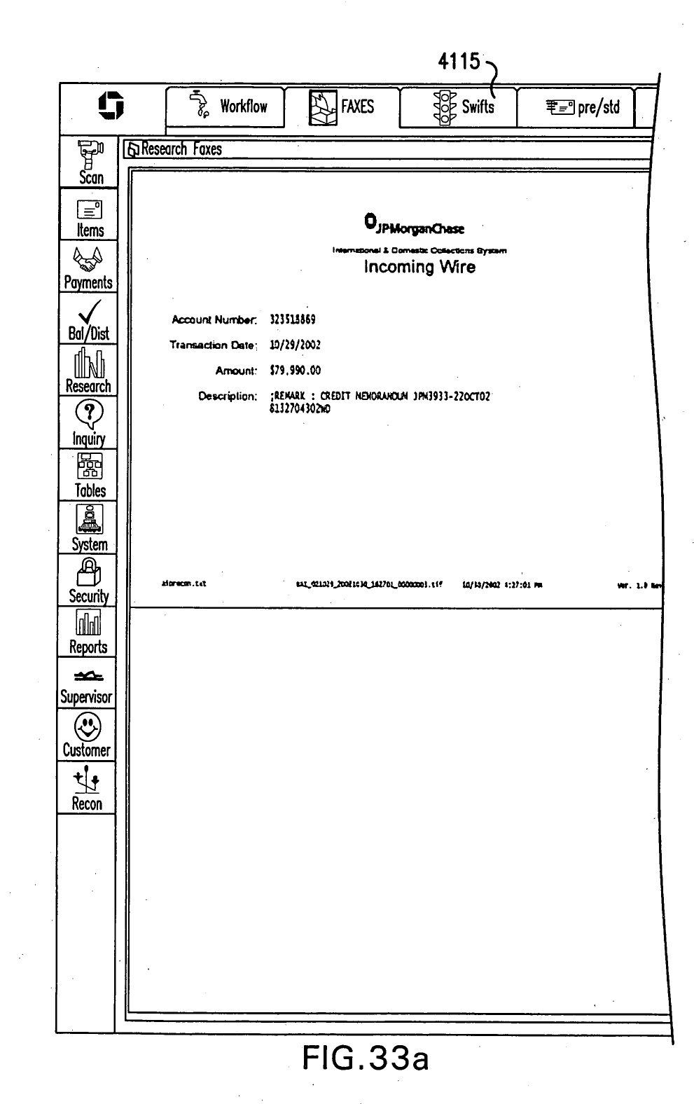

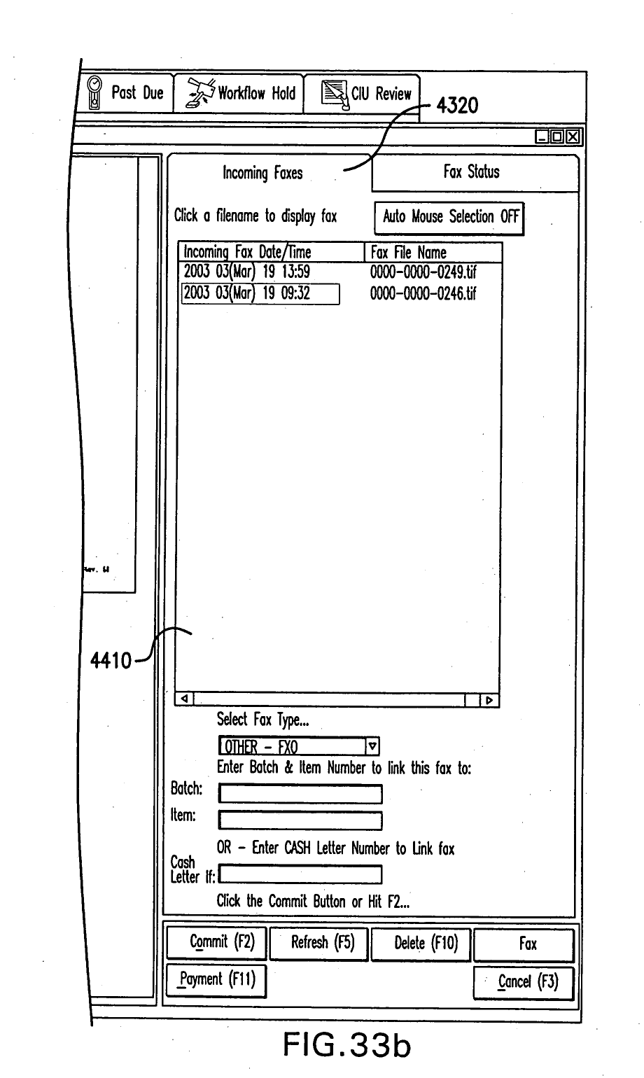

If the IDCS user clicks the Incoming fax tab 4320, the research module 270 displays an incoming fax table 4410, shown in FIG. 33. The table has a column for fax date/time and one for fax file name. The incoming Fax Tab 4320 provides the ability to attach the incoming fax to the appropriate IDCS Case by entering a batch number and item number or cashletter number.

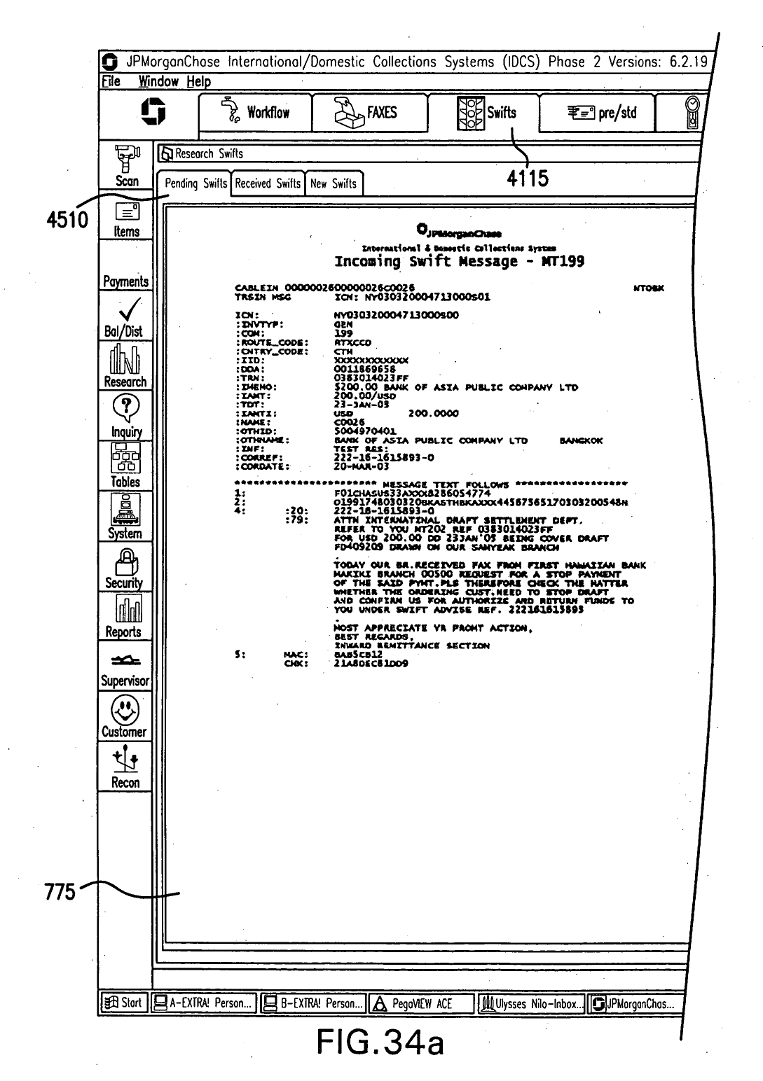

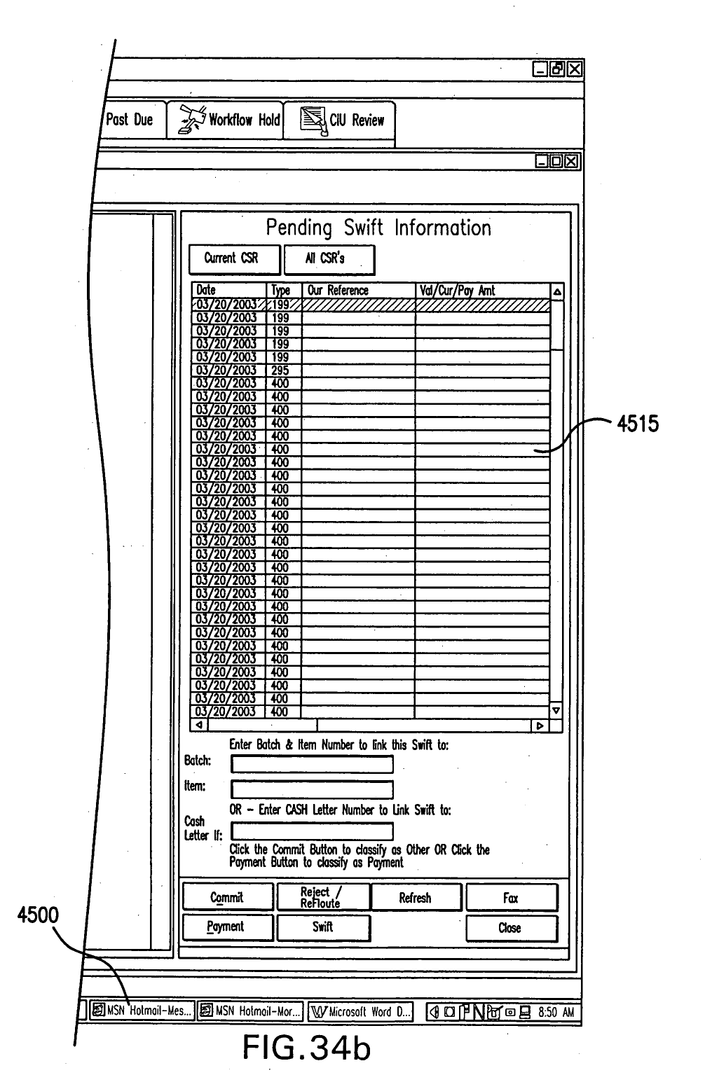

Clicking the SWIFTS tab 4115 causes the research module 270 to display the SWIFT information screen 4500, shown in FIG. 34. The IDCS user may view details about the pending SWIFT by clicking the pending SWIFT tab 4510. As can be seen in FIG. 34, selection of the pending SWIFT tab cause pending swift information table 4515 to be displayed. A selected incoming SWIFT message from that table is displayed in the display area 775.

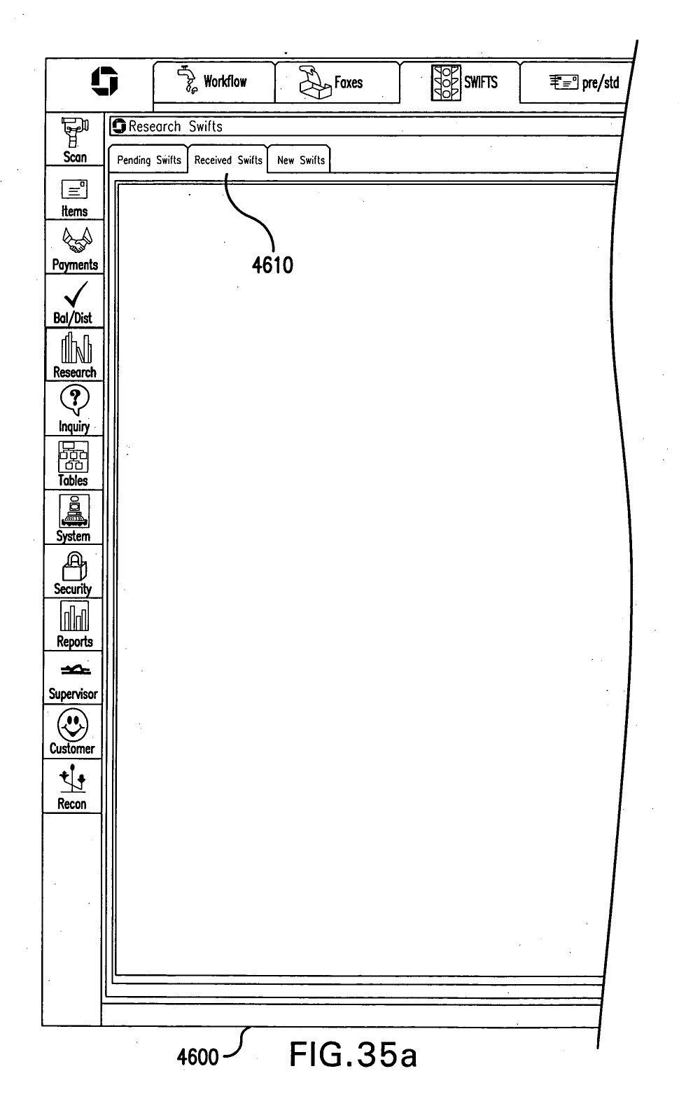

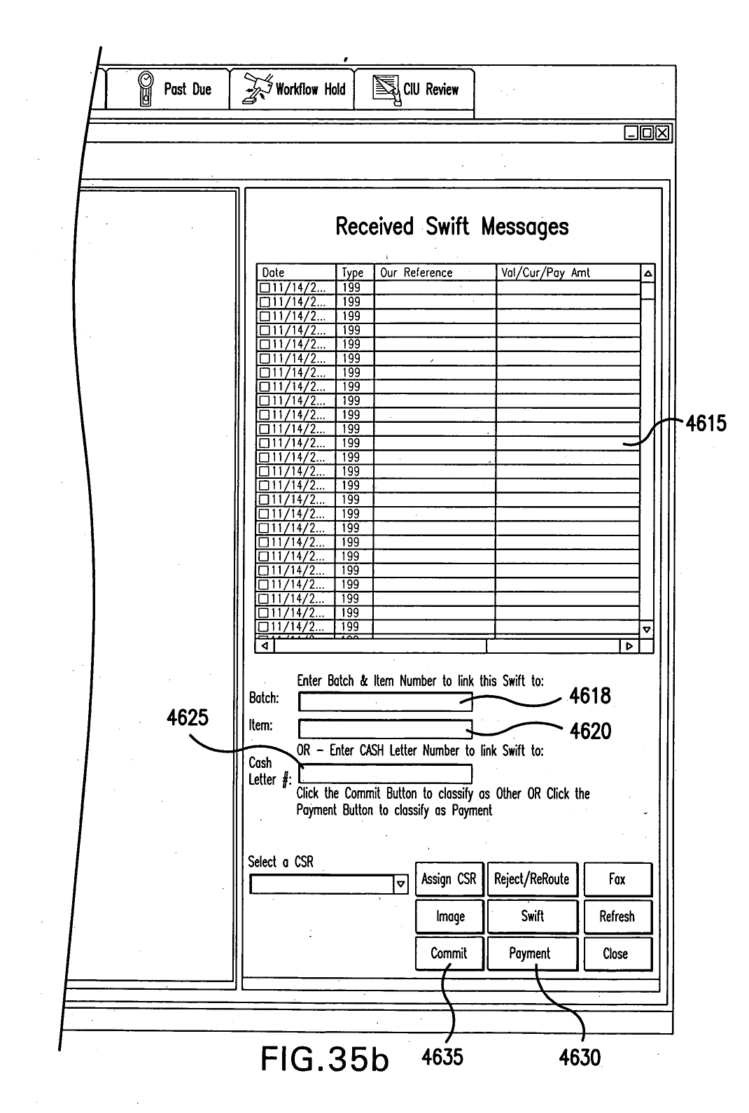

Details relating to received SWIFT messages can be viewed by selecting the received swifts tab 4610, which causes the system to display the received SWIFTS page 4600, shown in FIG. 35. The received SWIFTS page includes a received SWIFT messages field 4615 in which received SWIFT messages are displayed. The received SWIFT message can be linked to an item identified by a batch and item number by entering information into the batch field 4618 and the item field 4620. Alternatively, information can be entered into the cash letter # field 4625 to link the SWIFT message to a cash letter. Classification as a payment can be effected by clicking payment button 4630. The commit button 4635 may be clicked to classify the received SWIFT message as “other.” The “OTHER” button is used to link a SWIFT to an IDCS case.

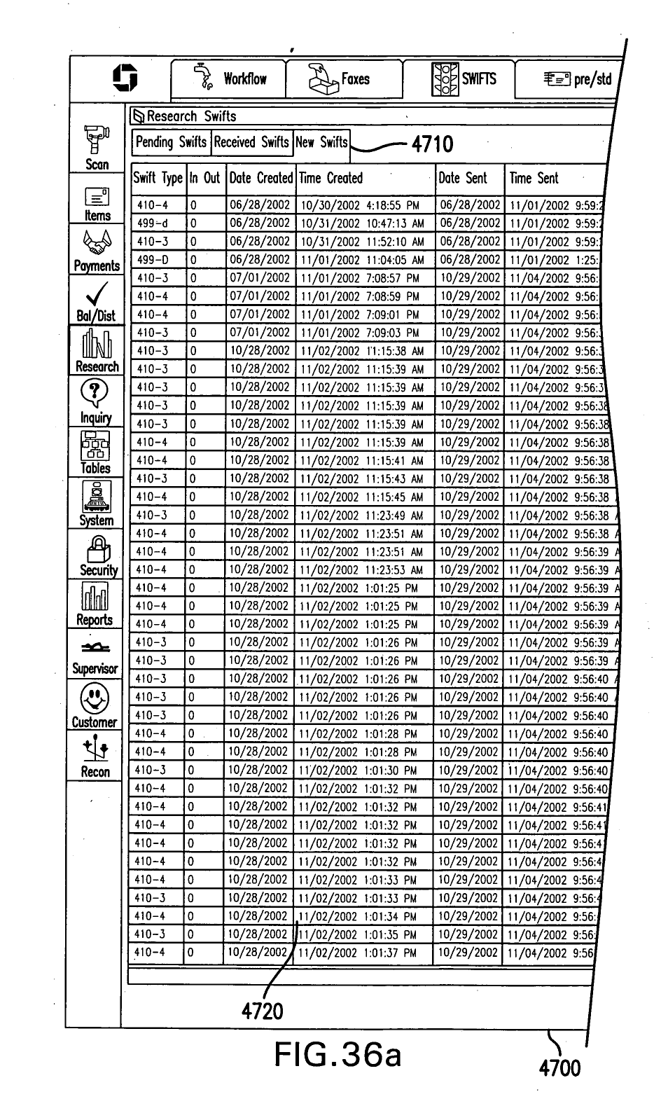

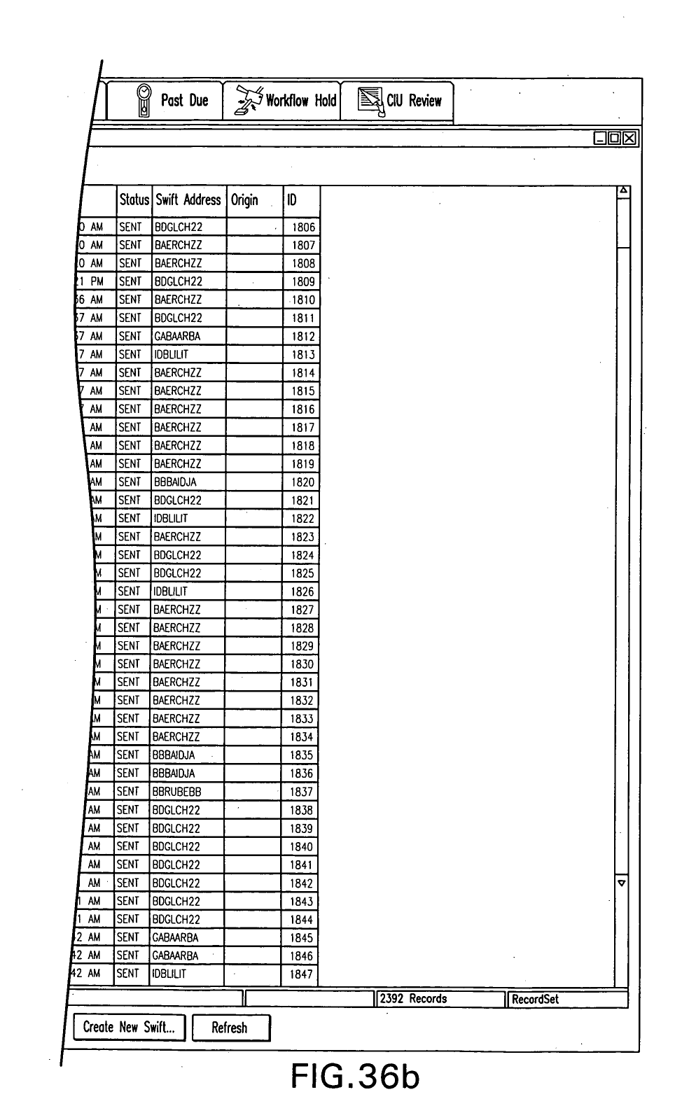

Details relating to new SWIFT messages can be viewed by selecting the new SWIFTS tab 4710, which causes the system to display the new SWIFTS page 4700, as shown in FIG. 36. New SWIFT messages are displayed in display field 4720. The “New Swift” tab lists all incoming and outgoing SWIFTS generated by IDCS by date and type.

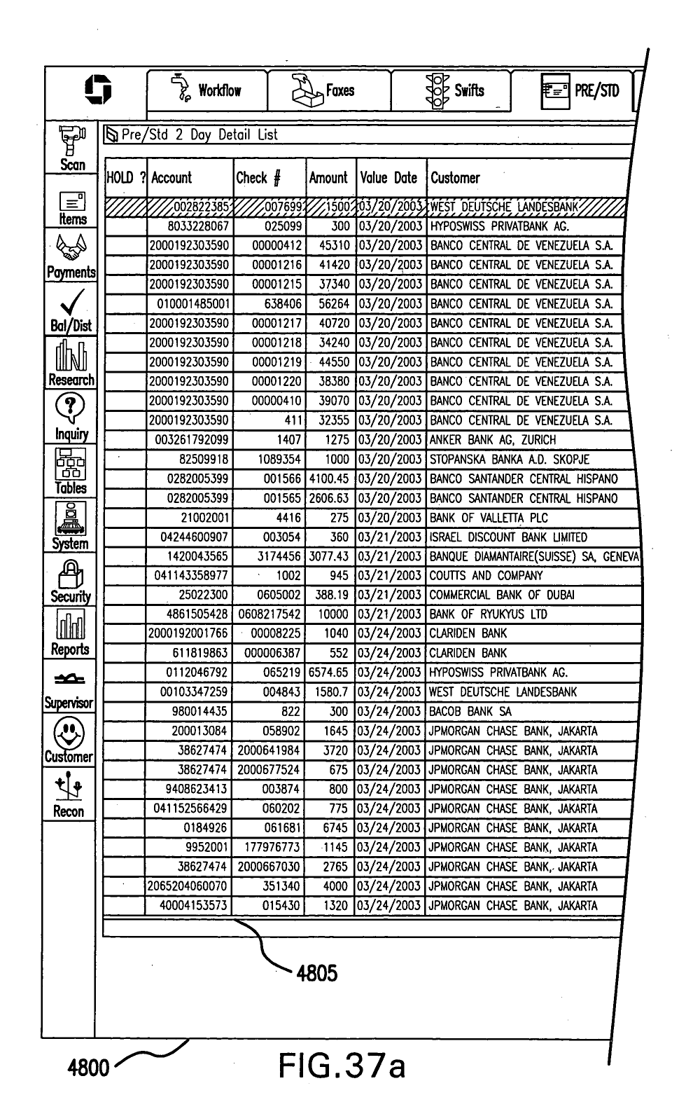

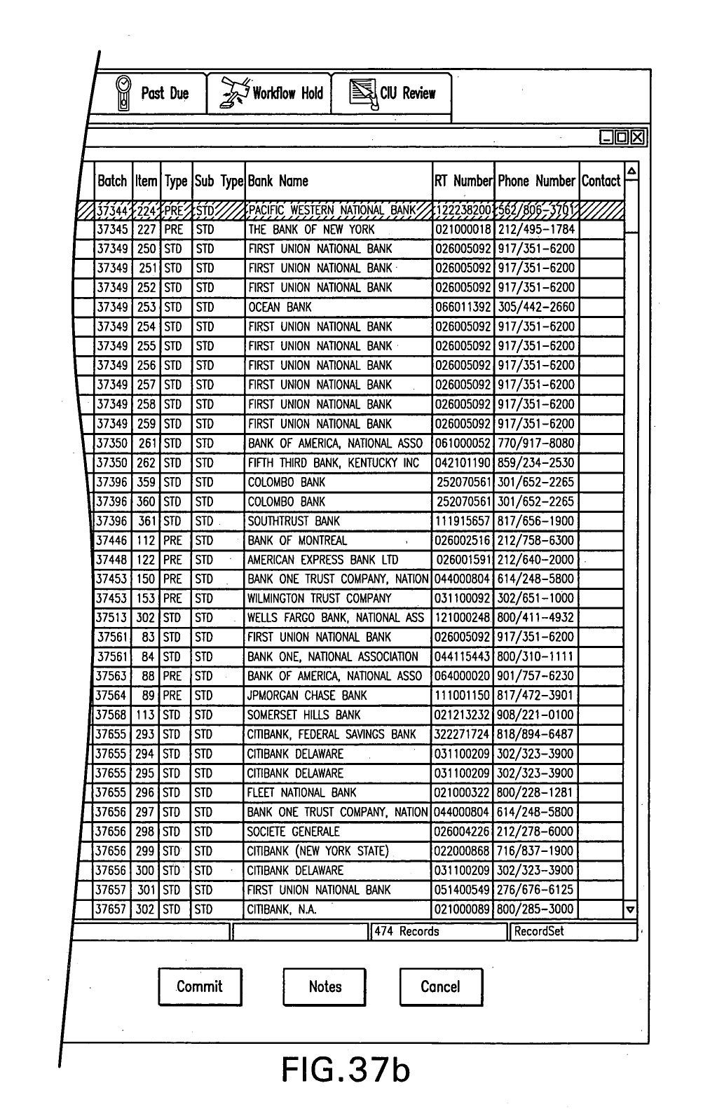

Clicking the PRE/STD tab 4117 causes research module 270 to generate and the PRE/STD 2 Day screen 4800, shown in FIG. 37. This screen includes a PRE/STD 2 day detail list 4805. This list shows all Pre/Std workflow items that will pay in 2 days. The IDCS user has an opportunity to process these items. The IDCS user may place an item on hold and prevent the payment process from continuing. If the item is not placed in hold, the item will automatically pay on the second day. As shown in the figure, the information on the list may include the name of the bank having an item due, the customer, the amount, the check number, the account number and other relevant data to assist in identifying the item. The “PRE/STD” tab allows the IDCS user to decide whether payment will continue or place a hold on the payment.

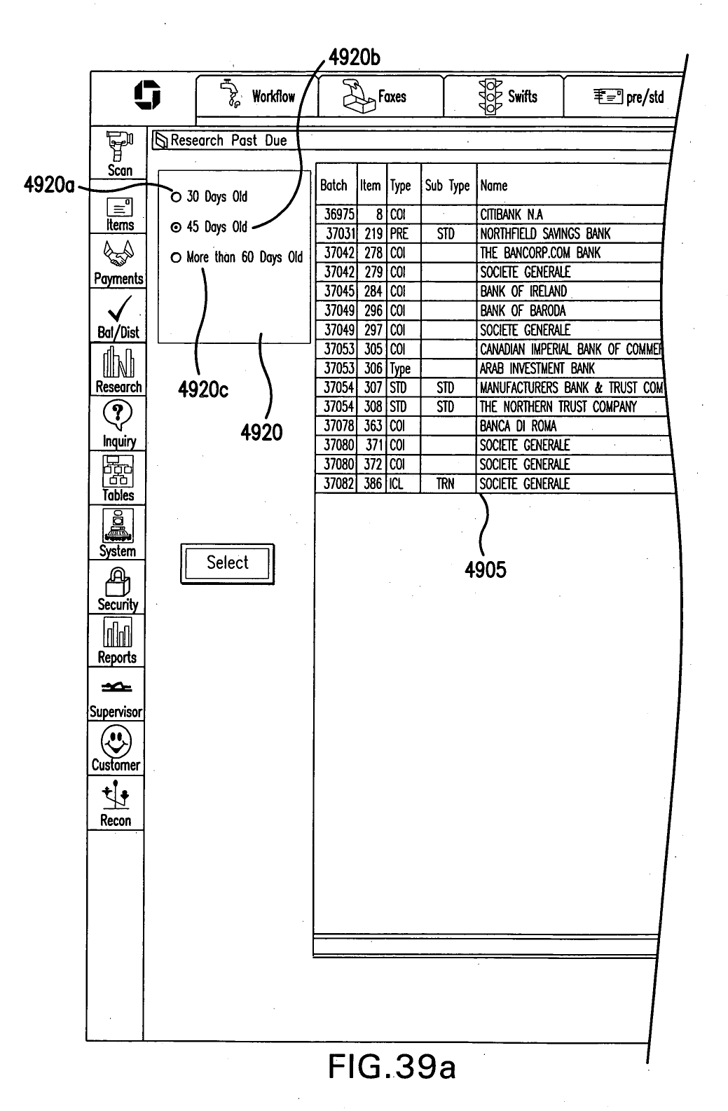

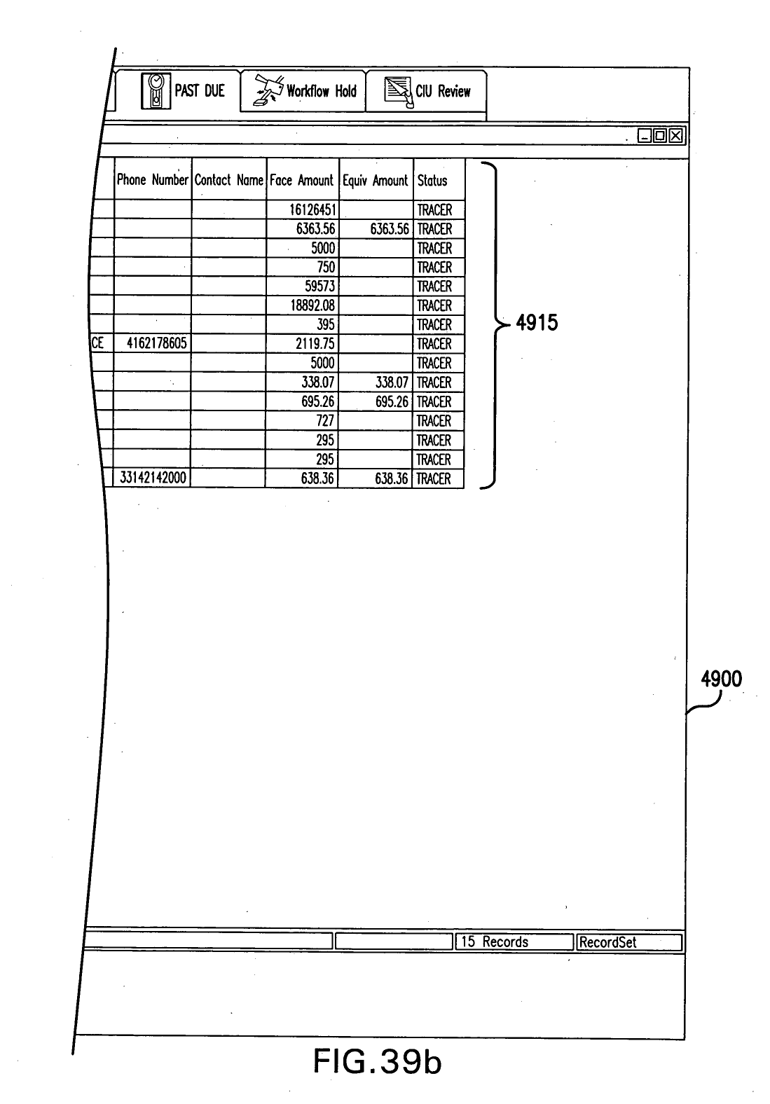

Clicking the Past Due tab 4120 causes the research module 270 to generate and display a past due research screen 4900 having a past due research table 4905, which lists all past due collections items, if any, as shown in FIG. 39. Selecting an a past due item from the past due research table 4905 allows the IDCS user to update the status of the past due item. The IDCS user may indicate, for example, by entering a “Y” in the status column 4915, that the item should be cleared from the past due research table 4905. The IDCS user may also enter, for example, an “N” in the status column to leave the item as past due. In radio box 4920, the IDCS user may choose between, for example, three options. The first is to select option 4920a to view items past due for 30 days, with a tracer (SWIFT, fax, or mail) automatically generated by the IDCS 100. The second is to select 2420b to view items past due for 45 days, with a tracer (SWIFT, fax, or mail) automatically generated by the IDCS 100. The third is to select 2420c to view items past due for more than 60 days, with a tracer (SWIFT, fax, or mail) automatically generated by the IDCS 100.

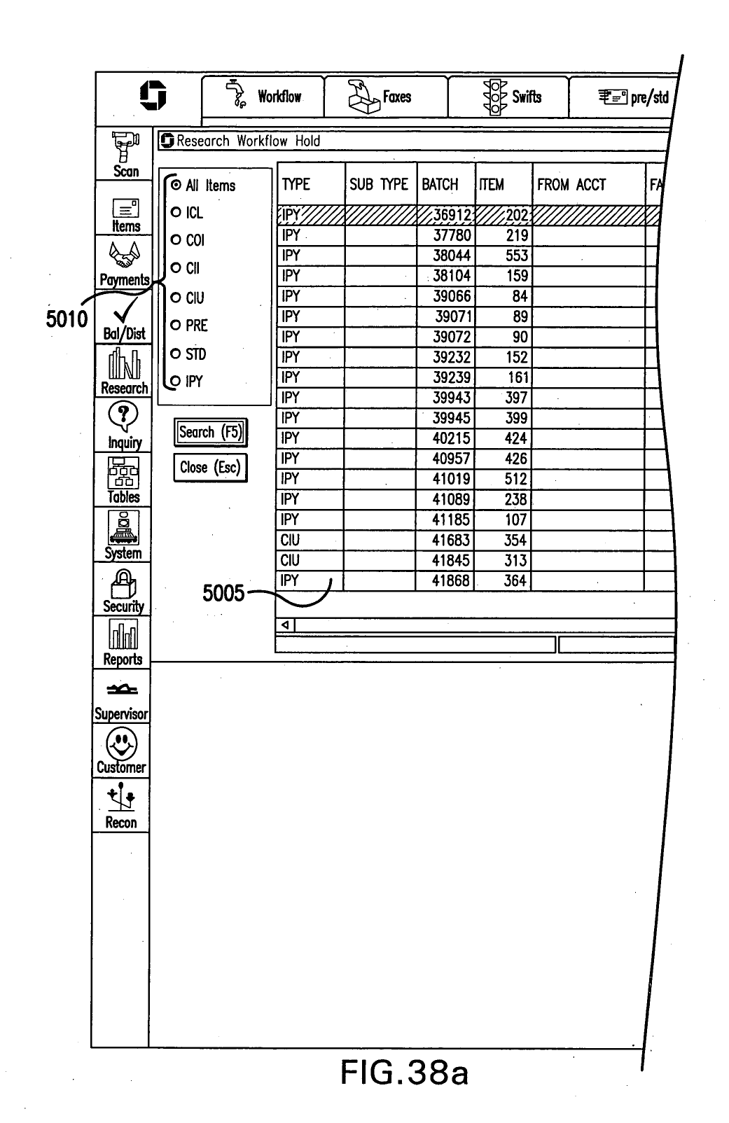

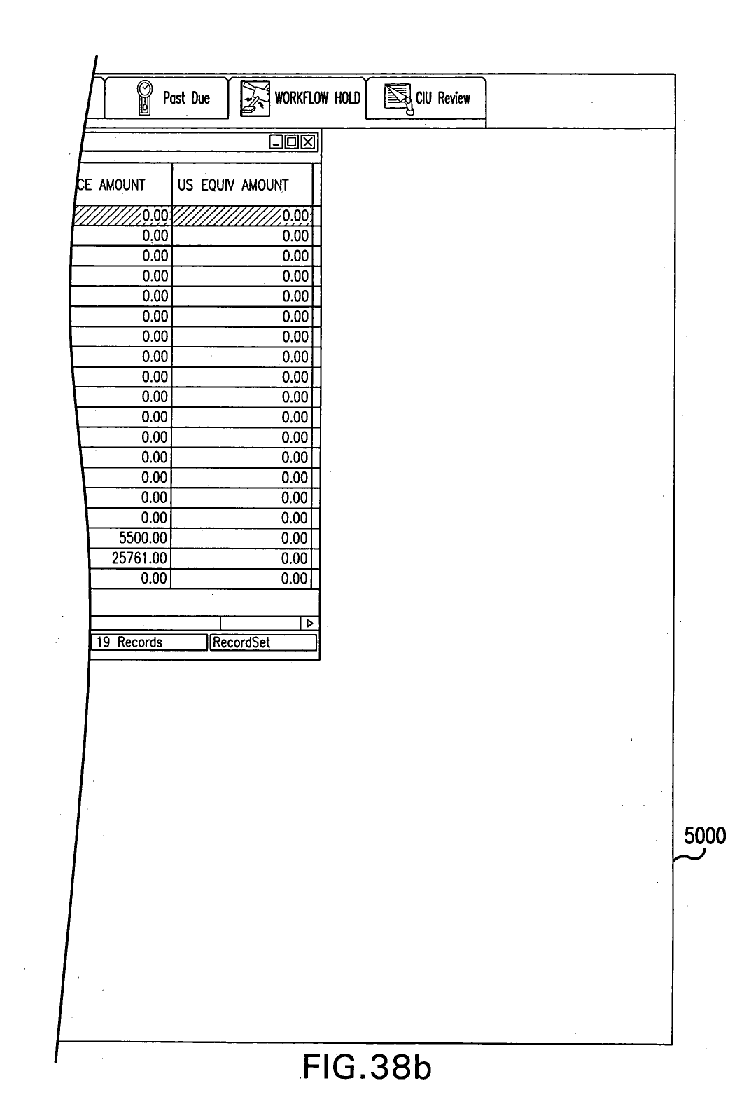

Clicking the workflow hold tab 4130 causes the research module 270 to generate and display a research workflow hold screen 5000, which includes a research workflow hold table 5005, each shown in FIG. 38. Radio buttons 5010 allow the user to display all items, or a particular class of items. The Research Workflow hold queue is an overnight queue where items can be held until next day processing.

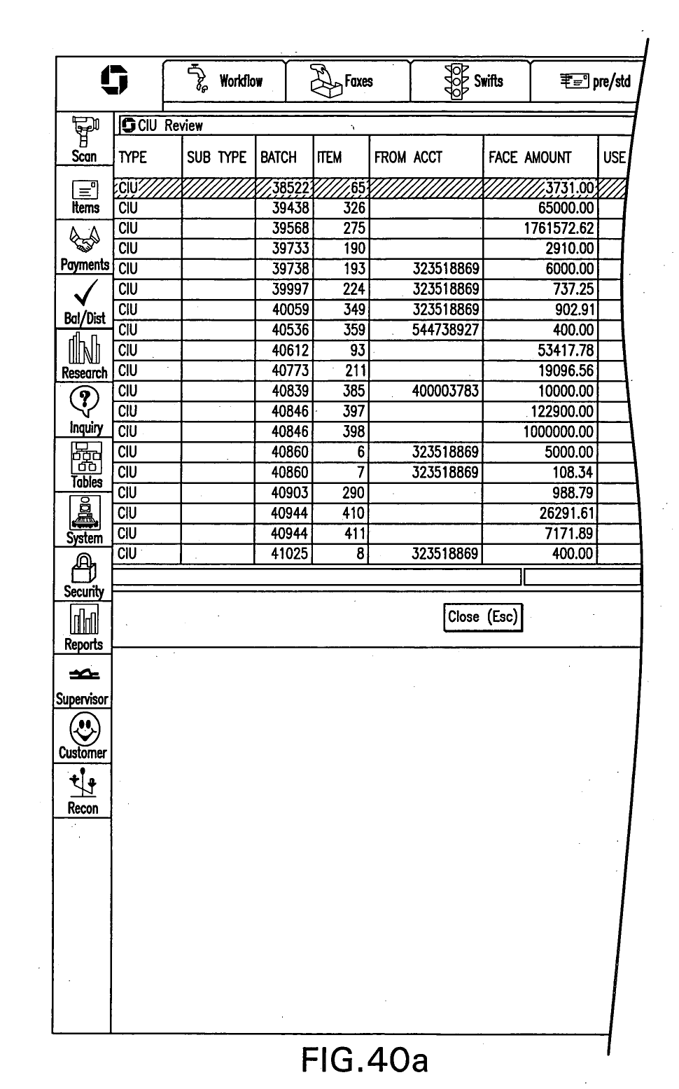

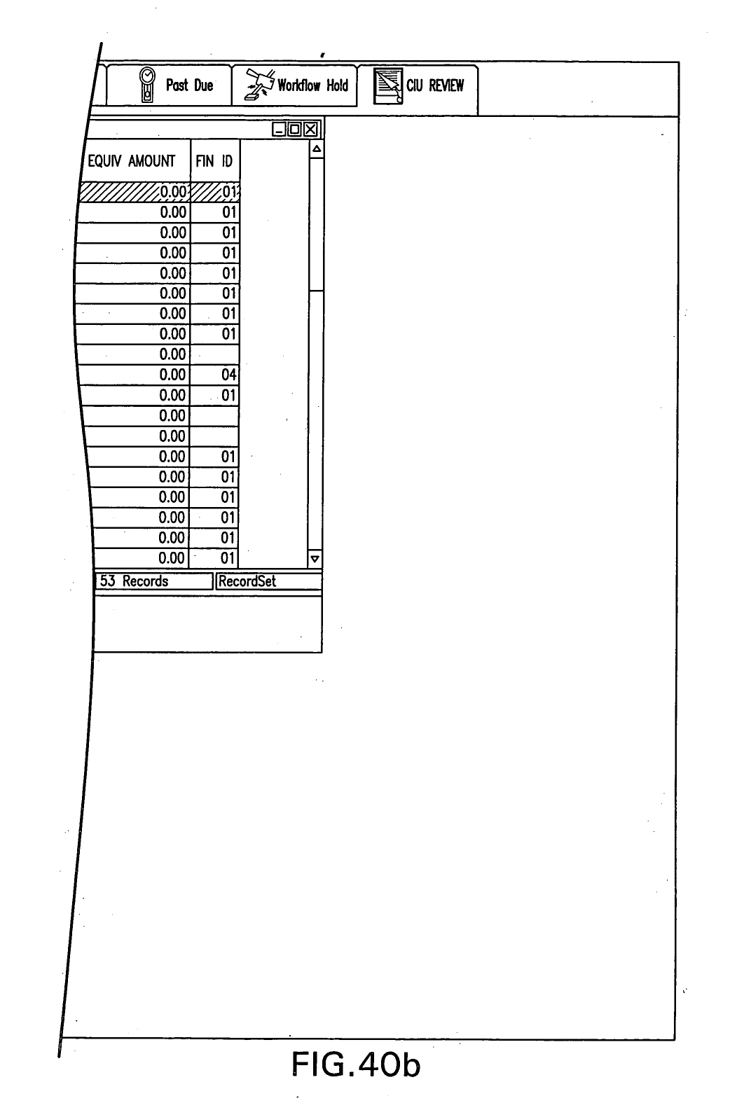

FIG. 40 is a diagram depicting the main screen obtained by selecting the CIU Review tab. In CIU Review, the IDCS user process items drawn “on us” for payment or return. Clients signature card and account status are reviewed as part of the decision. The CIU Review tab is the module where “On-Us” items are housed for account/signature verification. The IDCS user verifies all pertinent account information for accuracy before deciding whether the case is either “PAY” or “Return”.

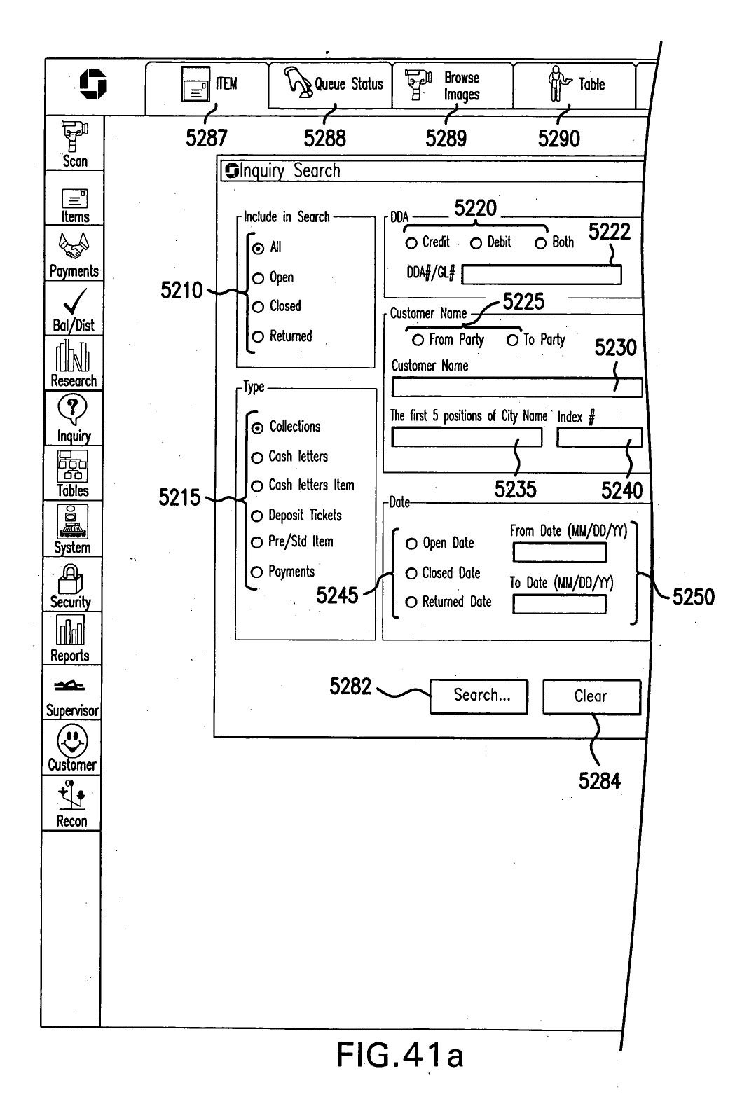

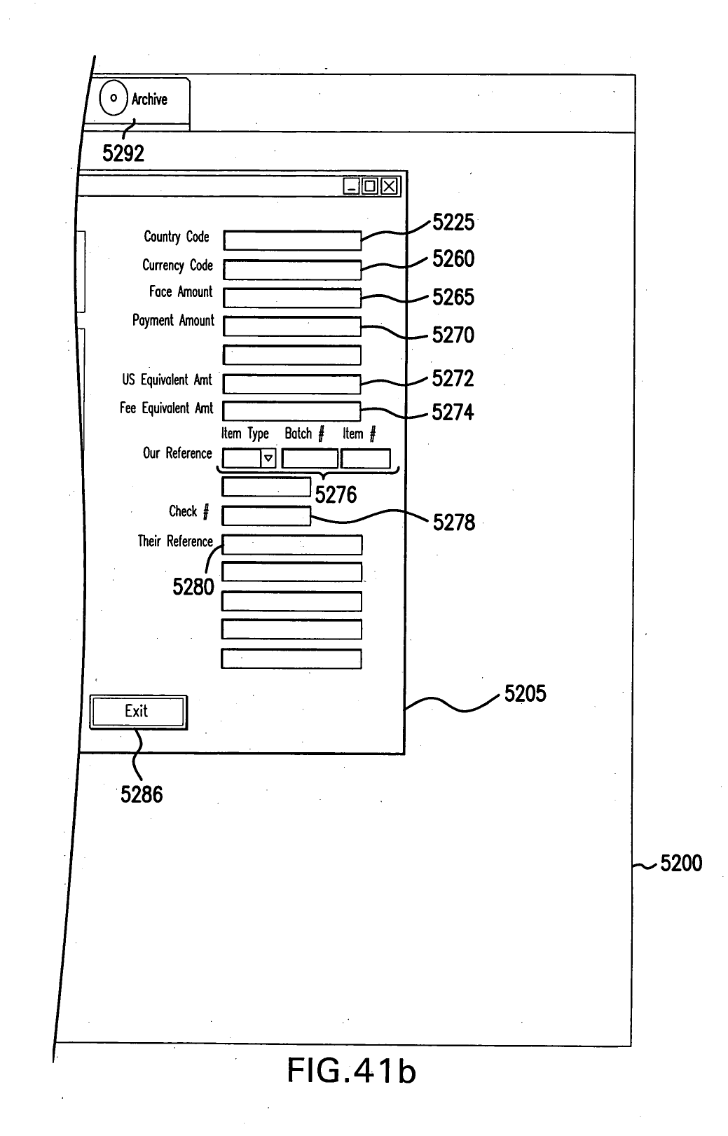

When inquiry button 705f is selected, inquiry module 270 cause the user to be presented with an inquiry screen 5200, as shown in FIG. 41. This screen allows for entry of search criteria in searching for an item. Radio buttons 5210 allow the user to narrow the search to include all items (default), only open items, only closed items, or only returned items. Radio buttons 5215 allow the user to specify the type of items to be searched. In particular, collections (default), cash letters, cash letter items, deposit tickets, Pre/Std items, and payments. DDA search may utilize radio buttons 5220 to select credit, debit, or both. The DDA#/GL# field 5222 allows for direct entry of this information. Customer name entry utilizes radio buttons 5225 to specify the from party or the to party. The customer name is entered into customer name field 5230, with city name and index number being entered in the fields 5235 and 5240, respectively.

The date criteria can be entered utilizing the date radio buttons 5245 and the “from date” and “to date fields” 5250. The date radio buttons 5245 include buttons for an open date (default), a closed date, and a return date. Other criteria may be entered in country code field 5255, currency code field 5260, face amount field 5265, payment amount field 5270, US equivalent amount field 5272, and fee equivalent amt field 5274. The our reference field 5276 has three subfields: item type, batch # and item #. Other fields include the check number field 5278 and the their reference field 5280. The search button 5282 is clicked to invoke the entered search criteria and proceed to a search result. The clear button 5284 clears the entered search criteria, while the exit button 5286 allows the user to exit from the inquiry process. The default tab at the top of the screen is item tab 5287, which is used to search for an item. Other tabs include queue status tab 5288, browse images tab 5289, table tab 5290 and archive tab 5292.

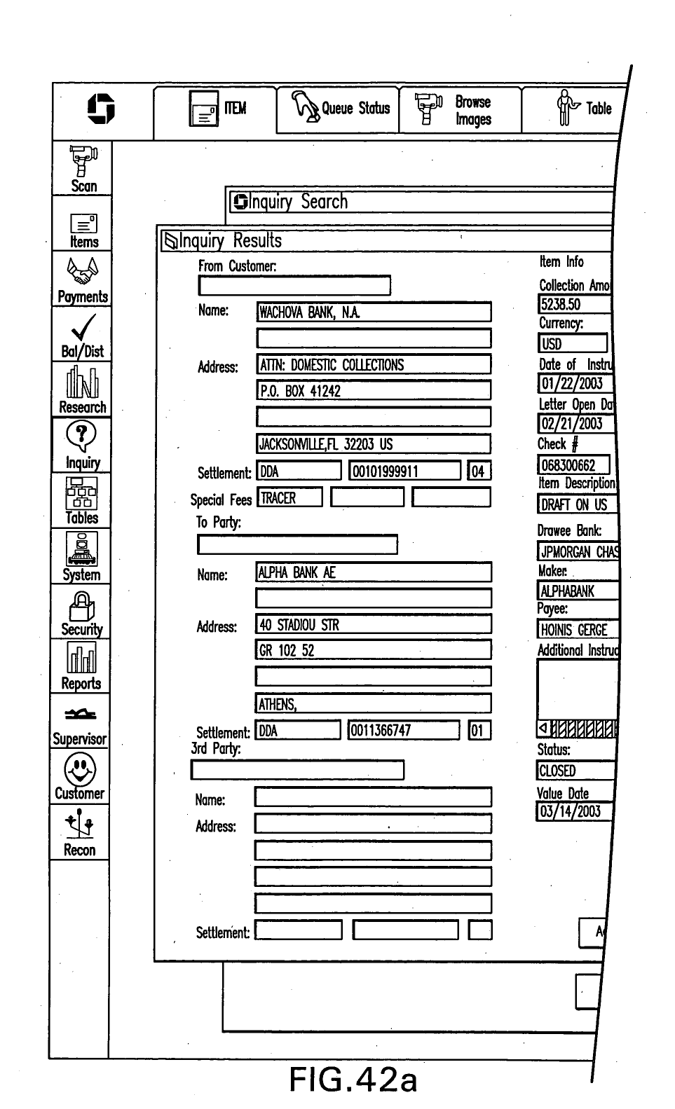

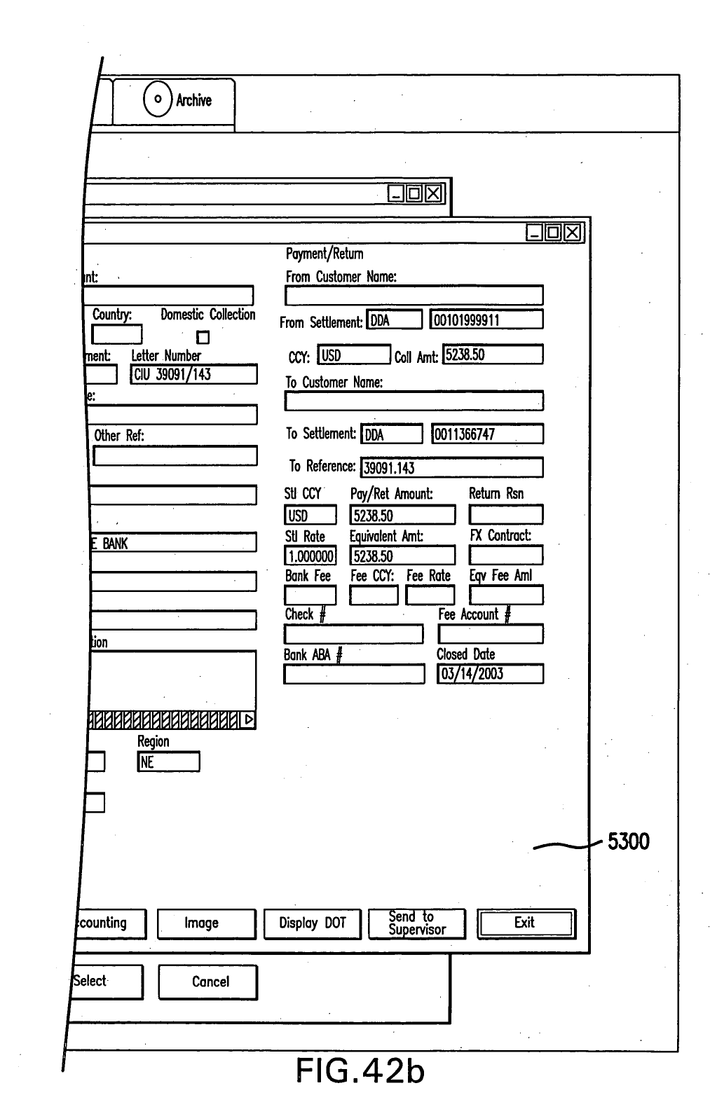

Once the search criteria have been submitted, the research inquiry module 270 performs a search of the records based upon the search criteria. Preferably, the results of the search are displayed in a pop up window showing relevant information for the item uncovered by the search. An example inquiry results field 5300 is shown in FIG. 42. As shown in that figure, the system returns information related to the search result in a table form, preferably superimposed in a pop up window.

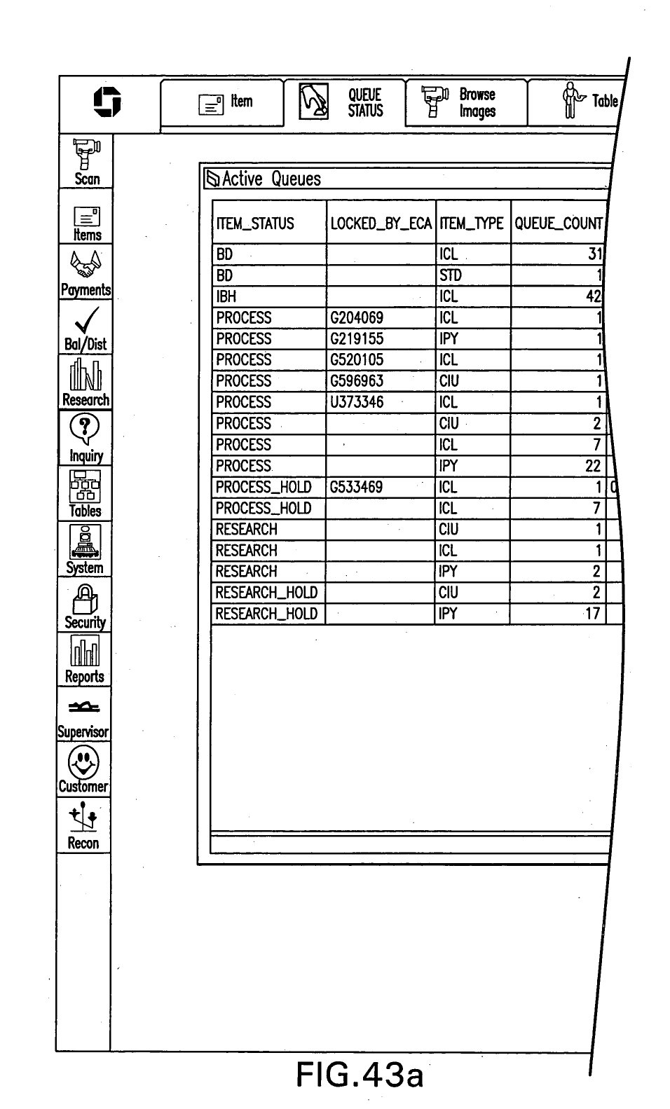

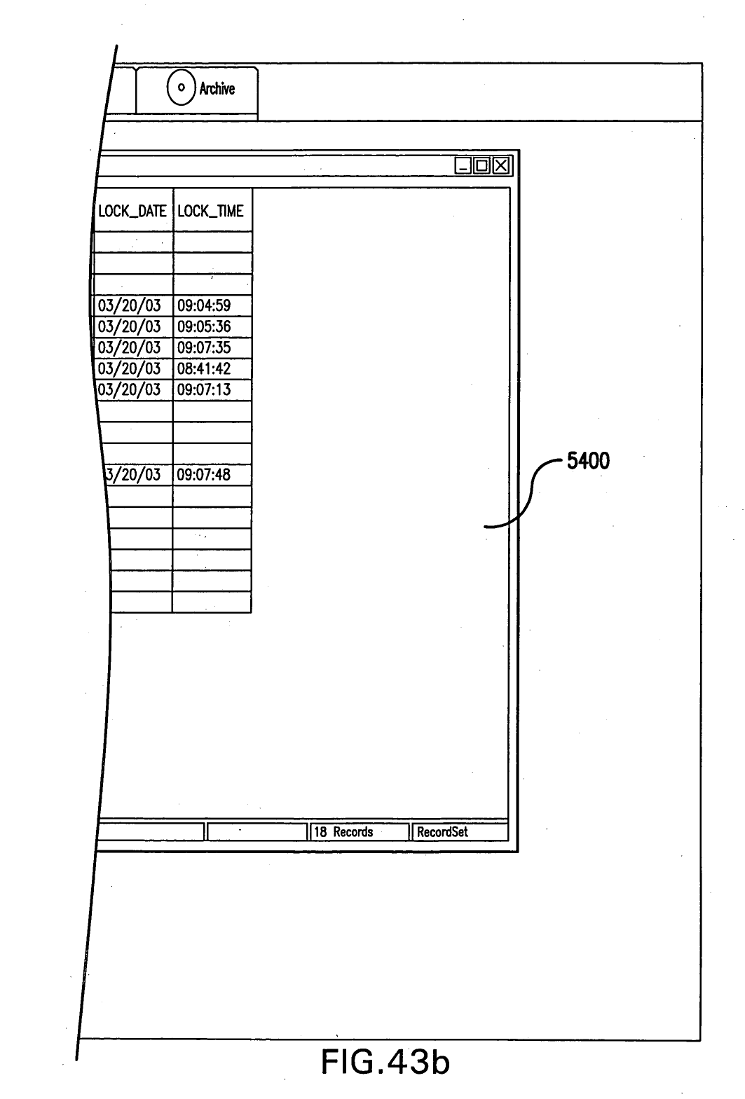

Selection of the queue status tab 5288 causes display of active queues field 5400, as shown in FIG. 43. The queue status tab provides a snap shot of all the processing queues and the number of items within each queue access to the images must be obtained via the indicated queues.

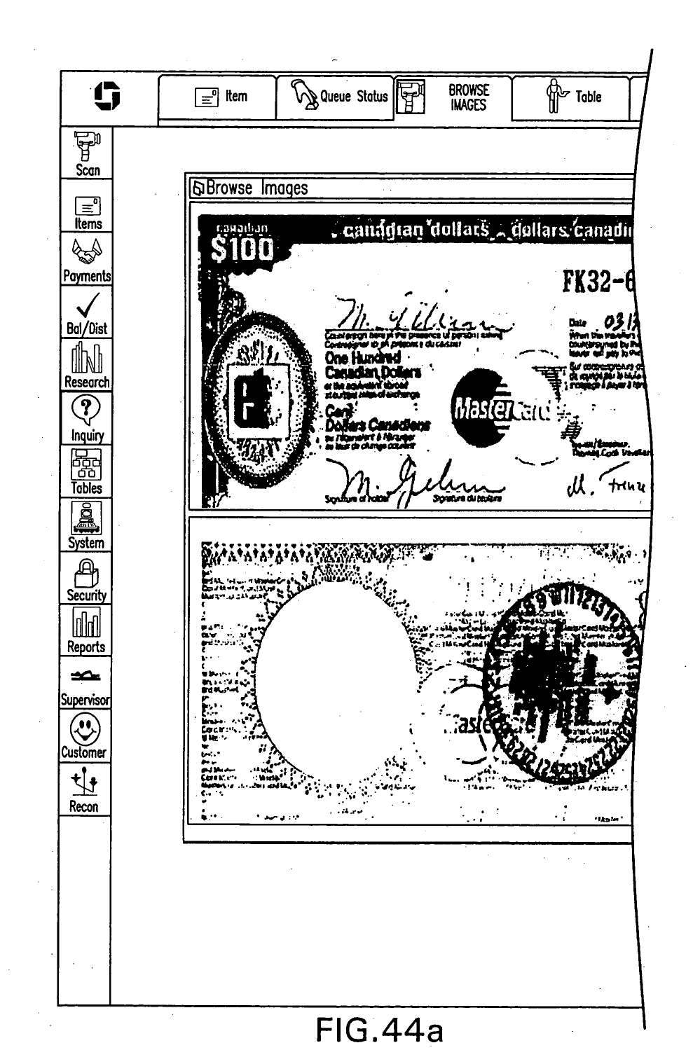

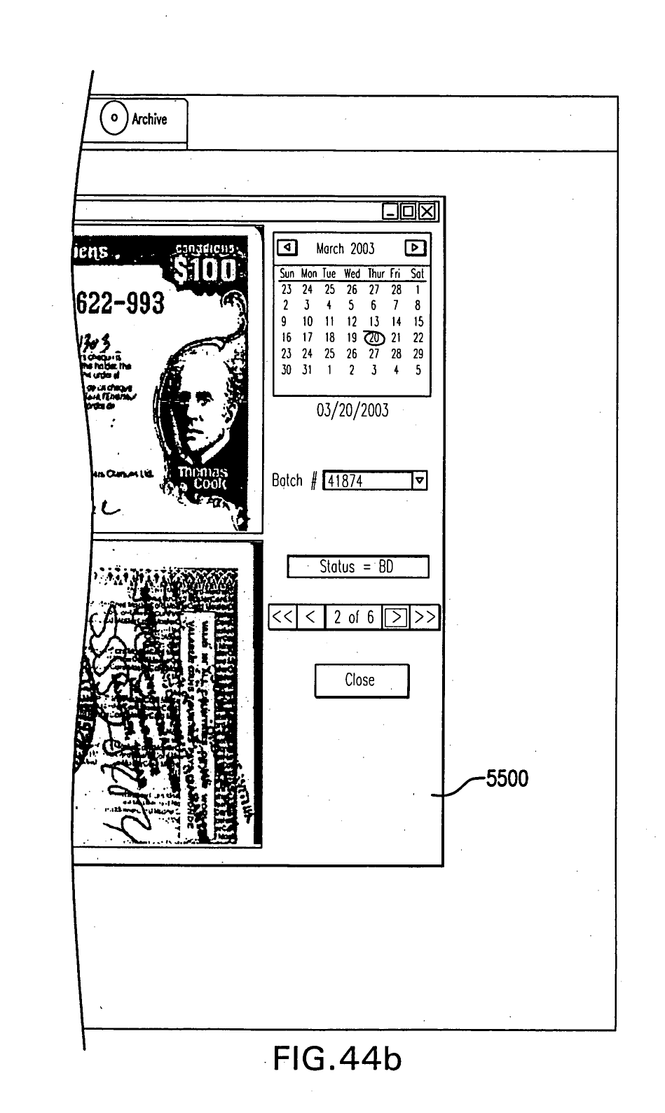

Selection of the browse images tab 5289 causes display of the browse images screen 5500, as shown in FIG. 44. FIG. 44 is the result image of the selected batch. Batches are listed in the drop down batch number field. The required batch is either entered or highlighted.

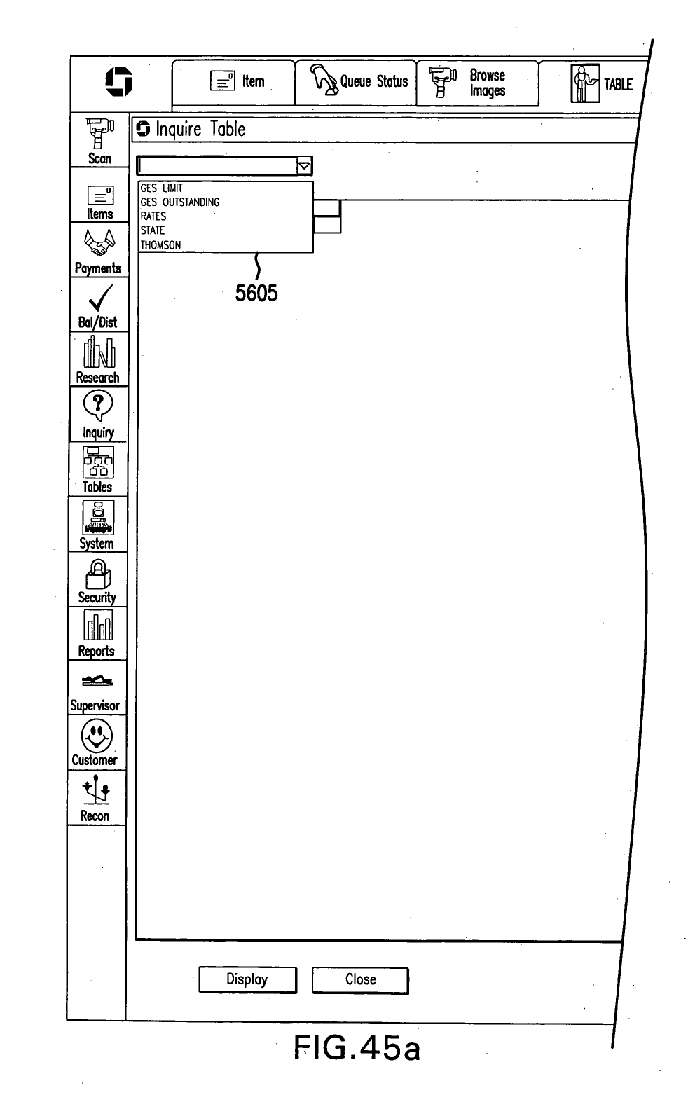

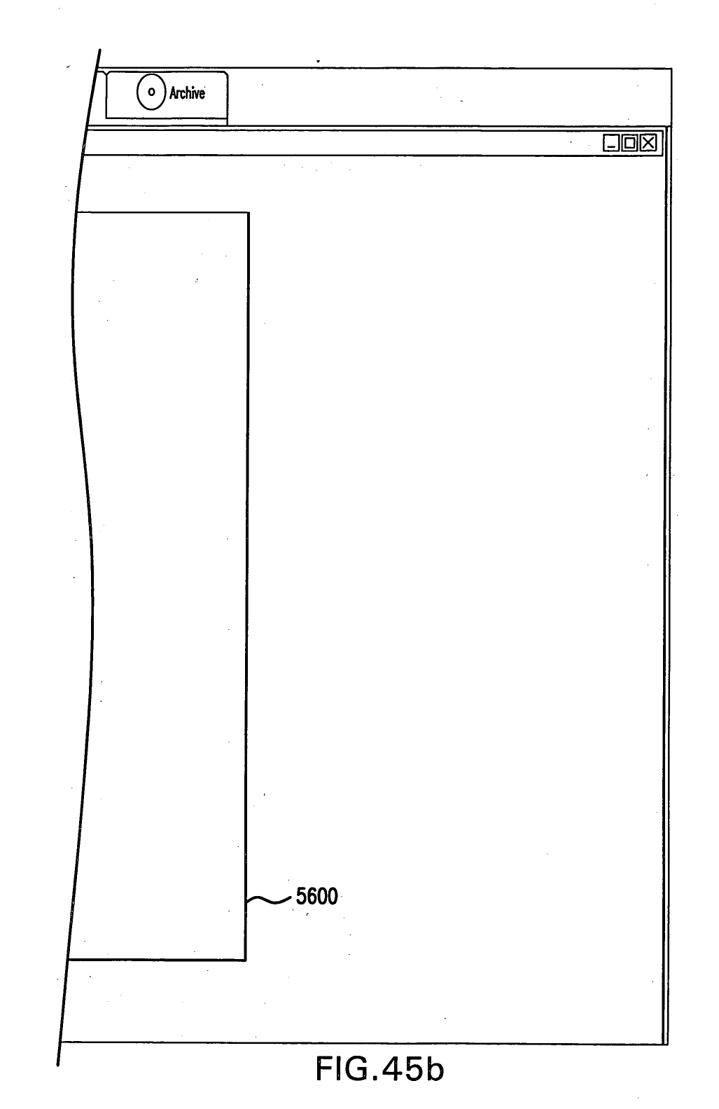

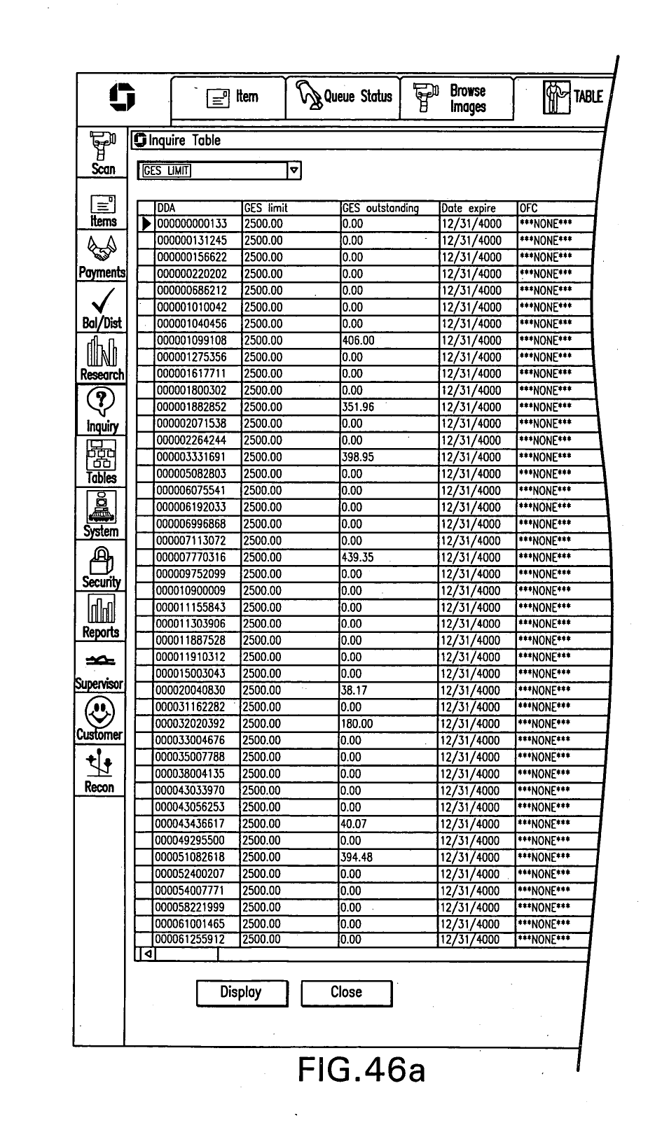

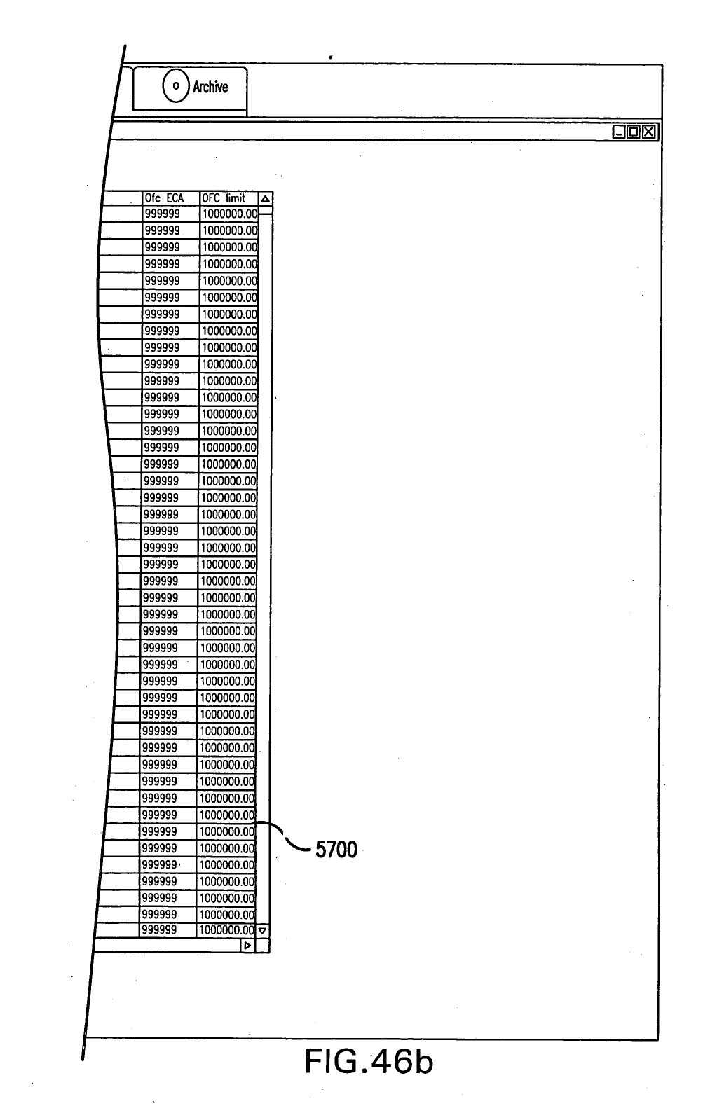

Selection of the table tab 5290 causes display of the inquire table selection screen 5600, as shown in FIG. 45. That screen includes a drop down list box 5605 that has a list of the tables available for inquiry. The user clicks one of the table names in the drop down list box 5605 and the screen with the selected list are displayed. FIG. 46 shows a resultant list 5700 for GES Limit selected from drop down list box 5605 in FIG. 45. Other selections from the drop down list box 5605 would result in a display of a corresponding table.

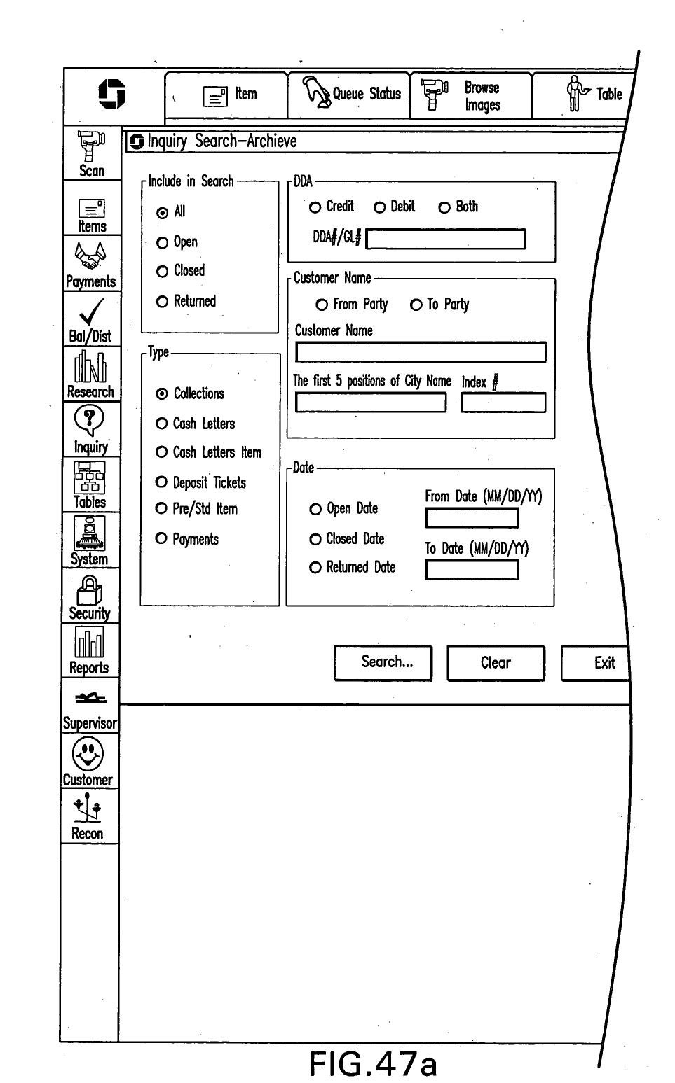

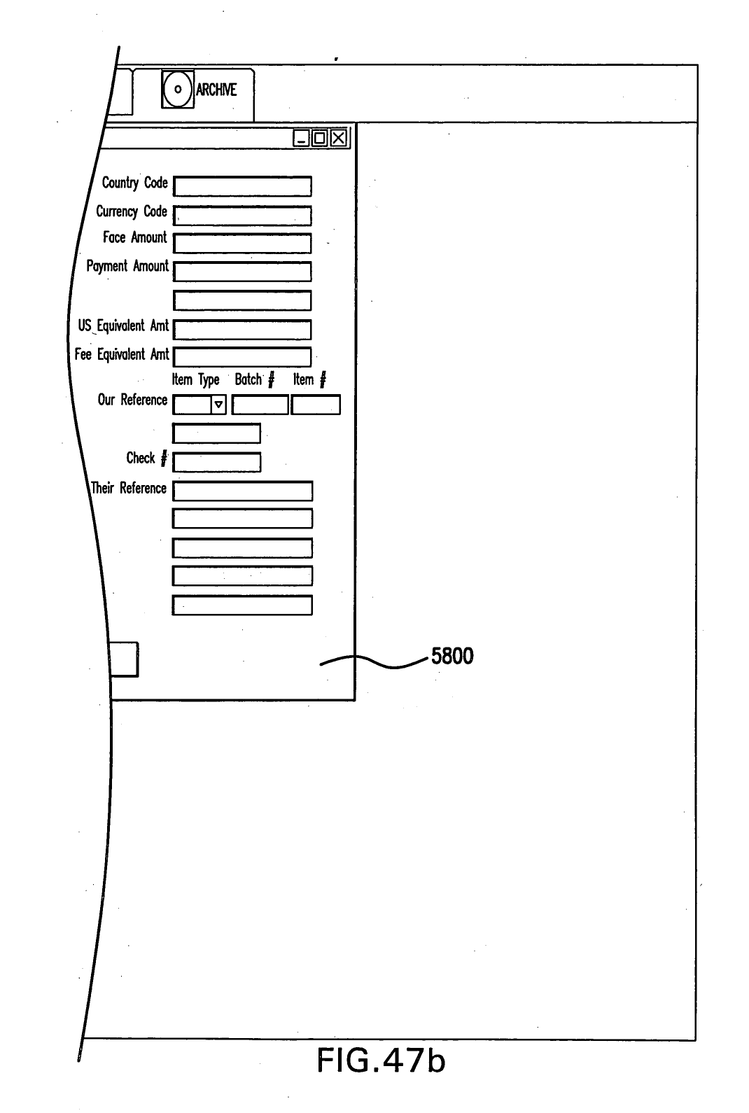

Selection of the archive tab 5292 causes display of the archive screen 5800, shown in FIG. 47, which is preferably substantially identical to the search entry field shown in FIG. 41 for items.

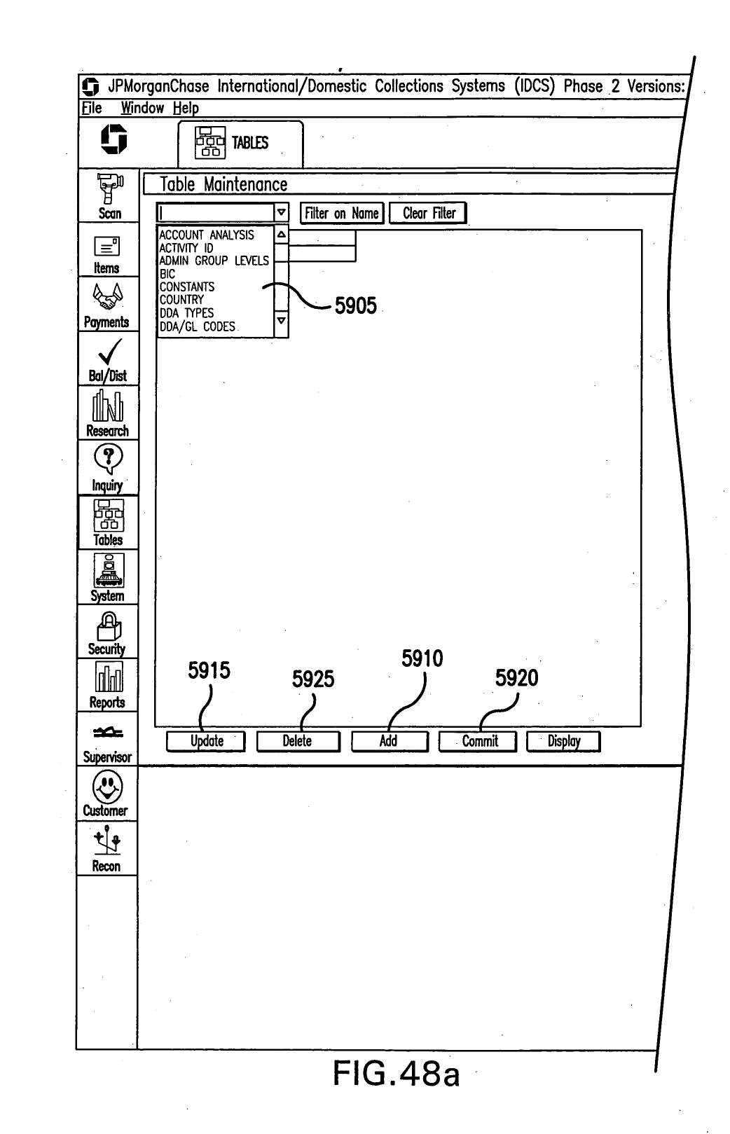

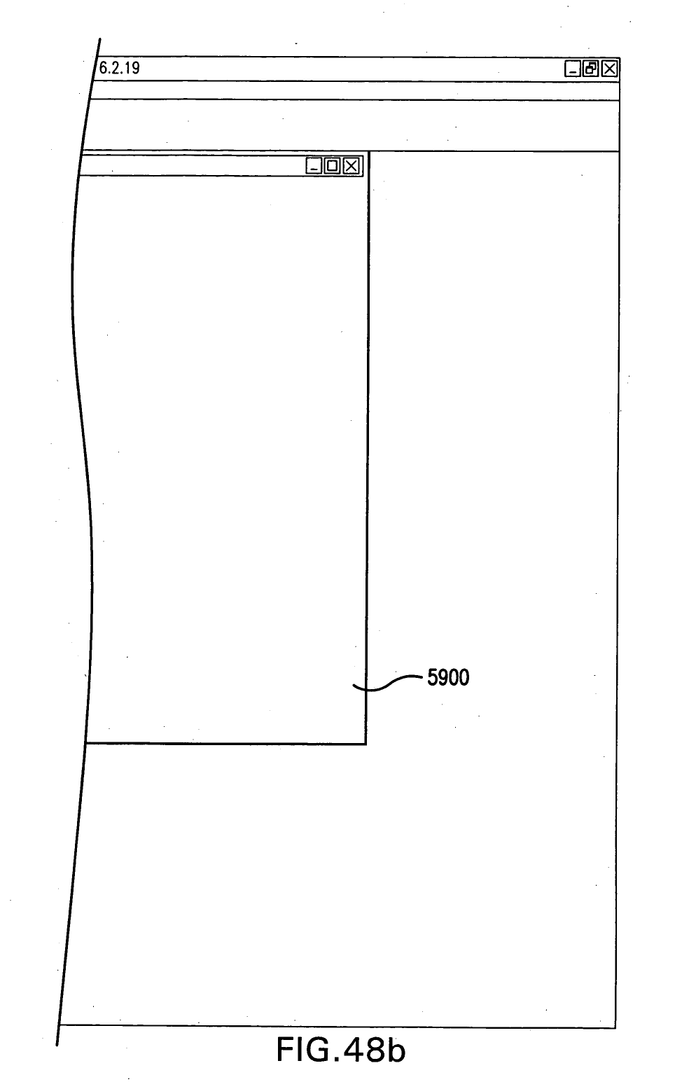

When the table maintenance button 705g is selected, the user is presented with an table maintenance screen 5900, as shown in FIG. 48. That screen includes a drop down list box 5905 that allows the user to select a table for maintenance. In particular, the list includes the tables available for update. Preferably, the tables available for maintenance are dynamically controlled by a program such as Oracle so that new tables are automatically put into the list without the need for Visual Basic code changes. Visual Basic is a software application that provides the workflow functionality for IDCS. A table is selected for maintenance by clicking on the name in the dropdown list box 5905. When the table is selected, a grid with the fields for that table is displayed (not shown). The add button 5910 is enabled upon selection of a table from the dropdown list box 5905. Clicking the add button 5910 an add table screen is presented to the user (not shown). Clicking the update button 5915 allows a record to be updated. The changes made during the update can be saved by clicking the commit button 5920.

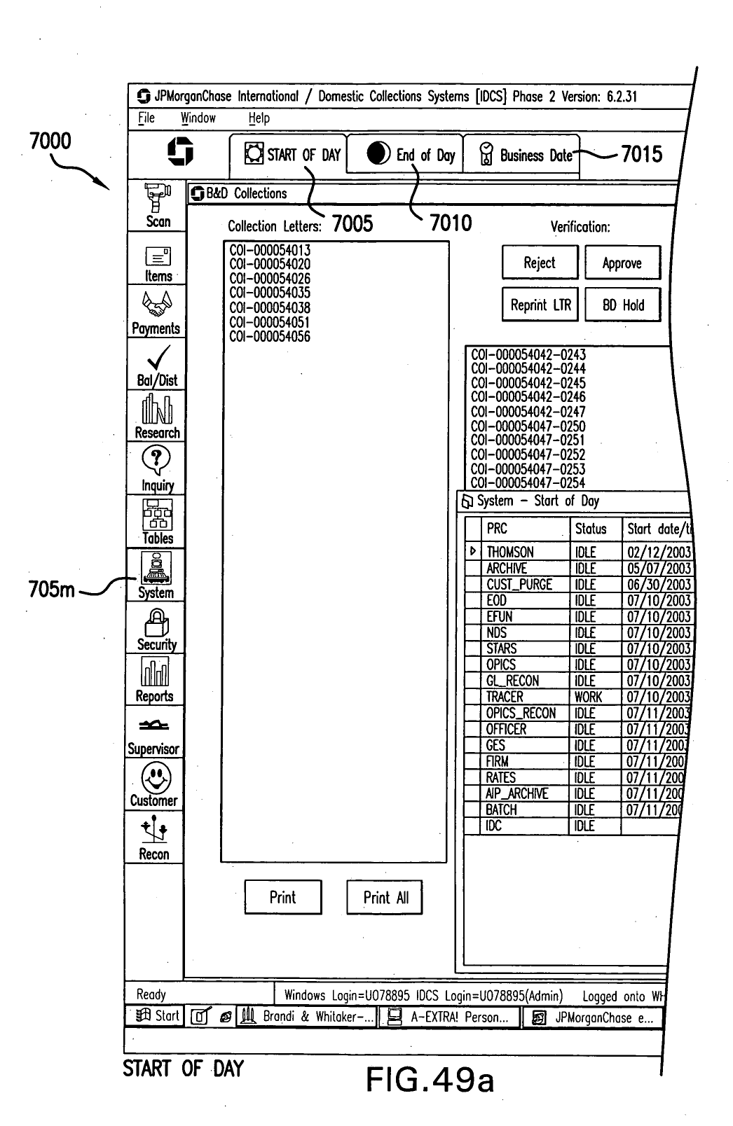

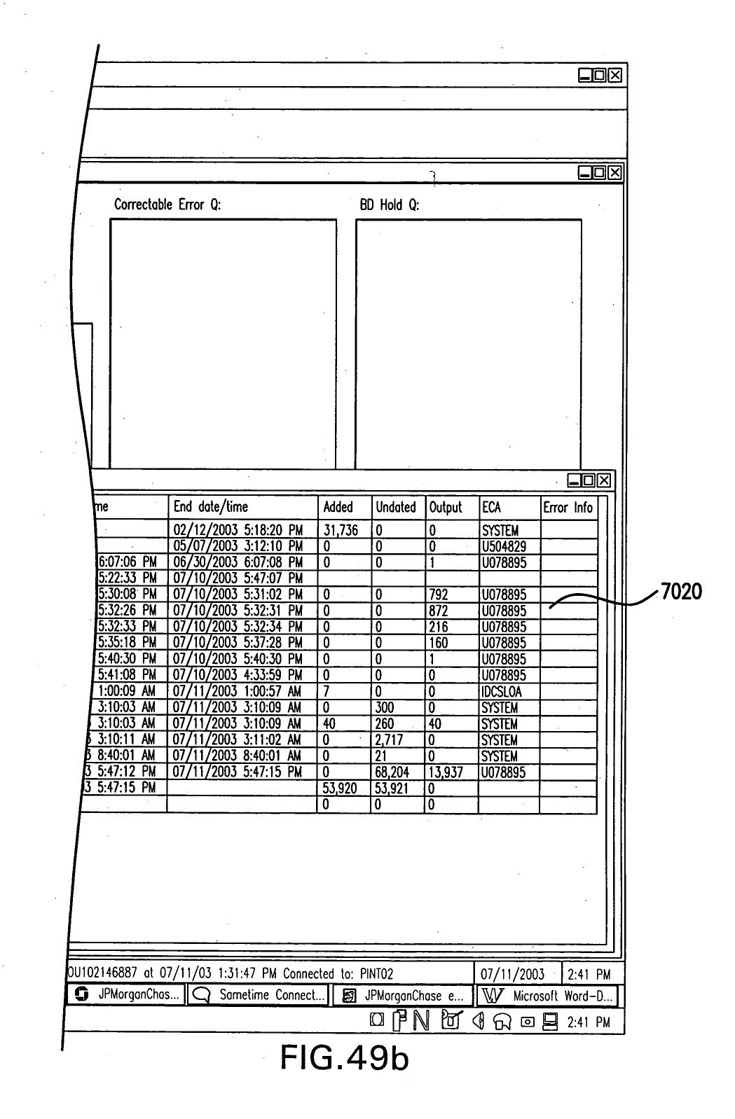

When System tab 705m is clicked on the left side of the screen, a screen 7000 having a start of day tab 7005, an end of day tab 7010, and a business date tab 7015, is displayed. Such a screen is shown in FIG. 49. The start of day tab selection is the default and causes a grid 7020 to be displayed. The grid 7020 shows the status of the processes from the previous days' end of day processing. Preferably, it should show that all processes have completed successfully in order to begin a new day of work.

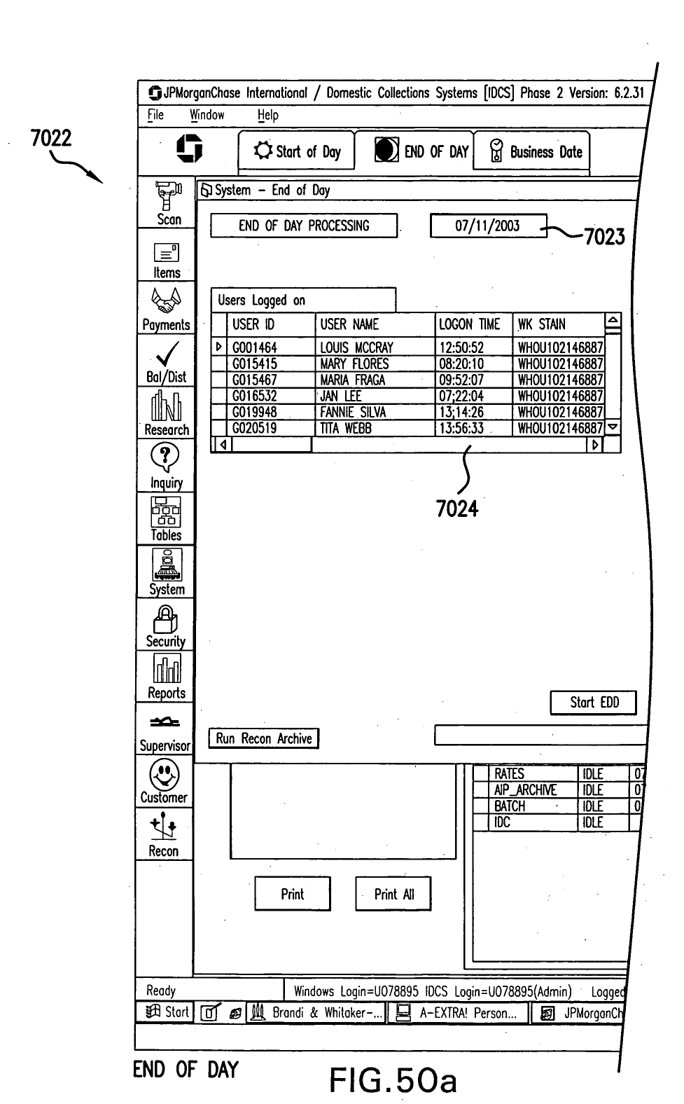

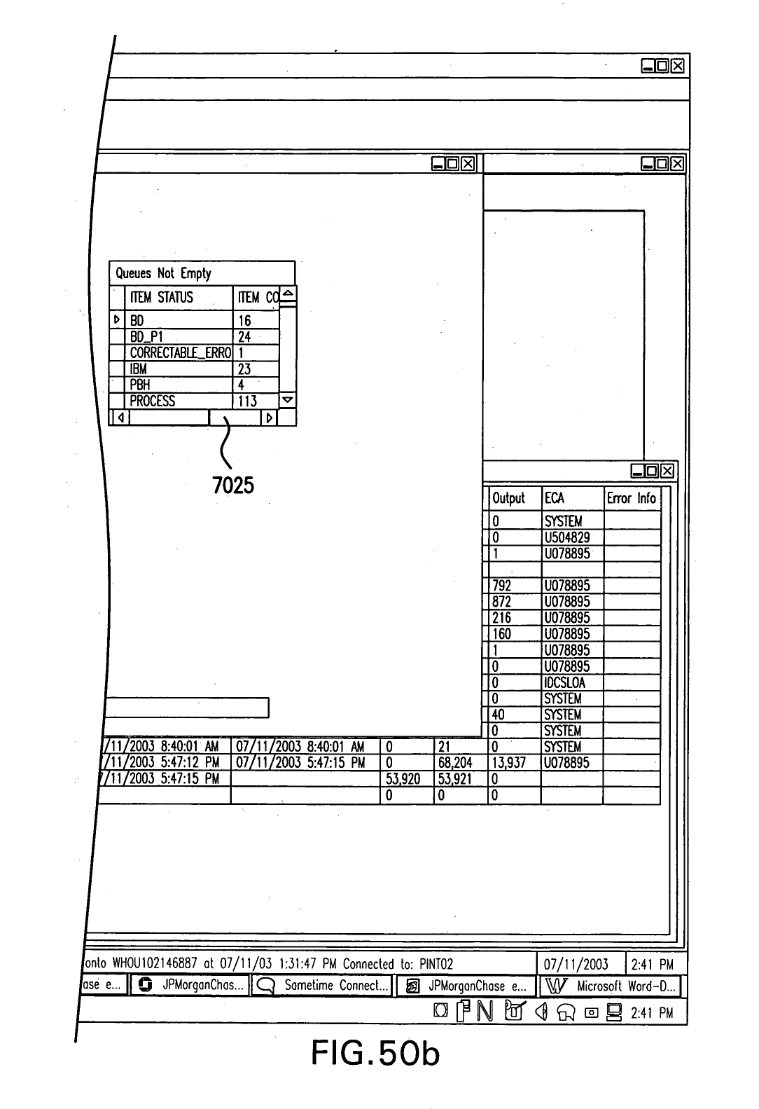

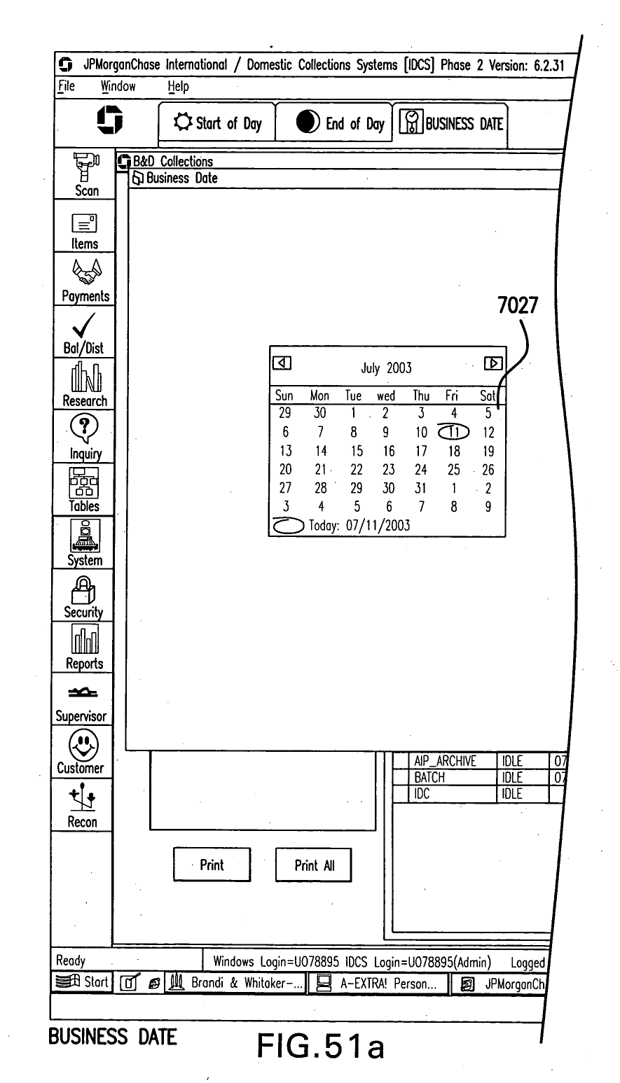

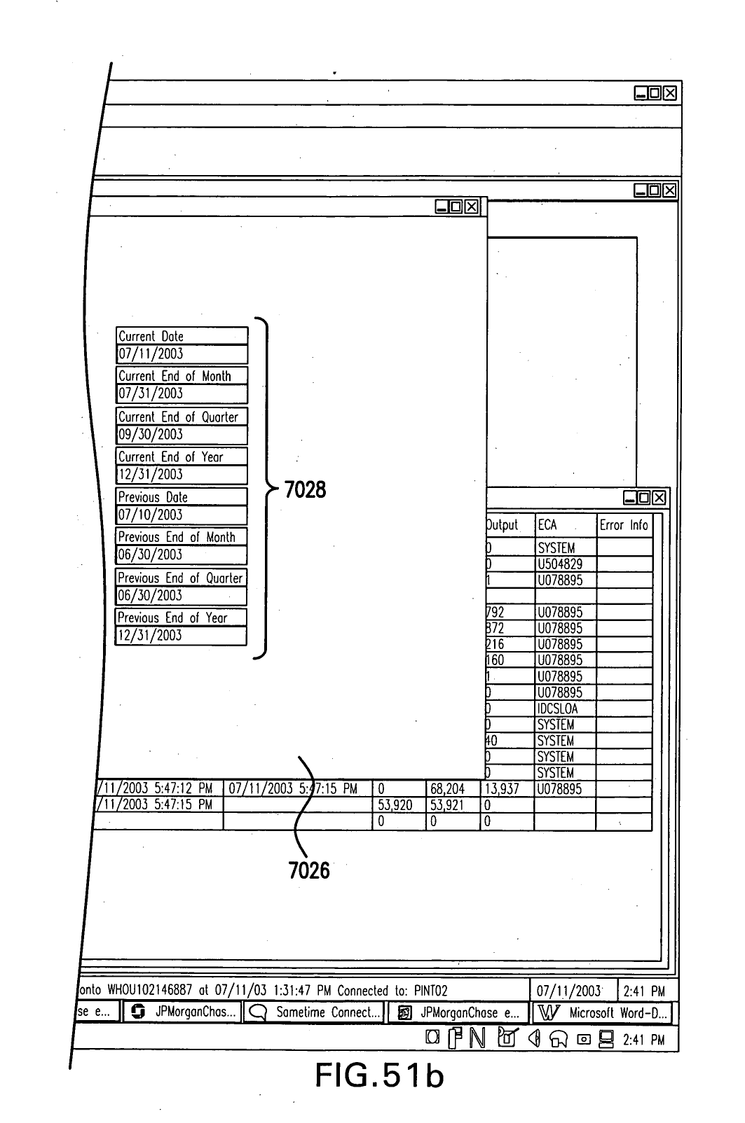

Selection of the end of day tab 7010 preferably causes display of a screen 7022, as shown in FIG. 50. End of day area 7023 shows an end of day processing date, i.e., the date the current end of day processing will use. Users logged on field 7024 displays a list of users that are still logged in to the system of the present invention. Queues not empty field 7025 displays information about processing queues that are not empty. End of day processing cannot begin until all normal processing queues are empty. Preferably, the list includes at least the queue name and the queue count. End of day processing preferably includes the steps necessary to ensure that any steps that need to be done before close of the system for that day are done. When the business date tab 7015 is clicked, a business date screen 7026 appears. This screen preferably displays a calendar 7027 of the current month with the current business date highlighted. The business date would preferably be set by the system. A supervisor log on would preferably be required to change the current business date if necessary. Preferably, a list 7028 of system dates also is displayed. These dates, except for the current business day, cannot be changed. The dates would preferably include: the current date; the current end of the month; the current end of the quarter; the current end of the year; the previous date; the previous end of the month; the previous end of the quarter; and the previous end of the year.

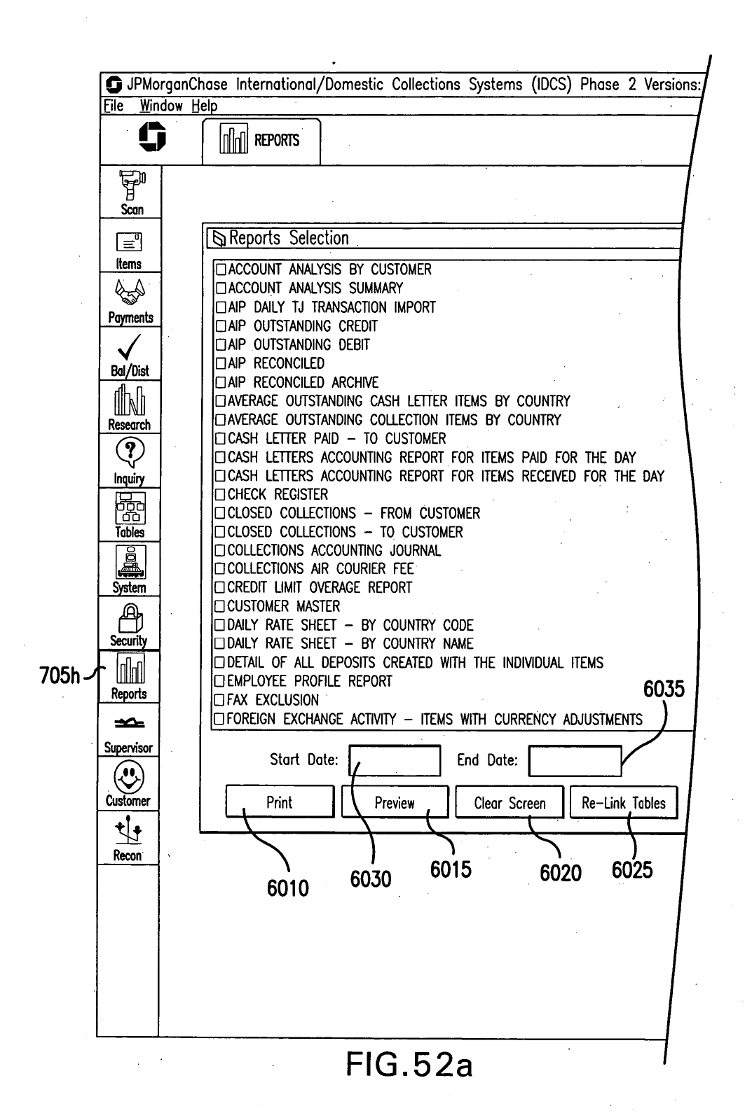

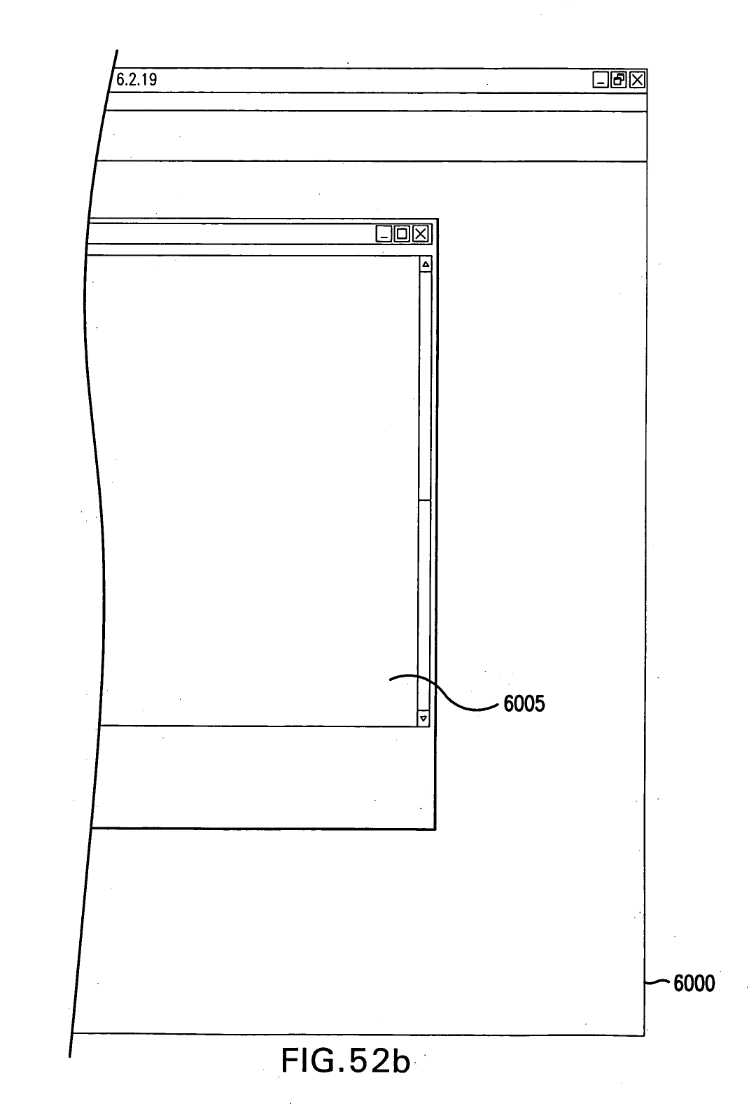

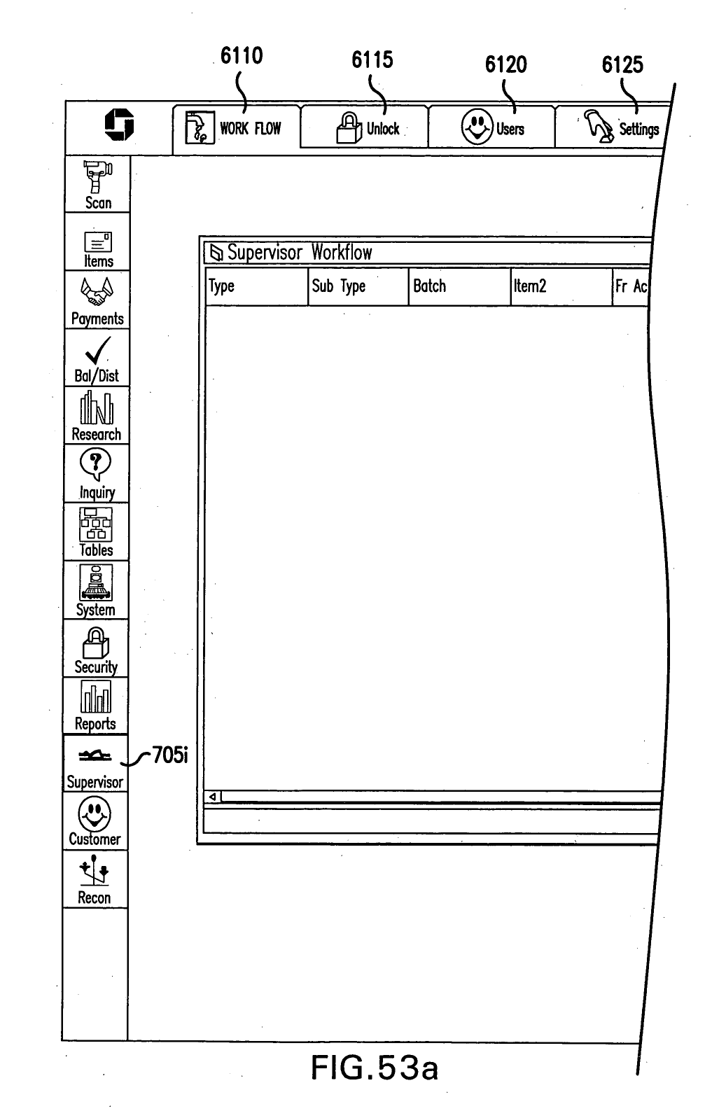

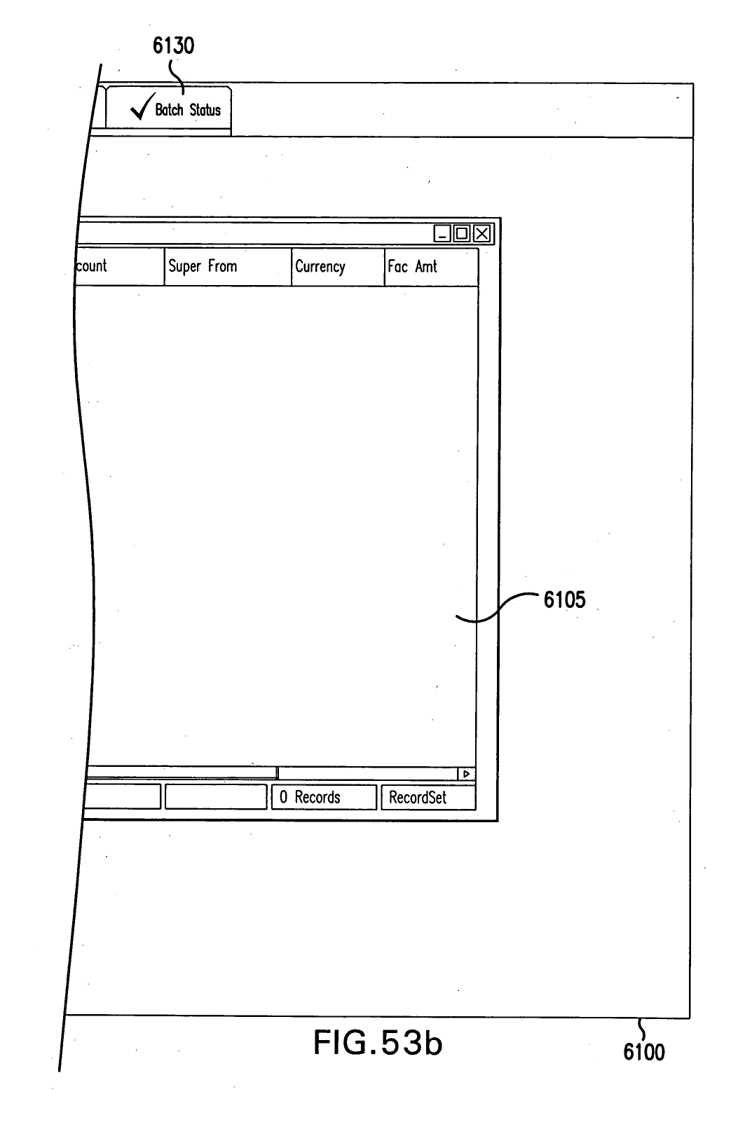

Clicking the reports button 705h on the left side of the screen causes the system to display a reports screen 6000, as shown in FIG. 52. Reports screen 6000 includes a reports selection window 6005 with displays a list of available reports. A report is selected by clicking an entry on the list, to highlight that entry, and using one of: the print button 6010, to send the report directly to a default printer; the preview button 6015, to allow viewing of the report at the user's workstation; the clear screen button 6020, to allow selection of another report without printing or previewing the previously selected report Start date and end date parameters may be entered in fields 6030 and 6035, respectively.

When the supervisor button 705i is selected, the supervisor workflow screen 6100 appears, as shown in FIG. 539. The workflow tab 6110 is selected as the default selection. Associated with the workflow tab 6110 is the textbox 6105. The textbox 6105 preferably lists the items that have been sent to the supervisor. An item that would be shown in the textbox 6105 is selectable, by double clicking on the item. This causes a processing screen appropriate for the selected item to be displayed, allowing the supervisor to determine the appropriate action for the item.

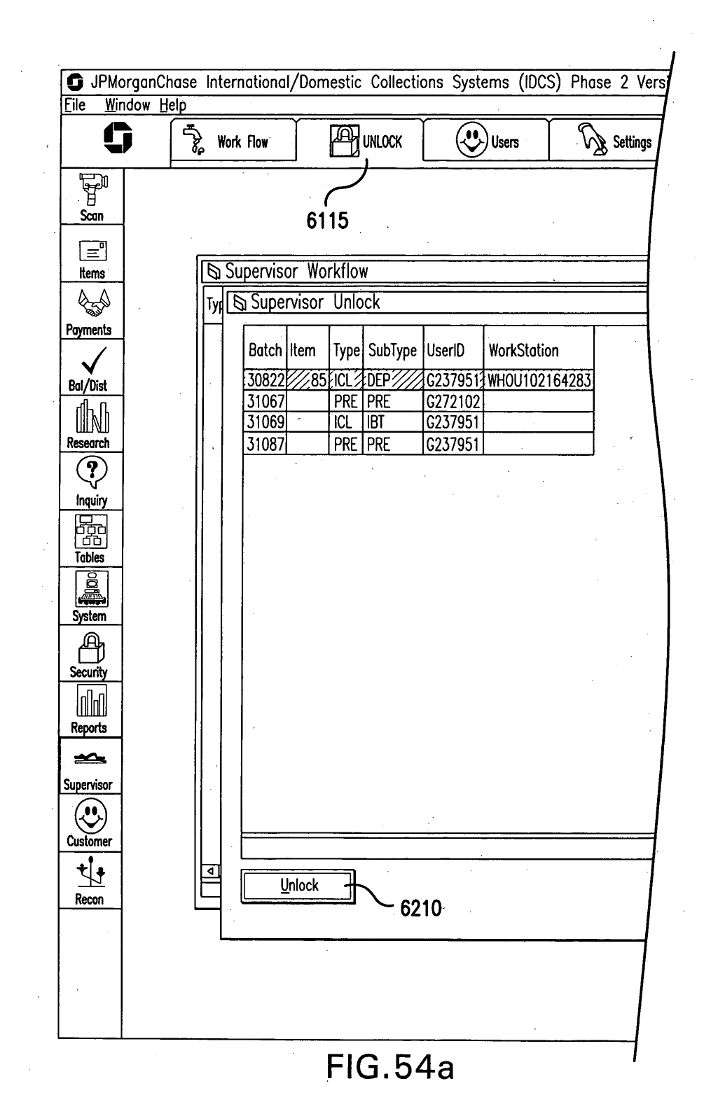

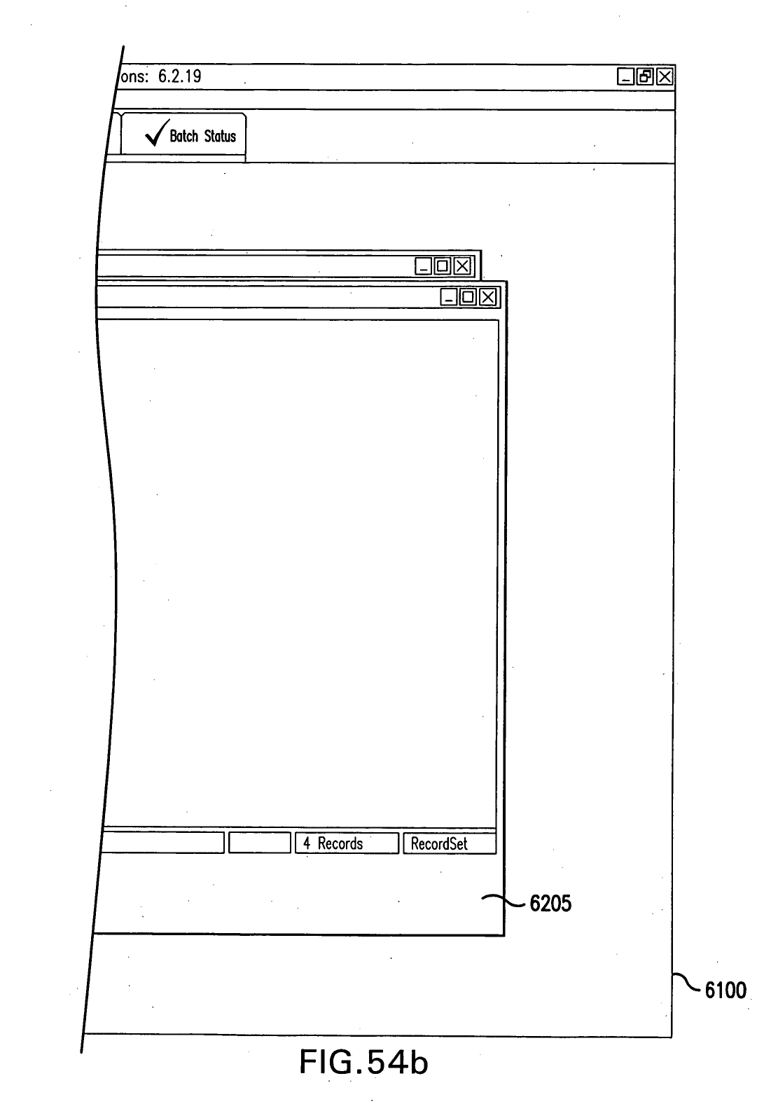

FIG. 54 shows the supervisor unlock textbox 6205, which is displayed as a cascading window in supervisor workflow screen 6100 when the unlock tab 6115 is selected. The textbox 6205 lists items that have been locked because a user failed to complete processing of the item. An item can be unlocked from the locked list by clicking on the item and clicking the unlock button 6210. This removes the item from the locked list and makes it available for processing.

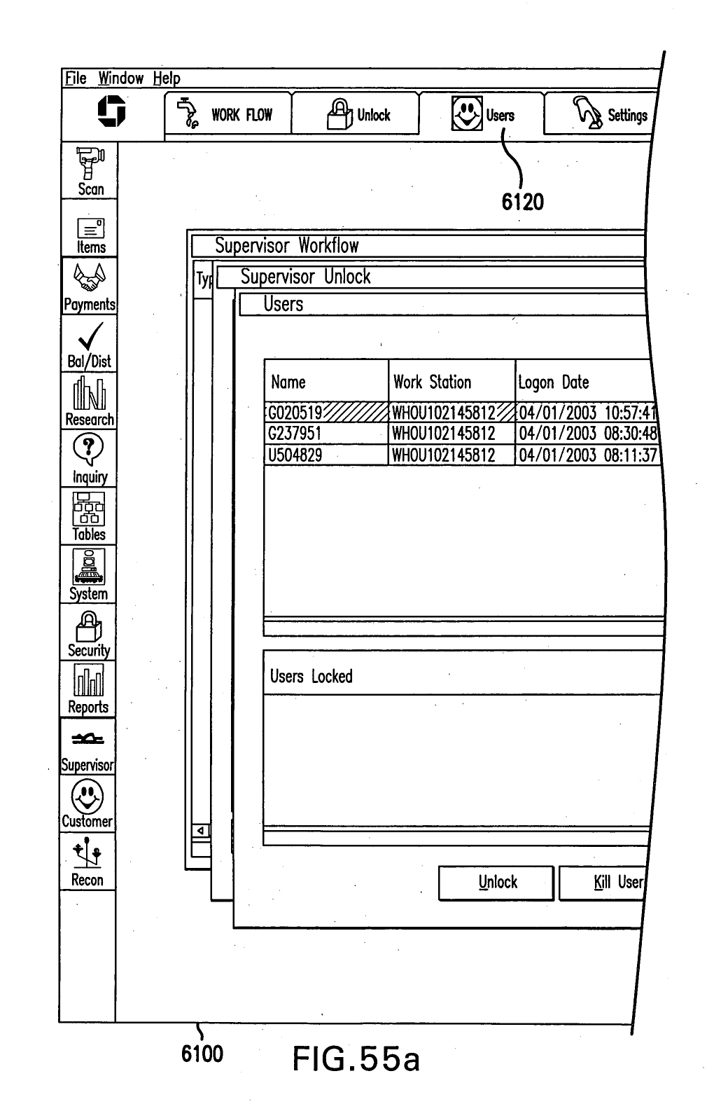

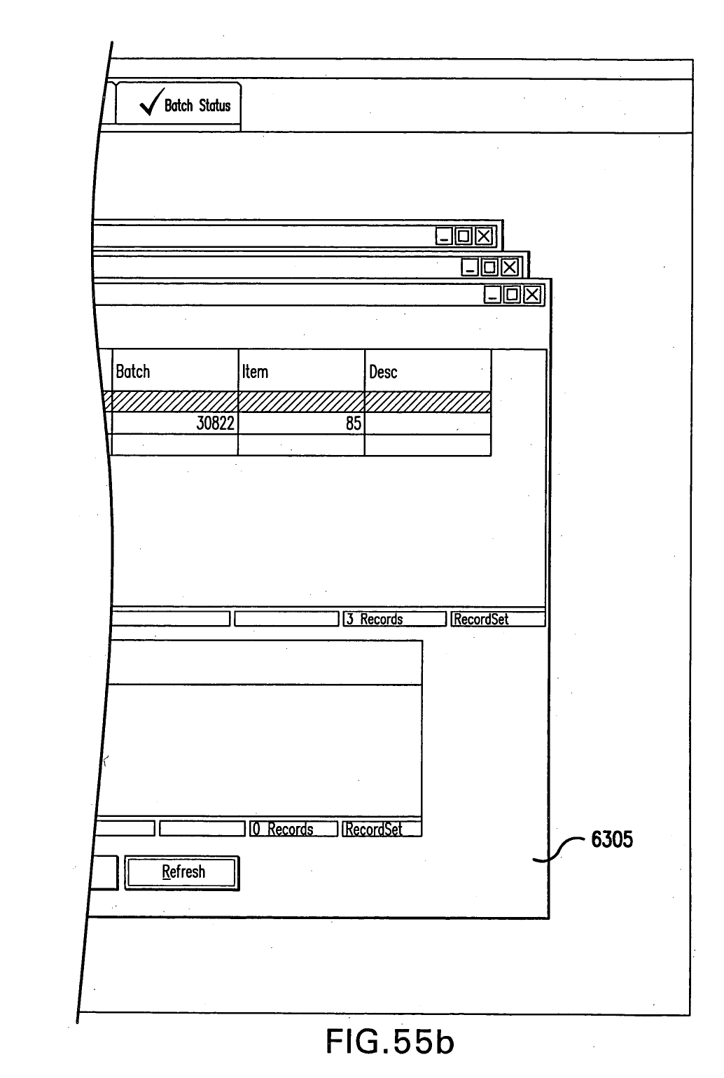

FIG. 55 shows the supervisor users textbox 6305, which is displayed as a cascading window in supervisor workflow screen 6100 when the users tab 6120 is selected. This window allows the supervisor to know who is logged on the system and which batch/item description the user is working on.

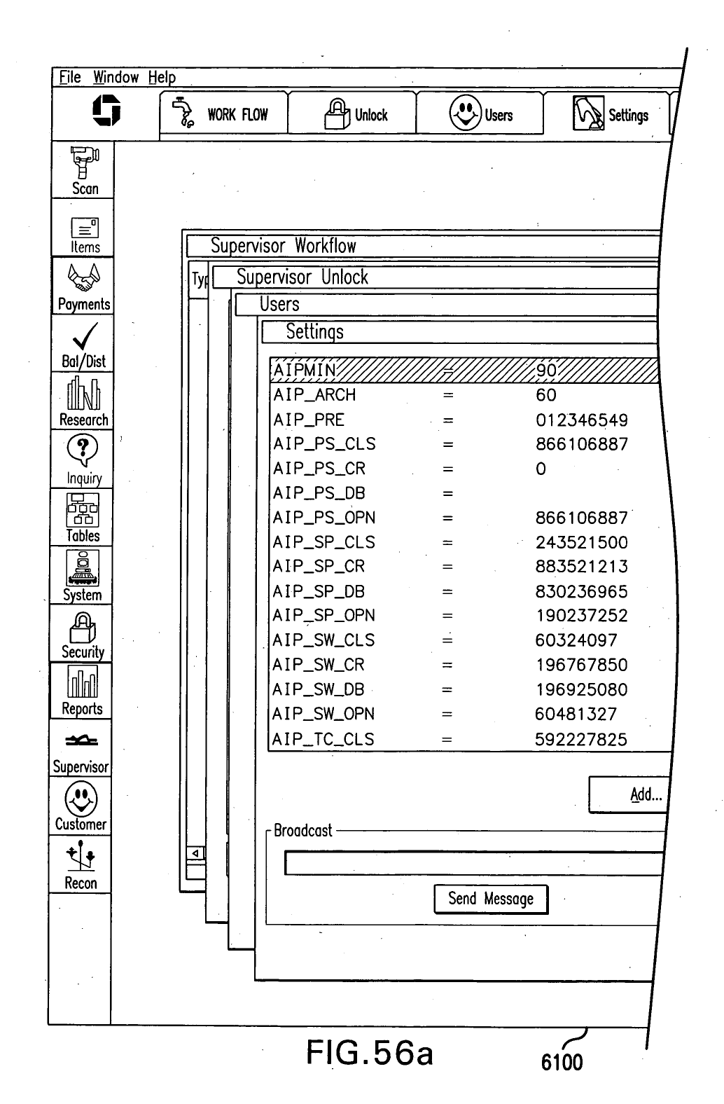

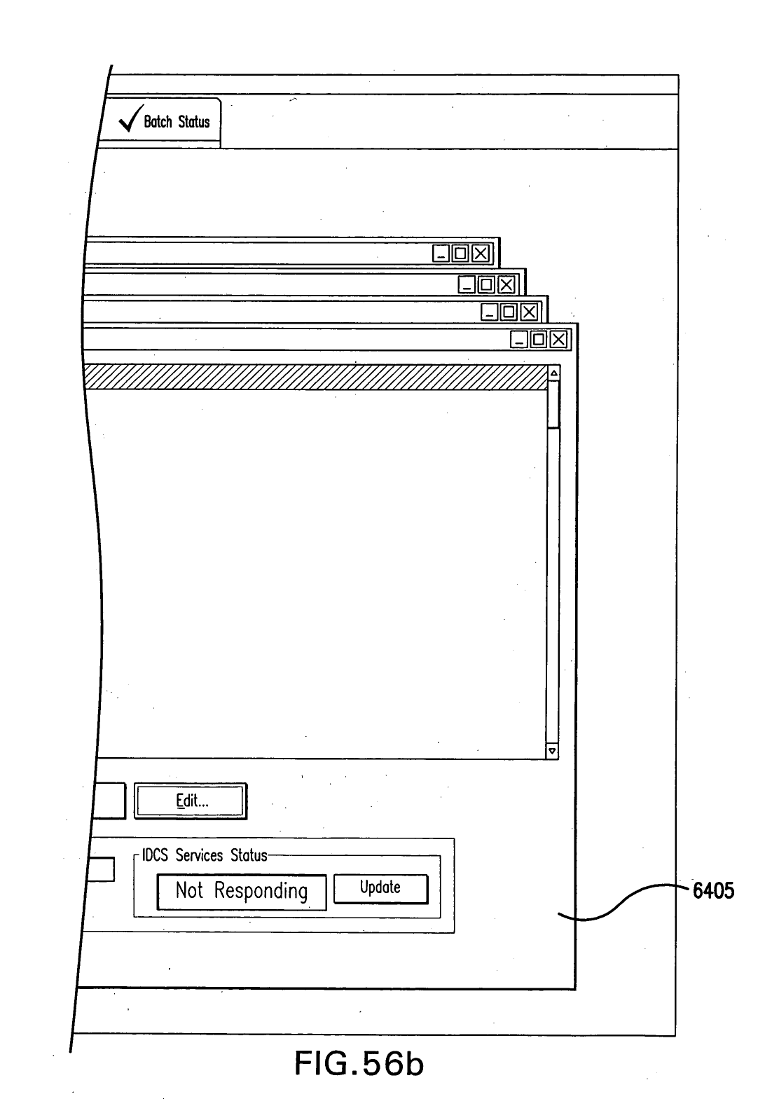

FIG. 56 shows the supervisor settings window 6405, which is displayed as a cascading window in supervisor workflow screen 6100 when the settings tab 6125 is selected. This window displays defaults for certain activities and features of the system.

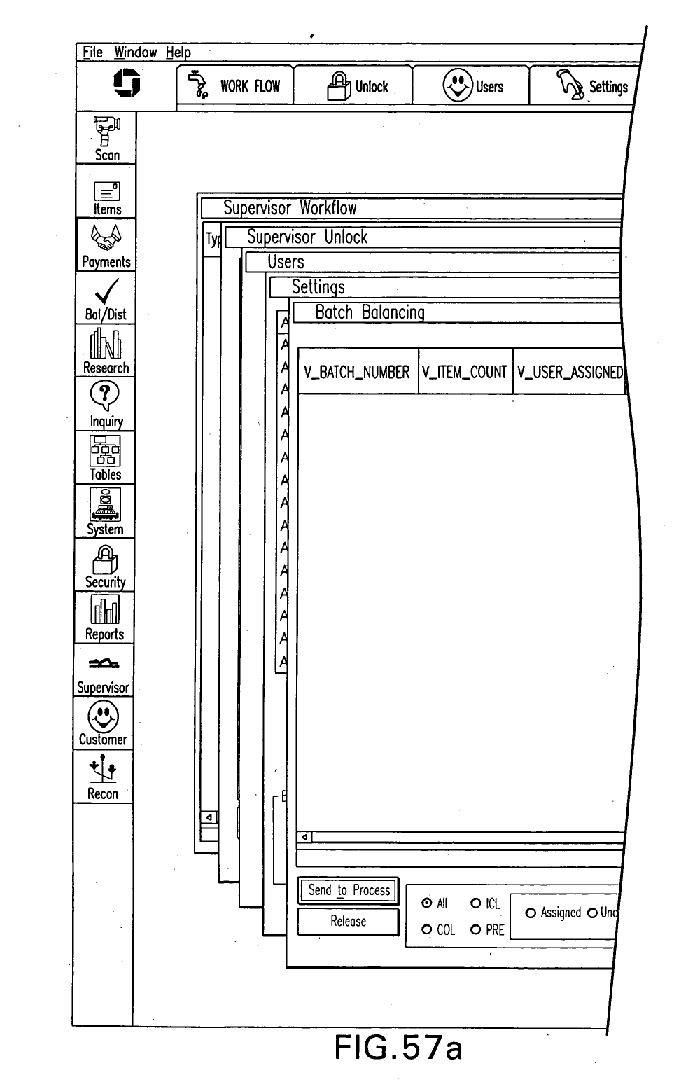

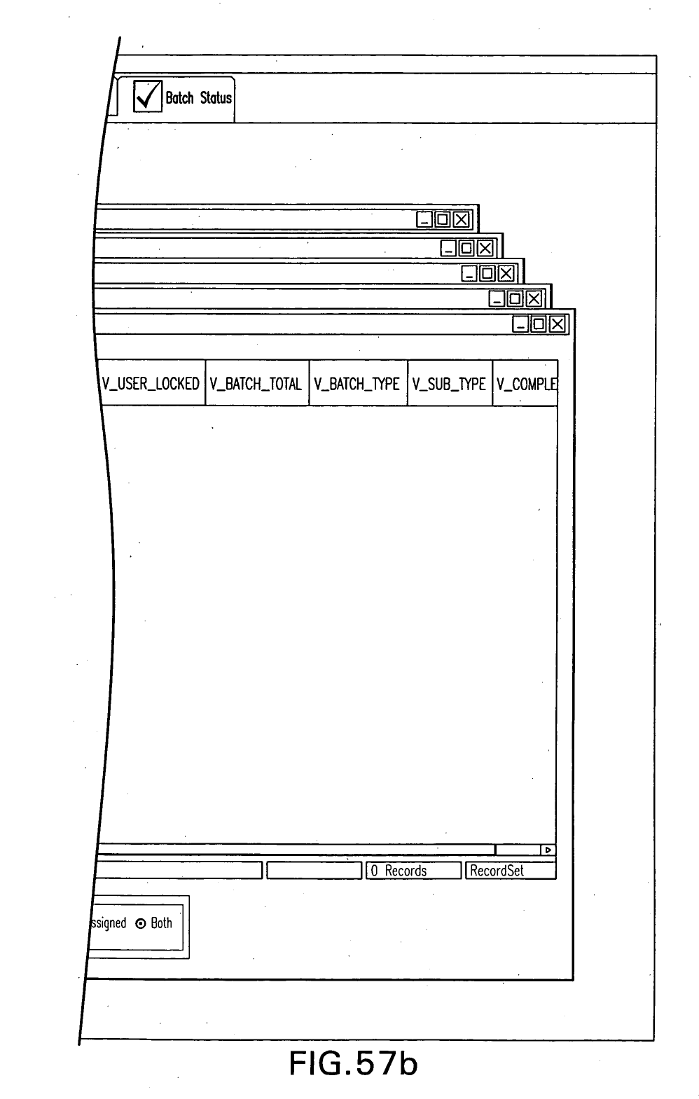

FIG. 57 shows the batch balancing window 6505, which is displayed as a cascading window in supervisor workflow screen 6100 when the batch status tab 6130 is selected. All batches processed for a specific production day are displayed denoting balancing confirmation by a “Y” (yes) or “N” (no). The batch balancing module is operable to release a batch and re-assign.

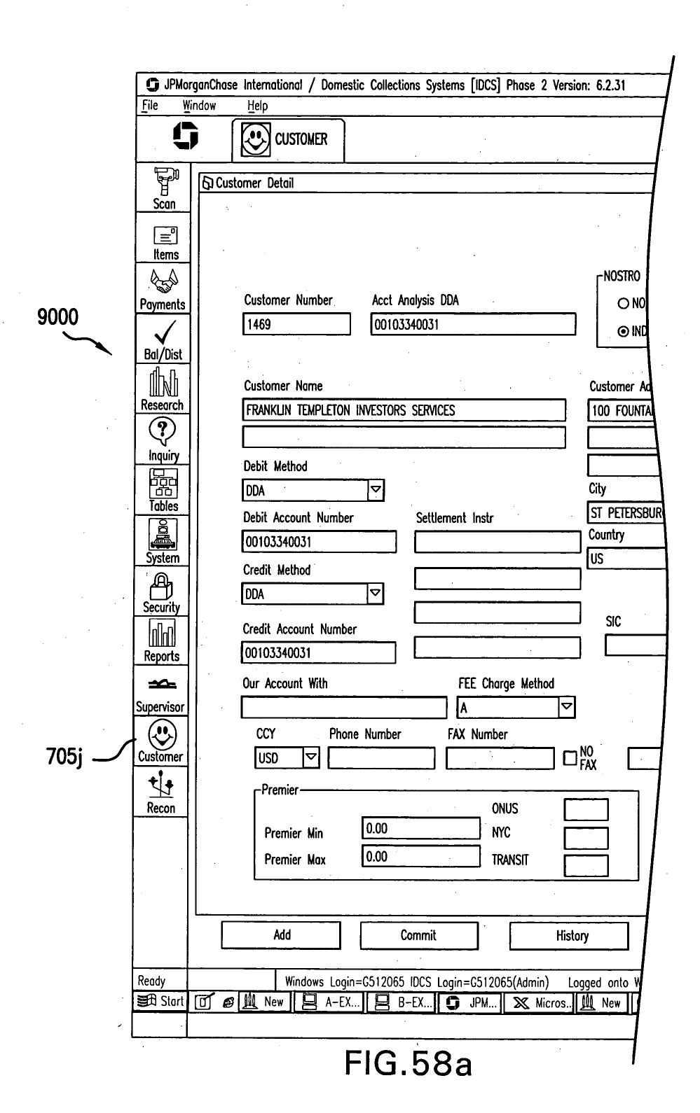

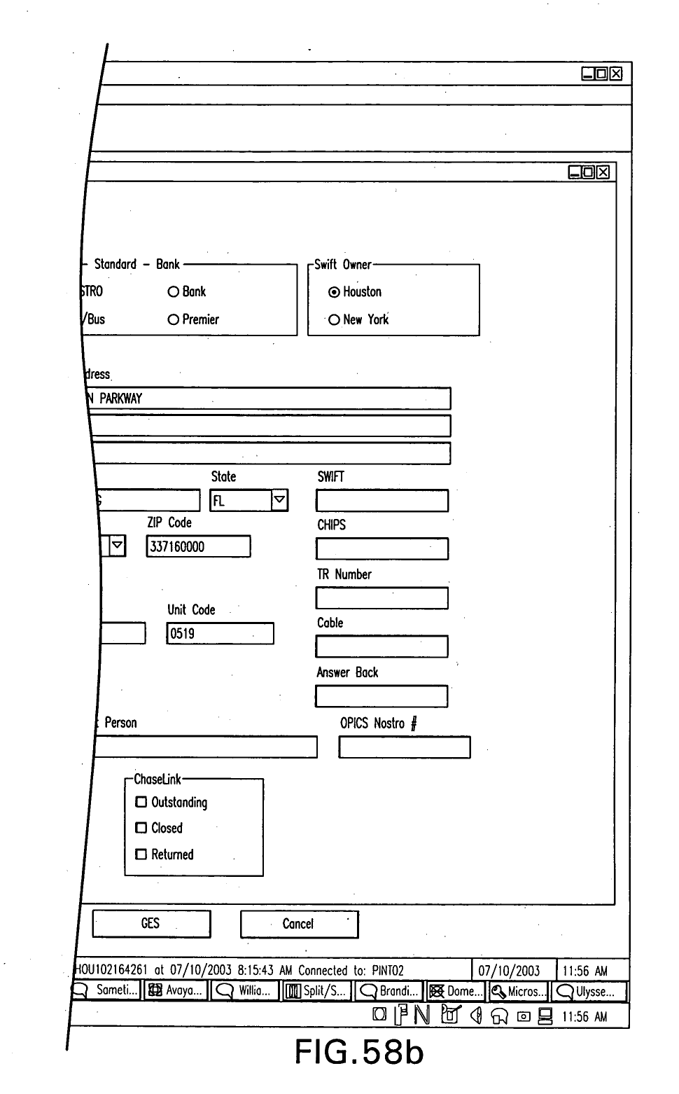

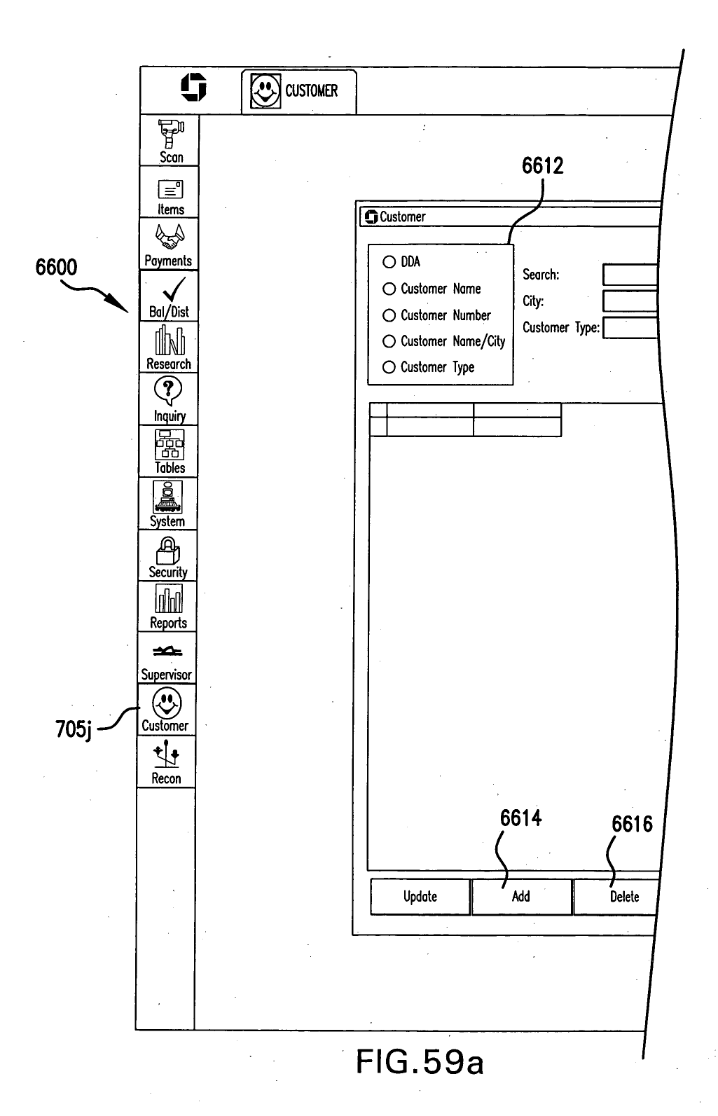

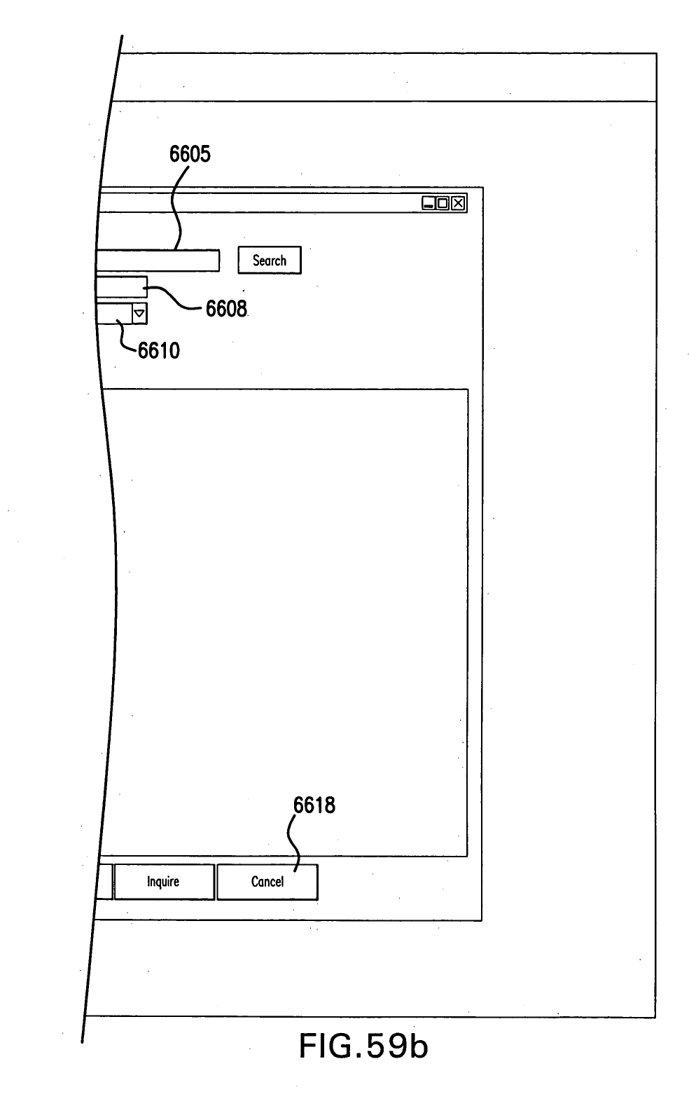

In response to selection of customer tab 705j, the system shows the customer screen 6600, as shown in FIG. 59. This allows the user to search for information about of customer. The search field 6605 may be used to enter search terms. Radio buttons 6612 are provided to indicate the type of search term to be entered. As shown, the term can be the DDA, the Customer Name, the Customer Number, the Customer Name/City and the customer type. City information can be entered in city field 6608, while customer type information can be entered in customer type field 6610. Add button 6614 and delete button 6616 allow the customer to be added or deleted, respectively. The operation of this screen may be canceled by clicking cancel button 6618. A customer master file screen 9000, shown in FIG. 58, may also be presented to display detailed information about a customer.

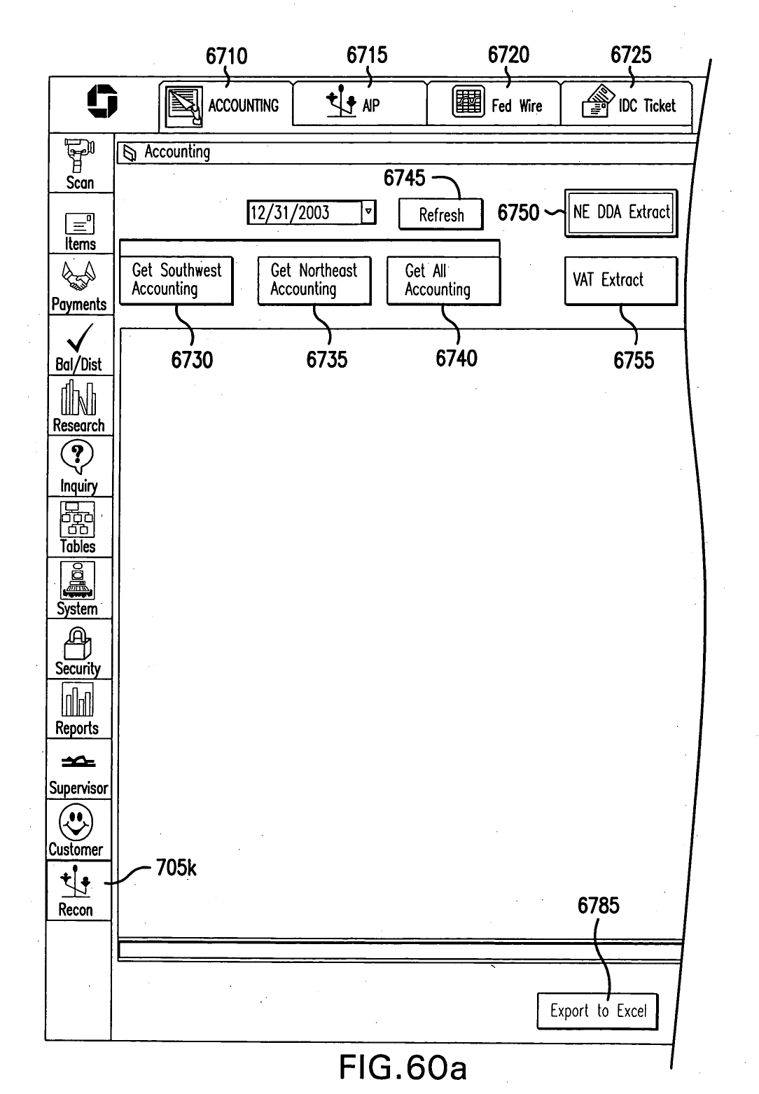

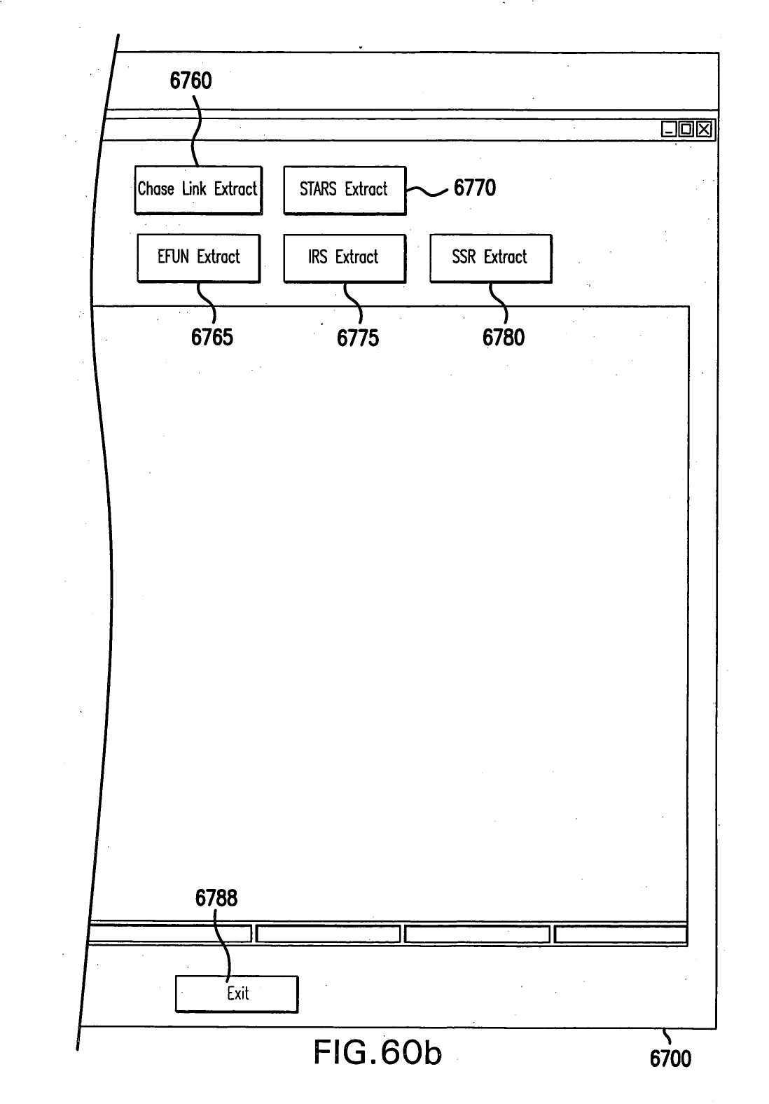

Selection of the Reconciliation (Recon) tab 705k, causes the system to show screens for reconciliation. As a default, the system presents the Accounting reconciliation screen 6700, shown in FIG. 60, in response to selection of the Recon tab 705k. That Accounting screen is also available by clicking on tab 6710 at the top of the screen from any of the reconciliation screens. Other tabs include an AIP reconciliation tab 6715, a FedWire tab 6720, and an IDC Ticket tab 6725, each having an associated screen, to be discussed below. The Accounting tab houses all the information posting by production date.

The Accounting reconciliation screen includes a number of buttons used in accounting reconciliation processing. The buttons include a Get Southwest Accounting button 6730 which provides a listing of all DDA & G/L entries posting in the Southwest to Finen 04 by production date; a Get Northeast Accounting button 6735 which provides a listing of all DDA and G/L entries posting in the Northeast to Finen01 by production date; a Get All Accounting button 6740 which provides a listing of all financial entries for both Southwest and Northeast accounts by production date; a Refresh button 6745 which resets the data in the Accounting screen. Also included are the NE DDA Extract button 6750 which provides a listing of Northeast DDA posting by production date; the VAT (Volume Allocation Tracking) Extract button records the volume for Collection Services; the Chase Link Extract button 6760 lists all transactions that post to a particular account; the EFUN Extract button 6765 which provides a listing of the Southwest financial transactions posting via Electronic Funnel; the STARS Extract button 6770 which provides a listing of the general ledger entries posting for the Northeast by production date; the IRS (Income Revenue System) Extract provides the tracking of the income back to the appropriate BAC; and the Smart Stream Reconciliation (SSR) Extract button 6780 is a reconciling system that handles foreign currency items. At the lower portion of the screen are provided an Export to Excel button 6785 which provides the ability to export any of the listings within accounting to a spreadsheet for printing; and an Exit button 6788 which allows the IDCS user to exit the accounting module.

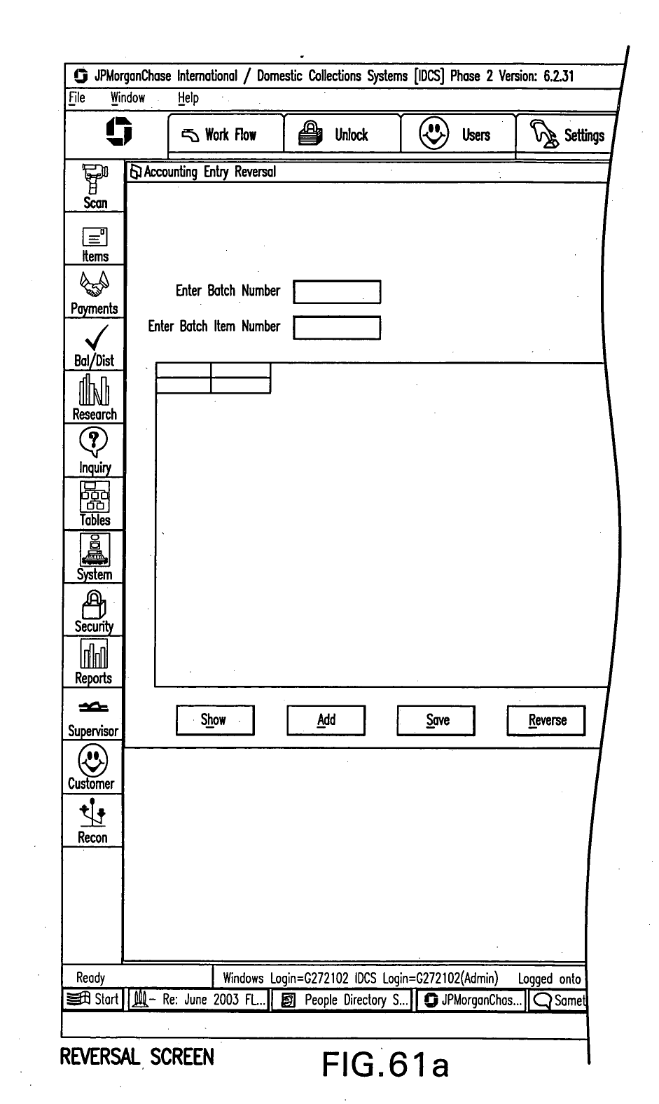

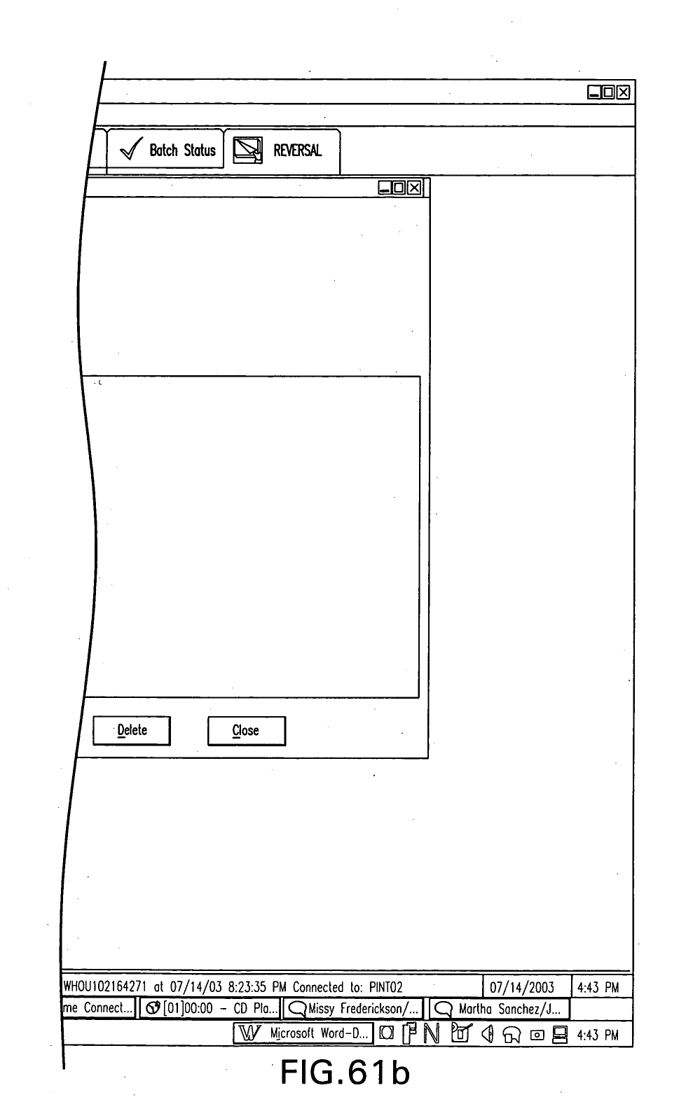

An accounting reversal screen is shown in FIG. 61. This screen allows entries to be reversed by the supervisor.

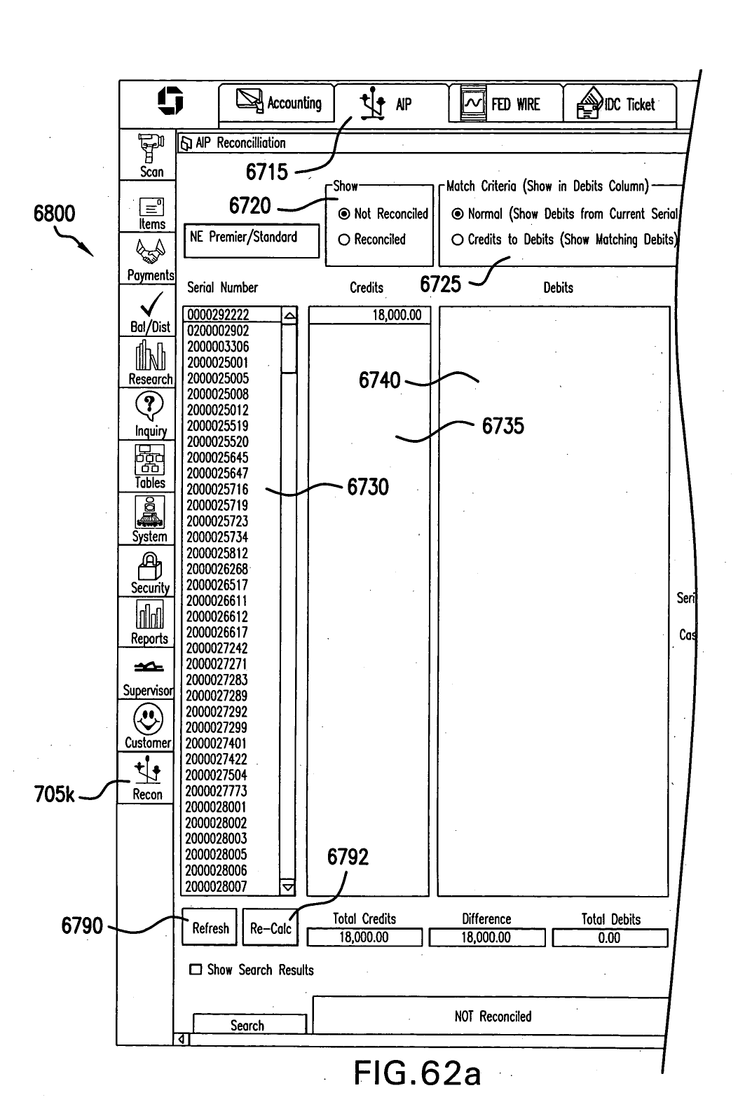

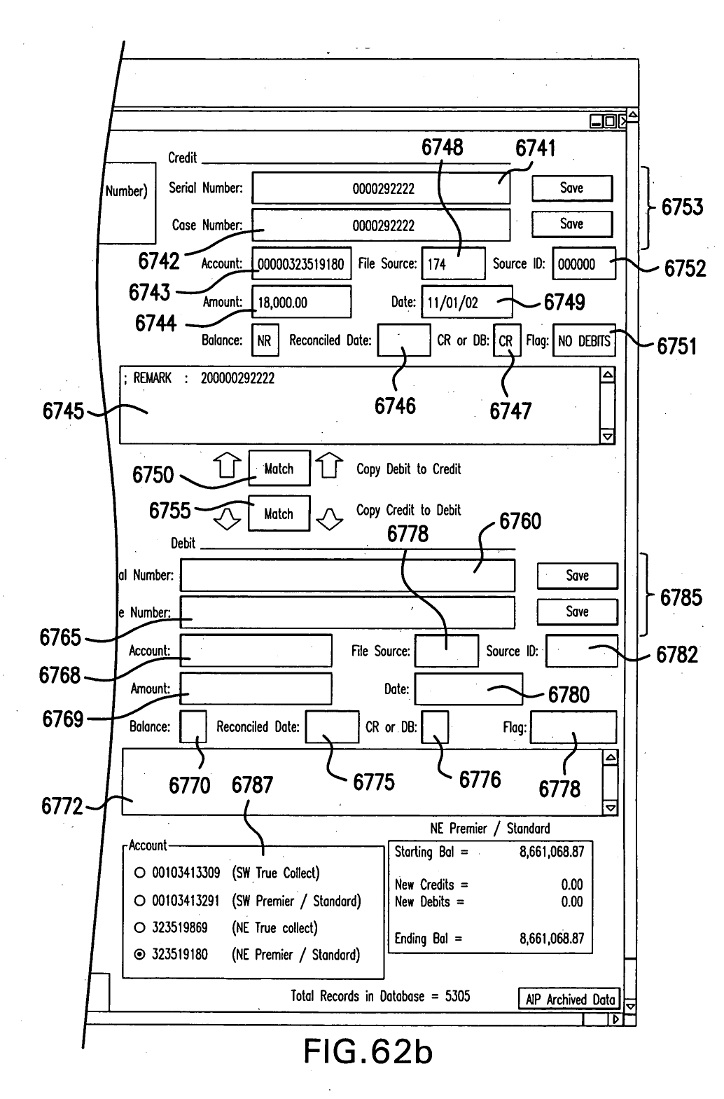

When the AIP tab 6715 is selected, the system presents the AIP reconciliation screen 6800, shown in FIG. 62. The auto investment program allows for the systematic reconciliation of internal DDA accounts. The fields in this screen include radio buttons 6720 allowing display of not reconciled or reconciled items. Radio buttons 6725 allow a choice of match criteria (shown in debits column 6740). In particular, the choice can be made between normal match criteria, in which debits are shown from the current serial number, and credits to debits, in which matching debits are shown. Serial numbers of items for AIP reconciliation are listed in serial number field 6730. Credit field 6735 and debits field 6740 are also provided. The right side of the screen is divided between a credit display area and a debit display area. The credit display area includes a serial number field 6741, a case number field 6742, an account number field 6743, an amount field 6744, a remark field 6745, reconciled date field 6746, a CR or DB field 6747, a file source field 6748, a date field 6749, a copy debit to credit button 6750, a flag field 6751, a source ID field 6752, and save buttons 6753.

The debit display area includes a copy credit to debit button 6755, a serial number field 6760, a case number field 6765, an account number field 6768, an amount field 6769, a remark field 6772, reconciled date field 6775, a CR or DB field 6776, a file source field 6778, a date field 6780, a flag field 6778, a source ID field 6782, and save buttons 6785. The screen also provided radio buttons 6787 allowing a choice between SW True Collect, SW Premier/Standard, NE True collect, NE Premier/Standard, and the applicable reconciling accounts.

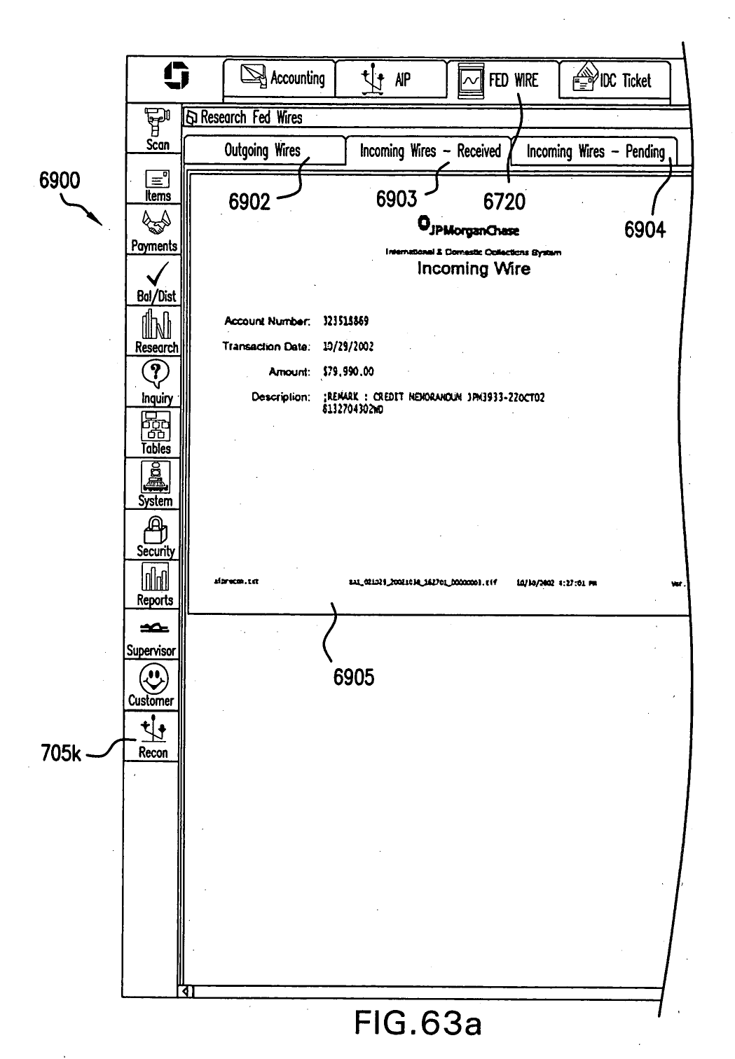

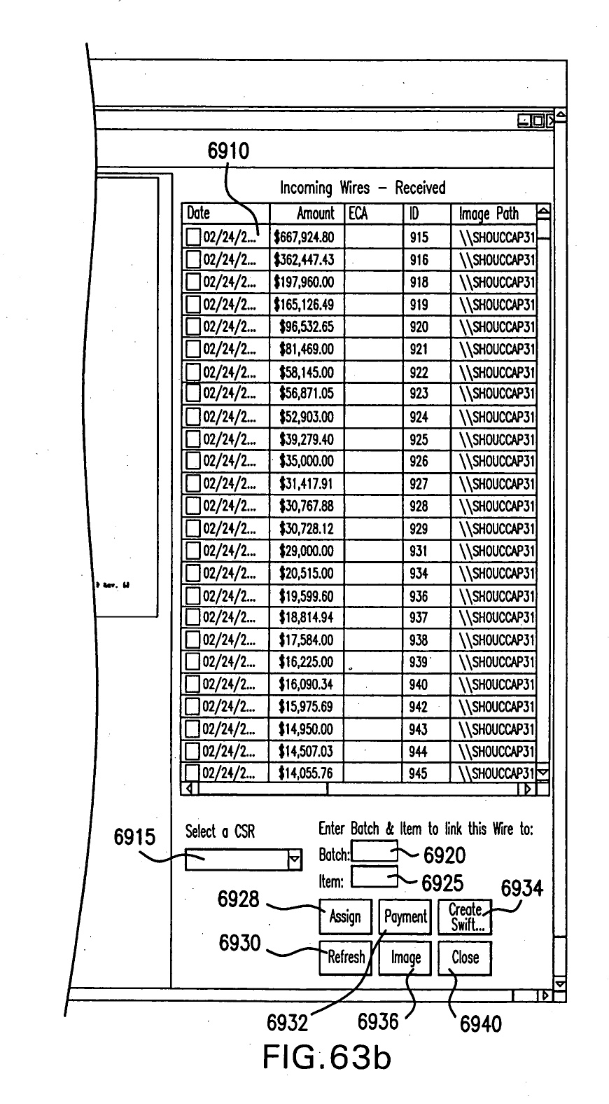

When the FEDWIRE tab 6720 is selected, the system presents the Research FedWires screen 6900. The Fedwire tab houses all the wire notification information for the IDCS user. This screen includes three tabs, an outgoing wires tab 6902, an incoming wires—received tab 6903, and an incoming wires—pending tab 6904. FIG. 63 shows the Research FedWires screen 6900 with the incoming wires —received tab 6903 selected. The display for the other two tabs is substantially similar and is not shown. A display field 6905 displays the image of an incoming wire. An incoming wires—received list 6910 is displayed on the right side of the screen. Also provided are: a field 6915 for selecting a CSR; batch entry field 6920 and item field 6925, which allow the current wire to be linked to the batch and item entered in these fields; an assign button 6928; a refresh button 6930; a payment button 6932; a create swift button 6934; an image button 6936; and a close button 6940, which causes the screen to close.

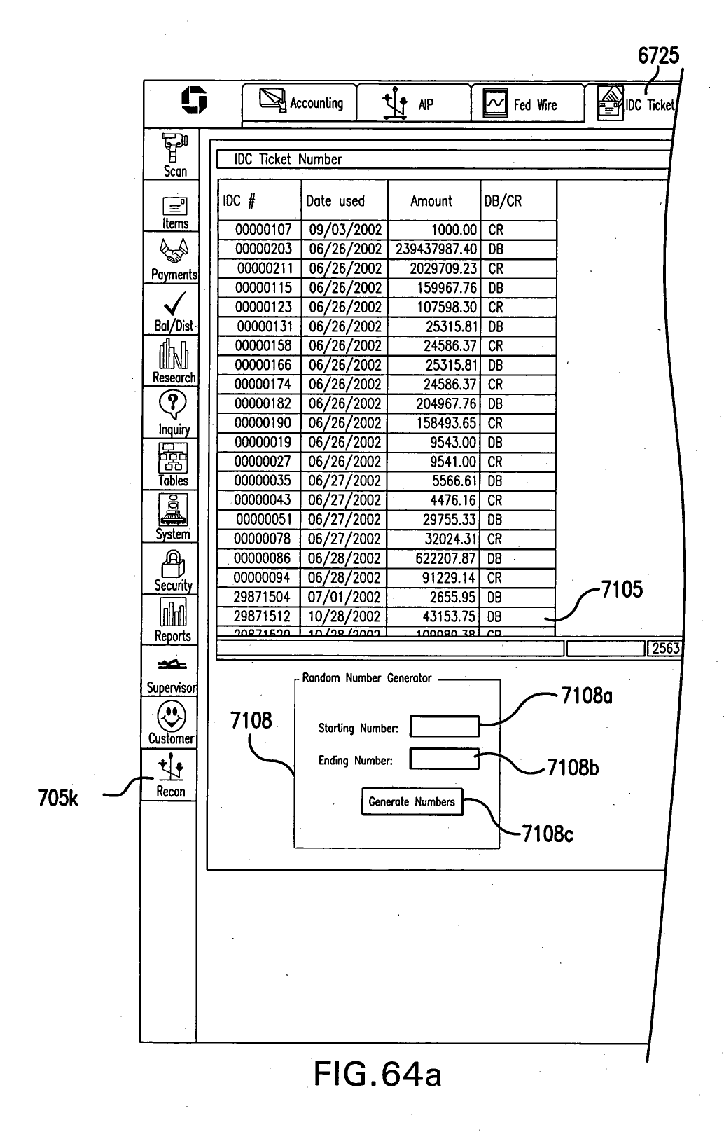

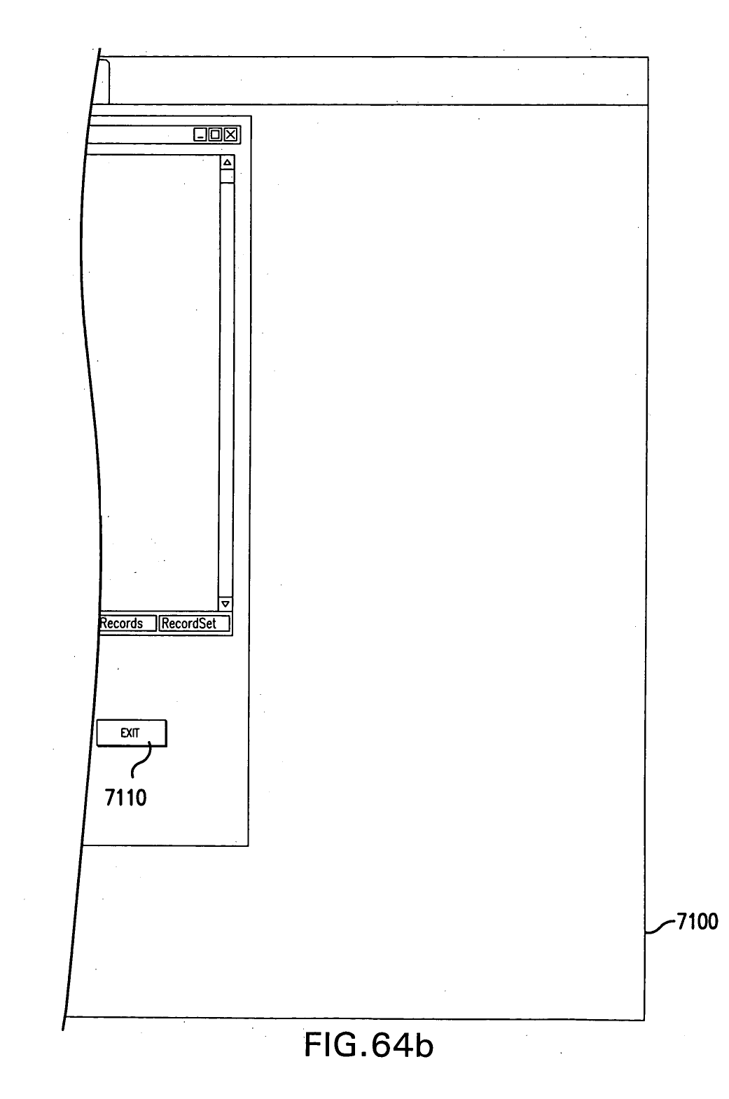

When the IDC Ticket tab 6725 is selected, the system presents the IDC Ticket Number screen 7100, as shown in FIG. 64. The IDC ticket tab allows for the systemic allocation and creation of internal IDC numeric tickets. The screen includes a list 7105 of IDC tickets, a random number generator 7108, and an exit button 7110. The random number generator 7108 includes a starting number field 7108a, an ending number field 7108b, and a generate numbers button 7108c, which triggers generation of a random number based upon the numbers input in fields 7108a and 7108b.

The present invention provides a system that allows financial institutions to handle a large volume of incoming documents without the necessity of storing, maintaining and searching through enormous quantities of paper. By virtue of the present invention, these tasks can be done electronically, using stored images. Moreover, because all papers relating to a particular collections item can be stored together in a single unit of work, all related papers can be accessed at the same time that the collections item is accessed. The present invention has been described in accordance with certain preferred embodiments. However, the invention is not limited to the described embodiments and may be implemented using various techniques, as would be understood by one of skill in the art, within the scope of the appended claims.

What is claimed is:

1. A system for capturing and processing information from a collection item, the system comprising:
one or more scanners structured to scan and extract information, including image information, from a collection item and/or one or more documents associated with the collection item;
a client operable to receive the information from the one or more scanners, associate the collection item and any associated documents together as an image-based unit of work, provide a display interface for a user of the client, accept input from the user, and perform processing of the collection item in accordance with the user's input;
a database operable to store the extracted information so as to be retrievable on a unit of work basis; and
an application server coupled to the client and the database, the application server being operable to access information stored in the database, make information from the database available to the client, and interface with external systems.

2. A system according to claim 1, wherein the client further comprises:
a collection item processing module that prior to scanning the collection item sorts the collection item in accordance with a collection item type;
a scan and index module that controls scanning of the collection item and, in cooperation with input of the user, organizes the scanned information in the image-based unit of work for storage in the database, the scan and index module generating a unique database key for the collection item so as to allow all documents in the unit of work for the collection item to be accessed on the basis of the database key;
a user interface module that generates screens to prompt input of information from a user and display information relating to the unit of work, including image information, to the user; and
a payment processing module that processes payments of the collection item in accordance with the collection item type.

3. A system according to claim 2, wherein the payment processing module causes the user interface module to generate a payment screen, the payment screen displaying images of all documents in a unit of work to the user, and accepting input relating to: (a) the party to whom payment is to be made, (b) the party that issued the collections item, (c) the amount of the payment, and (d) the method of payment, the payment screen providing means for the user to commit a payment so as to save data entered through the payment screen to the database.

4. A system according to claim 2, wherein the client further comprises a balance and distribution module that effects payment and account balancing for the payment processed collection item, the balance and distribution module being operable to cause the user interface module to generate a balance and distribution screen to allow the user to distribute funds and balance accounts of processed collection items and to allow the user to create deposit tickets.

5. A system according to claim 1, said application server comprising:
a queue module that creates queues for storing data to be used during processing of the system, and dynamically tracking and updating status of the queues;
external interface modules that provide interface with external systems; and
an archive interface that uploads information stored in the database to an archive after a predetermined period of time.

6. A system according to claim 5, wherein the external interface modules include modules to interface using one or more of FEDWIRE, CHIPS and SWIFT.

7. A system according to claim 1, wherein the user interface module provides auto-fill of data for items the information for which has previously been stored in the database.

8. A system according to claim 1, wherein the one or more scanners includes a check scanner operable to read MICR information and a flatbed scanner.

9. A system according to claim 2, wherein the one or more scanners includes a check scanner operable to read MICR information and a flatbed scanner and if it is determined by the collection item processing block that the collection item is a check drawn on a U.S. bank, the check is scanned by the check scanner.

10. A system according to claim 1, wherein the database is a relational database.

11. A method for capturing and processing information from a collection item, the method comprising:
providing one or more scanners structured to scan and extract information, including image information, from a collection item and/or one or more documents associated with the collection item;
receiving, at a client, the information from the one or more scanners, associating the collection item and any associated documents together as an image-based unit of work, providing a display interface for a user of the client, accepting input from the user, and performing processing of the collection item in accordance with the user's input;
storing the extracted information in a database so as to be retrievable on a unit of work basis; and
in an application server coupled to the client and the database, the application server being operable to access information stored in the database, making information from the database available to the client, and interfacing with external systems.

12. A method according to claim 11, further comprising, at the client:
collection item processing at which, prior to scanning the collection item sorts the collection item in accordance with a collection item type;
scanning of the collection item and, in cooperation with input of the user, organizing the scanned information in the image-based unit of work for storage in the database, the scan and index module generating a unique database key for the collection item so as to allow all documents in the unit of work for the collection item to be accessed on the basis of the database key;
generates screens to prompt input of information from a user and display information relating to the unit of work, including image information, to the user; and
processing payments of the collection item in accordance with the collection item type.

13. A method according to claim 12, wherein in the payment processing step a payment screen is generated, the payment screen displaying images of all documents in a unit of work to the user, and accepting input relating to: (a) the party to whom payment is to be made, (b) the party that issued the collections item, (c) the amount of the payment, and (d) the method of payment, the payment screen providing means for the user to commit a payment so as to save data entered through the payment screen to the database.

14. A method according to claim 12, further comprising, at the client, effecting payment and account balancing for the payment processed collection item and causing a balance and distribution screen to be displayed to the user to allow the user to distribute funds and balance accounts of processed collection items and to allow the user to create deposit tickets.

15. A method according to claim 11, further comprising, at the application server:
creating queues for storing data to be used during processing of the system, and dynamically tracking and updating status of the queues;
providing an interface with external systems; and
uploading information stored in the database to an archive after a predetermined period of time.

16. A method according to claim 15, wherein the external interface interfaces using one or more of FEDWIRE, CHIPS and SWIFT.

17. A method according to claim 11, further comprising providing auto-fill of data for items the information for which has previously been stored in the database.

18. A method according to claim 11, wherein the one or more scanners includes a check scanner operable to read MICR information and a flatbed scanner.

19. A method according to claim 11, wherein the one or more scanners includes a check scanner operable to read MICR information and a flatbed scanner and if it is determined by the collection item processing block that the collection item is a check drawn on a U.S. bank, the check is scanned by the check scanner.

20. A method according to claim 11, wherein the database is a relational database.
